(19) United States
(12) Patent Application Publication
(10) Pub. No.: US 2008/0108771 A1
(43) Pub. Date: May 8, 2008

(54) Redox polymerization method, water-absorbent resin composite, and absorbent article

(76) Inventors: Shunichi Himori, Yokkaichi-Shi (JP); Kiichi Itoh, Yokkaichi-Shi (JP); Yasunari Sugyo, Yokkaichi-Shi (JP); Yoshiaki Mori, Ogaki-Shi (JP); Taisuke Ishii, Yokkaichi-Shi (JP)

Correspondence Address: BIRCH STEWART KOLASCH & BIRCH, PO BOX 747, FALLS CHURCH, VA, 22040-0747, US

(21) Appl. No.: 12/000,440

(22) Filed: Dec. 12, 2007

Related U.S. Application Data
(62) Division of application No. 11/402,825, filed on Apr. 13, 2006.

(30) Foreign Application Priority Data
Oct. 16, 2003 (JP) 2003-355931
Oct. 27, 2003 (JP) 2003-365519
Feb. 16, 2004 (JP) 2004-038553

(51) Int. Cl. C08F 2/06

(52) U.S. Cl. 526/317.1

(57) ABSTRACT

In a method of redox polymerization of monomer by the use of a non-metal reducing agent and a non-metal oxidizing agent, a transition metal compound is used in addition to the reducing agent and the oxidizing agent in an amount of from 0.01 to 100 ppm by weight in terms of the metal thereof relative to the monomer, whereby the polymerization speed is significantly increased. Using this, water-absorbent resin composite and an absorbent article can be produced.

This application is a Divisional of co-pending application Ser. No. 11/402,825 filed on Apr. 13, 2006, which claims priority on PCT International Application No. PCT/JP2004/015652 filed Oct. 15, 2004, which claims priority on Japanese Application Nos. JP2003/355931, JP2003/365519 and JP2004/038553, filed Oct. 16, 2003, Oct. 27, 2003, and Feb. 16, 2004 respectively. The entire contents of each of these application is hereby incorporated by reference.

### BACKGROUND OF THE INVENTION

1. Field of the Invention

The present invention relates to a technique for greatly accelerating the polymerization speed of redox polymerization to thereby improve producibility. In particular, the invention provides a method for rapid polymerization of (meth) acrylic acid suitable to production of hydrophilic resins such as water-absorbent resins, water-soluble resins, coagulants, dispersants, etc. The invention also relates to a water-absorbent resin composite and a method for producing it, to a water-absorbent resin composite composition containing a water-absorbent resin composite, and to a water-absorbent article comprising the water-absorbent resin composite composition. The water-absorbent resin composite and its composition in the invention have a low remaining monomer concentration, and are thin, flexible and openable, and therefore they are favorable for constitutive materials for absorbent articles such as sanitary materials, e.g., paper diapers and sanitary napkins, and also industrial materials.

2. Description of the Related Art

Heretofore, a redox polymerization method is employed for production of emulsion paints, water-absorbent resins, etc. As compared with that in other polymerization methods, the polymerization speed in a redox polymerization method itself is not slow at all, but it is desired to accelerate the polymerization speed for improving producibility and for down-sizing polymerization apparatus.

In JP-A 2000-328456, proposed is a method for rapidly producing a water-absorbent resin, which comprises dropping a partially-neutralized (meth)acrylic acid in a vapor phase and polymerizing it in air, using a redox polymerization system of hydrogen peroxide/L-ascorbic acid. As compared with other conventional methods, the production method is a remarkably rapid method. However, the method requires a polymerization tank having a height of at least 3 m for the purpose of ensuring the dropping residence time necessary for the end of polymerization.

Similarly, C. Briens, et al. (Ind. Eng. Chem. Res., 2001, 40, 5386-5390) report “an ultra-rapid reactor for water-absorbent resin”. Their technique uses the same reaction system as in JP-A 2000-328456, basically under the concept as therein. Though it may be an ultra-rapid system, it takes at least 2 seconds for attaining a polymerization conversion rate of 40% in the most rapid case using neutralization heat generation, and takes at least 3 seconds in other cases not using neutralization heat. In any case, the method is insufficient in point of acceleration of polymerization speed.

On the other hand, in carrying out rapid polymerization, the delicacy of the process to a polymerization inhibitor must be taken into consideration. Specifically, as compared with ordinary polymerization that takes a few hours for polymerization completion, the rapid polymerization method where the polymerization is completed in seconds may have a problem in that even minor polymerization delay of at most 1 second or even minor polymerization interference may have a significant influence on the rapid polymerization. Concretely, it is known that minor impurities formed in a step of producing (meth)acrylic acid as side products significantly retard the polymerization of the acid. As a result, it is reported that the monomer remaining in the produced polymer (in this description, monomer means a polymerizing monomer) greatly increases. For example, WO01/98382 says that, in polymerization of acrylic acid, specific minor impurities (protoanemonin and furfural) formed as side products during the production have a negative influence on the polymerization and, as a result, the remaining monomer increases. Accordingly, it is proposed to use “ultra-pure acrylic acid” purified to remove the minor impurities from it.

Japanese Patents 3349768 and 3357093, and JP-A 6-56931 say that a minor side product, β-hydroxypropionic acid to be formed during the production has a negative influence on the polymerization and, as a result, the remaining monomer increases. Accordingly, it is proposed to use acrylic acid purified to remove the minor impurities from it.

It is also known that minor metal impurities derived from the materials of production, storage and transportation equipment have a significant polymerization-inhibitory effect. “Functional Acrylic Resin” (EizoOmori, Technosystems Co., 1985, p. 28, line 2 ff.) says that copper, iron, chromium, zinc, mercury and others have a polymerization-inhibitory effect. Further, JP-A 3-31306 says that heavy metals such as iron, manganese, chromium, copper, lead have a negative influence on polymerization and therefore increase the remaining monomer. Accordingly, it is proposed to construct the apparatus with a lined and/or coated material so that the monomer is not brought into contact with heavy metals, or to utilize acrylic acid purified to so as to remove the heavy metals from it. Addition of the purifying step for removal of the impurities and the lining and/or coating treatment for the apparatus take much cost, labor and energy, therefore causing the increase in the production costs. Accordingly, it has been desired to develop a rapid polymerization method that is not delicate to such minor impurities.

On the other hand, a hydrophilic resin obtainable in a redox polymerization method is useful as a sanitary material such as paper diapers. A monomer remaining in a water-absorbent resin may retard the water-absorbing property of the water-absorbent resin and may cause pollution, and therefore has some problems in sanitation. Accordingly, it has been desired to much more reduce the amount of the remaining monomer. Various methods have heretofore been proposed for reducing the remaining monomer. For example, they include 1) a method of promoting the polymerization of monomer, 2) a method of leading monomer into other derivatives, 3) a method of removing monomer. Regarding the method 1) of promoting the polymerization of monomer, for example, there are known a method of further heating polymer, a method of adding a catalyst or a catalyst component capable of promoting the polymerization of monomer, to water-absorbent resin, and then heating the resin (JP-A 64-024808, 01-103644), a method of irradiation with UV rays (JP-A 63-260907), a method of irradiation with electromagnetic radiations or particulate ionization radiations (JP-A 63-043930). However, these methods may take a relatively long period of time for the treatment and may require expensive equipment.

Regarding the method 2) of leading monomer into other derivatives, for example, there are known a method of adding amine, ammonia or the like (JP-A 50-040689), a method of adding a reducing agent such as hydrogensulfite, sulfite, pyrosulfite (JP-A 64-062317). Surely these methods may greatly reduce the amount of monomer in some cases, but are problematic in point of the toxicity of the additive chemicals themselves and the monomer derivatives.

Regarding the method 3) of removing monomer, for example, there are known a method of extraction with an organic solvent (JP-A 01-292003) or vaporization (JP-A 01-026604). These methods are defective in that they consume great energy and, in addition, they have another problem in that impurities derived from the organic solvent used may contaminate the product. In view of the drawbacks of these prior art techniques, a sanitary and low-cost method for remaining monomer reduction has been desired.

On the other hand, various techniques have heretofore been proposed for improving products by adding a specific metal to polymerization.

For example, in JP-A 63-210102, proposed is use of L-ascorbic acid, sodium L-ascorbate, alkali metal salt of L-ascorbic acid, cobalt acetate, copper sulfate, ferrous sulfate or the like as a reducing agent in a redox polymerization system for producing a water-absorbent resin. However, this has neither description nor suggestion relating to the fact that, in redox polymerization using a non-metal reducing agent and a non-metal oxidizing agent, for example, using L-ascorbic acid/hydrogen peroxide, when an iron compound is used along with them, then the iron compound may act as a polymerization activator for accelerating the polymerization speed or may act as an anti-polymerization inhibitor for ensuring the polymerization stability to impurities. In JP-A 63-210102, the iron compound serves exclusively as a reducing agent and therefore only compounds having a lower oxidation number are employable for it. In fact, only ferrous(II) sulfate is exemplified as the iron compound, and there is given neither description nor suggestion relating to use of 3-valent or more polyvalent iron compounds.

JP-A 4-372604 describes a method of adding a metal salt compound with Fe(II) or Fe(III) in producing a water-absorbent resin through polymerization to thereby improve the quality of the water-absorbent resin. In this method, a metal salt compound is added during polymerization, but it is not for improving the reaction mode of polymerization. In this, the metal salt compound added is inactive during polymerization reaction, and is intended exclusively for improving the water-absorbing capability of the water-absorbent resin after completion of polymerization. In JP-A 4-372604, a fact is explicitly described that the metal salt compound does not participate in redox polymerization initiation, and an experimental ground for it is also shown. Further, production examples of redox systems and working examples with them are not described in the publication. Accordingly, the publication has no suggestion at all relating to a polymerization activator or an anti-polymerization inhibitor that directly participates in redox polymerization, and to a remaining monomer amount-reducing agent for reducing the amount of remaining monomer.

### SUMMARY OF THE INVENTION

The invention has been made for solving the themes and the problems with the prior art techniques described in the above-mentioned patent publications and references. Specifically, an object of the invention is to provide a redox polymerization method in which the polymerization speed is significantly increased. Another object of the invention is to provide a redox polymerization method in which the polymerization retardation is small and the polymerization behavior is stable even though the redox polymerization system contains a polymerization inhibitor (for example, when crude (meth) acrylic acid is used as a monomer). Still another object of the invention is to provide a redox polymerization method in which the amount of the remaining monomer may be reduced. Still another object of the invention is to provide a polymerization activator and an anti-polymerization inhibitor for redox polymerization, and to further provide a remaining monomer amount-reducing agent for the polymer obtained through redox polymerization.

Still another object of the invention is to provide a water-absorbent resin composite having a small amount of remaining monomer and a method for producing it, to provide a water-absorbent resin composite composition containing the water-absorbent resin composite, and to provide an absorbent article comprising the water-absorbent resin composite composition. In particular, the invention is to provide a composite of highly water-absorbent resin particles and fibers, which has a small amount of remaining monomer, in which the fibers are stably fixed to the highly water-absorbent resin particles not only in dry but also in wet and swollen condition, and the highly water-absorbent resin particles can be fixed to the fibers uniformly to a high content, which is flexible and may be thinned, and which is openable by itself and may be uniformly mixed with any other material; and to provide a composition containing the composite.

Further, the invention is to provide a method for producing an absorbent article that may rapidly absorb, diffuse and keep a sufficient amount of liquid. Also, the invention is to provide a simple method for producing a flexible and thin absorbent article. Still further, the invention is to provide a method for producing an absorbent article in which a water-absorbent resin is fixed in a good manner not generating fiber waste and finely-pulverized water-absorbent resin particles.

As in the above-mentioned “Functional Acrylic Resin” (Eizo Omori, Technosystems Co., 1985, p. 28, line 2 ff.) and JP-A 3-31306, it is known that metals such as typically iron generally inhibit polymerization of acrylic acid. However, as a result of our assiduous studies, we, the present inventors have surprisingly found that, on the contrary, when a minor amount of a transition metal compound is added to a specific redox polymerization system, then it remarkably increases the polymerization speed. Also surprisingly, we have found that, when a minor amount of a transition metal compound is added to a redox polymerization system that is naturally delicate to the co-existence of a polymerization-inhibiting substance in point of the polymerization speed and the polymerization stability thereof, then it stably realizes a sufficient polymerization speed of the system. The invention has been provided on the basis of the first finding that a transition metal compound may have an effect as a polymerization activator and an effect as an anti-polymerization inhibitor.

Specifically, the invention is a method for producing a polymer through redox polymerization of a monomer by the use of a non-metal reducing agent and a non-metal oxidizing agent, wherein a transition metal compound is used in addition to the reducing agent and the oxidizing agent, in an amount of from 0.01 to 100 ppm by weight in terms of the metal thereof relative to the monomer. The invention is also a method for increasing the polymerization activity in redox polymerization of a monomer by the use of a non-metal reducing agent and a non-metal oxidizing agent, wherein a transition metal compound is used in addition to the reducing agent and the oxidizing agent, in an amount of from 0.01 to 100 ppm by weight in terms of the metal thereof relative to the monomer. The invention is also a method for inhibiting the activity of a polymerization inhibitor existing in a reaction system of redox polymerization of a monomer that uses a non-metal reducing agent and a non-metal oxidizing agent, wherein a transition metal compound is used in addition to the reducing agent and the oxidizing agent, in an amount of from 0.01 to 100 ppm by weight in terms of the metal thereof relative to the monomer. The invention is also a method for reducing the remaining monomer amount in a polymer obtained through redox polymerization of a monomer by the use of a non-metal reducing agent and a non-metal oxidizing agent, wherein a transition metal compound is used in addition to the reducing agent and the oxidizing agent, in an amount of from 0.01 to 100 ppm by weight in terms of the metal thereof relative to the monomer. For example, this may be carried out by keeping the product after the redox polymerization in an atmosphere having a relative humidity of at least 80% or by giving water to the product, in the presence of a transition metal compound in an amount of from 0.01 to 100 ppm by weight in terms of the metal thereof relative to the monomer.

In these methods of the invention, the transition metal compound is preferably a compound capable of being reduced by the reducing agent, more preferably a primary transition metal compound, even more preferably an iron compound. Also preferably, the redox potential of the non-metal reducing agent is from −2 to 0.3 V, the redox potential of the non-metal oxidizing agent is from 0.6 to 2.5 V, and the redox potential of the transition metal of the transition metal compound is larger than the redox potential of the non-metal reducing agent and is smaller than the redox potential of the non-metal oxidizing agent. Also preferably, the non-metal reducing agent is used in an amount of from 0.001 to 10% by weight relative to the monomer, and the transition metal compound is used in an amount of from 0.0001 to 100% by weight in terms of the metal thereof relative to the non-metal reducing agent. In this, when the amount of the transition metal compound in terms of the metal thereof is the same as the monomer amount or the non-metal reducing agent amount, then it is 100% by weight.

Preferably, (meth)acrylic acid may be used as the monomer in the methods of the invention. For example, crude (meth) acrylic acid may be employable, which contains one or more polymerization inhibitors selected from the group consisting of aldehydes having from 1 to 8 carbon atoms, saturated or unsaturated carboxylic acids having from 1 to 6 carbon atoms (excepting acetic acid, propionic acid and dimer acid), esters having from 1 to 6 carbon atoms, cyclic unsaturated hydrocarbons having from 8 to 10 carbon atoms, alkoxyhydroxy-(polycyclic) unsaturated hydrocarbons having from 7 to 16 carbon atoms except hydroquinone monomethyl ether, and phenothiazine, in an amount of from 1 to 1000 ppm by weight, and/or hydroquinone monomethyl ether in an amount of from 230 to 5000 ppm by weight. In the methods of the invention, one or more selected from the group consisting of ascorbic acid, erythorbic acid and their salts may be preferably used as the non-metal reducing agent. Also preferably, hydrogen peroxide may be used as the non-metal oxidizing agent. According to the methods of the invention, the monomer polymerization rate may be at least 50% in 0.7 seconds after the initiation of redox polymerization, or the monomer polymerization rate may be at least 70% in 1.5 seconds after it. In detail, ascorbic acid as referred to herein indicates L-ascorbic acid, and erythorbic acid is an optical isomer of L-ascorbic acid and it may be referred to also as isoascorbic acid or araboascorbic acid.

The invention further provides a polymerization activator for redox polymerization using a non-metal reducing agent and a non-metal oxidizing agent, which contains a transition metal compound. The invention also provides an anti-polymerization inhibitor for redox polymerization using a non-metal reducing agent and a non-metal oxidizing agent, which contains a transition metal compound. The invention also provides a remaining monomer amount-reducing agent for polymer obtained through redox polymerization using a non-metal reducing agent and a non-metal oxidizing agent, which contains a transition metal compound.

The invention also provides a hydrophilic polymer which contains a transition metal compound having a redox potential of from 0 to 2 V, in an amount of from 0.01 to 100% by weight in terms of the metal thereof, and contains a non-metal reducing agent in an amount of from 0.0001 to 10% by weight.

The invention also provides a method for producing a water-absorbent resin composite that comprises highly water-absorbent resin particles hybridized with fibers, by contacting liquid droplets that contain a monomer and/or the monomer being polymerized with fibers in a vapor phase and promoting the polymerization of the monomer, wherein (1) the polymerization of the monomer is promoted through radical polymerization in the presence of a polymerization activator; (2) the polymerization of the monomer is promoted through radical polymerization and, after the polymerization, the product is kept under the condition of a relative humidity of at least 80% in the presence of a polymerization activator; or (3) the polymerization of the monomer is promoted through radical polymerization and, after the polymerization, water is given to the product in the presence of a polymerization activator. In the methods (1) and (2), the polymerization is preferably effected in the presence of a polymerization activator, more preferably a transition metal compound is used in an amount of from 0.01 to 100 ppm by weight in terms of the metal thereof relative to the monomer. In the methods (1) to (3), a polymerization activator is preferably added to the product after the polymerization, more preferably a transition metal compound is used in an amount of from 0.01 to 100 ppm by weight in terms of the metal thereof relative to the polymer obtained. Preferably, the water-absorbent resin composite produced has a remaining monomer concentration of at most 2000 ppm by weight.

The invention also provides a water-absorbent resin composite produced according to these methods for producing the water-absorbent resin composite. The invention also provides a water-absorbent resin composite which comprises highly water-absorbent resin particles hybridized with fibers and which has a remaining monomer content of at most 2000 ppm by weight, preferably at most 500 ppm by weight. Preferably, the highly water-absorbent resin particles constituting the water-absorbent resin composite are nearly spherical, and the water-absorbent resin composite has fibers partly embedded in the resin particles and partly exposed out of the resin particles, and fibers not embedded in the resin particles but partly adhere to the surfaces of the resin particles. Also preferably, at least a part of the fibers constituting the water-absorbent resin composite are those having a contact angle with water of at most 90°.

The invention also provides a water-absorbent resin composite composition containing the water-absorbent resin composite. The invention also provides an absorbent article comprising the water-absorbent resin composite composition.

The invention also provides a method for producing an absorbent article comprising a water-absorbent resin and fibers, which includes the following steps (A) to (D):

(A) a hybridizing step of contacting liquid droplets that contain a monomer to give a water-absorbent resin and/or the monomer being polymerized, with previously-opened fibers, and further promoting the polymerization of the monomer to thereby obtain a composite of a water-absorbent resin and fibers having a structure of the water-absorbent resin adhering to the fibers,

(B) a recovering step of recovering an aggregate of the composite,

(C) a drying step of drying the aggregate,

(D) a shaping step of shaping the aggregate.

Between the drying step and the shaping step, the method preferably comprises an opening step of opening the aggregate obtained in the drying step to thereby obtain an opened aggregate comprising the water-absorbent resin and the fibers; more preferably, between the opening step and the shaping step, the method further comprises a sieving step of separating the fibers with no water-absorbent resin adhering thereto; even more preferably, the fibers separated in the sieving step are used in the hybridizing step and/or the shaping step in the method. In the production method, the water-absorbent resin is preferably a crosslinked product of a partially-neutralized acrylic acid polymer. Also preferably, the hybridizing step is effected in a reactor, and the aggregate of the composite deposited in the bottom of the reactor is recovered in the recovering step. Also preferably, in the hybridizing step, the fibers are fed into the reactor as a mixed-phase stream with air, and in the recovering step, the lower area than the mesh disposed in the bottom of the reactor is kept in a more reduced pressure condition than in the reactor to thereby make the aggregate deposited on the mesh, and the aggregate is thus recovered. Also preferably, the air having run towards the lower area through the mesh is used for forming the mixed phase stream by mixing it with the fibers in the hybridizing step.

### BRIEF DESCRIPTION OF THE DRAWINGS

FIG. 1 is a perspective view showing a mixing apparatus used in producing a water-absorbent resin composite in Examples and Comparative Examples.

FIG. 2 is a view showing an example of computing the space velocity of fibers in producing a water-absorbent resin composite.

FIG. 3 is a view showing an example of computing the space velocity of liquid droplets in producing a water-absorbent resin composite.

FIG. 4 is a cross-sectional view showing a thickness-measuring tool.

FIG. 5 is an outline view showing a tool for measuring the bending resistance of a sample according to a heart-loop process, in which (a) is a perspective view, and (b) is a cross-sectional view cut along the line B-B in (a).

FIG. 6 is a cross-sectional view showing an absorbent article produced in Test Example 3.

FIG. 7 is a cross-sectional view showing a tool for measuring a water-absorbing speed and a water-releasing amount.

FIG. 8 is an outline view showing a method for measuring a dropping rate of a highly water-absorbent resin.

FIG. 9 is an outline view showing a ro-tap shaker.

FIG. 10 is a plan view showing cut lines in a sample for measurement of a gel dropping rate.

FIG. 11 is a cross-sectional view showing the condition of shaking in measurement of a gel dropping rate.

FIG. 12 is one example of a flow sheet for continuously producing an absorbent article according to the production method of the invention.

FIG. 13 shows an outline view of the composite produced in Example 201, and scanning electromicroscope photographs thereof.

FIG. 14 shows an outline view of the composite produced in Example 202, and scanning electromicroscope photographs thereof.

FIG. 15 shows an outline view of the composite produced in Example 203, and scanning electromicroscope photographs thereof.

In the drawings, 1 is a polymerization tank; 2 is a vacuum conveyor; 3 is a surface crosslinking agent spray tank; 4 is a drier; 5 is an opener; 6 is a sieving unit; 7 is a vacuum conveyor; 8 is a crimper; 11 is a water-impervious polyethylene sheet; 12 is a tissue; 13 is a compacted water-absorbent resin composite composition; 14 is a nonwoven fabric of polyester fibers; 15 is a tissue; 16 is a water-impervious nonwoven fabric of polyester fibers; 21, 22 is a pipe; 21a, 22a is a nozzle; 23 is a liquid column; 24 is a liquid droplet; 31 is an adapter; 32 is a sample bed; 33 is a sample; 41 is a clamp; 42 is a sample; 52 is a sample; 53 is a cylinder; 55 is an acrylic plate; 56 is a disc; 60 is an absorbent article; 61 is a screen; 65 is a ro-tap shaker; 70 is an absorbent article; 73 is a sample; 74 is an acrylic plate; 75 is a load.

### BEST MODE FOR CARRYING OUT THE INVENTION

The invention is described in detail hereinunder with reference to the preferred embodiments thereof. The explanation of the constitutive elements described below is made on the basis of typical embodiments of the invention, to which, however, the invention should not be limited. In this description, the numerical range expressed by the wording “a number to another number” means the range that falls between the former number indicating the lowermost limit of the range and the latter number indicating the uppermost limit thereof. In the following, a redox polymerization method, a water-absorbent resin composite of the invention, a water-absorbent resin composite composition of the invention, a method for producing a water-absorbent resin composite of the invention, a method for producing a water-absorbent resin composite composition of the invention, an absorbent article of the invention, and a method for producing an absorbent article of the invention are described in detail in that order.

[I] Redox Polymerization Method

The polymerization activator, the anti-polymerization inhibitor and the remaining monomer amount-reducing agent of the invention are generically referred to as a reagent of the invention. In the following, the reagent of the invention is described first.

1. Reagent of the Invention:

(1-1) Components and Compositions of Reagent:

(Transition Metal Compound)

The reagent of the invention is characterized by containing a transition metal compound.

The transition metal compound for use in the reagent of the invention is preferably such that the redox potential of the transition metal contained in the compound is larger than the redox potential of a non-metal reducing agent and smaller than the redox potential of a non-metal oxidizing agent. The transition element may belong to any of a primary transition series, a secondary transition series, a tertiary transition series, a lanthanide series and an actinide series, but preferably belongs to a primary transition series. Concretely, the elements belonging to a primary transition series are titanium (−0.37 V), vanadium (−1.19V, −0.25 V), chromium (−0.91 V, −0.41 V), manganese (−1.18 V, 1.59 V), iron (−0.44 V, 0.77 V), cobalt (−0.28 V, 1.84 V), nickel (−0.24 V) and copper (0.34, 0.15 V, 0.52 V). (The parenthesized numeral is the redox potential of the element.) Of those, preferred the elements having a redox potential of from 0 to 2 V, more preferred are iron and copper; most preferred is iron. As in the above, some transition elements have plural redox potential data. Those of which at least one redox potential is larger than the redox potential of a non-metal reducing agent and is smaller than the redox potential of a non-metal oxidizing agent may preferably act in the above-mentioned redox cycle.

The oxidation number of the transition metal contained in the transition metal compound for use in the invention is not specifically defined. Depending on the oxidation number of the transition metal therein, transition metal compounds have different properties. For example, a trivalent or more polyvalent iron compound and a divalent or less polyvalent iron compound all have an excellent polymerization activity effect; but a trivalent iron has an advantage that it is stable to oxygen in air but has a disadvantage that it colors greatly in reddish violet. On the other hand, a divalent or less polyvalent iron compound has an advantage that it colors little in reddish violet but has a disadvantage that its stability to oxygen in air is low. To that effect, since the properties of transition metal compounds differ depending on the oxidation number of the transition metal therein, it is desirable that the oxidation number of the transition metal to be in the compounds is determined in consideration of the difference in the properties thereof and of the object, the subject, the environment and the dose of the reagent of the invention to be used. One or more different types of transition metal compounds may be used in the reagent of the invention, either singly or as combined.

The transition metal compound includes salts of an inorganic acid or organic acid with a transition metal, oxides and alloys. The inorganic acid as referred to herein includes hydrochloric acid, hydrofluoric acid, sulfuric acid, nitric acid, phosphoric acid, carbonic acid. Of those, preferred are hydrochloric acid and sulfuric acid. The organic acid as referred to herein includes organic group-having carboxylic acids, sulfinic acids, phenols, enols, thiophenols, imides, oximes, aromatic sulfonamides, primary and secondary nitro compounds. Of those, preferred are carboxylic acids and enols.

For example, specific examples of a transition metal compound in which the transition metal is a trivalent or more polyvalent iron include iron(III) chloride, iron(III) fluoride, iron(III) sulfate, iron(III) nitrate, iron(III) phosphate and their hydrates; monocarboxylates such as iron(III) formate, iron(III) acetate, iron(III) propionate, iron(III) acrylate, iron(III) oxalate, iron(III) citrate, iron(III) gluconate, iron(III) 2-ethylhexylate, iron(III) lactate, iron(III) naphthoate, dicarboxylates such as iron(III) fumarate, iron(III) maleate, polycarboxylates such as iron(III) polyacrylate, iron(III) enol L-ascorbate, iron(III) erythorbate, and their hydrates; iron(III) oxide, ferrates (IV), ferrates (V). Examples of a transition metal compound in which the transition metal is a divalent or less polyvalent iron include iron(II) chloride, iron(II) fluoride, iron(II) sulfate, iron(II) nitrate, iron(II) phosphate and their hydrates; monocarboxylates such as iron(II) formate, iron(II) acetate, iron(II) propionate, iron(II) acrylate, iron(II) oxalate, iron(II) citrate, iron(II) gluconate, iron(II) 2-ethylhexylate, iron(II) lactate, iron(II) naphthoate, dicarboxylates such as iron(II) fumarate, iron(II) maleate, polycarboxylates such as iron(II) polyacrylate, iron (II) enol L-ascorbate, iron(II) erythorbate, and their hydrates; iron(II) oxide; iron alloys.

(Composition)

The reagent of the invention may comprise a transition metal compound alone or may comprise a solution or dispersion of a transition metal compound dissolved or dispersed in a suitable medium. The solvent for the solution is preferably a hydrophilic solvent, for which are usable water, ethanol and acetone. From the viewpoint of the safety, the sanitary aspect, the solubilizing capability and the economical advantage thereof, water is preferred.

(1-2) Polymerization Activator:

The polymerization activator of the invention is a reagent for further activating redox polymerization to increase the polymerization speed, thereby realizing rapid polymerization.

(Concentration in Addition, Method for Addition)

Regarding the amount of the polymerization activator of the invention to be added, the amount of the transition metal compound to be added is from 0.01 to 100 ppm by weight in terms of the metal thereof relative to the monomer, preferably from 0.05 to 50 ppm by weight, more preferably from 0.1 ppm to 20 ppm. If the concentration is smaller than 0.01 ppm by weight, then a sufficient polymerization activation effect could not be obtained, but on the contrary, even if the compound over an amount of 100 ppm by weight is used, it could not increase its effect but is uneconomical.

The ratio of transition metal/non-metal reducing agent is also important. Preferably, the amount of the polymerization activator to be added is from 0.0001 to 100% by weight in terms of the metal therein relative to the non-metal reducing agent, more preferably from 0.001 to 10% by weight, even more preferably from 0.01 to 1% by weight.

The polymerization activator of the invention may be added to the monomer liquid containing an oxidizing agent, or may be added to the monomer liquid containing a reducing agent. It is desirable that, when the oxidizing agent and the reducing agent are mixed, then the polymerization activator of the invention may uniformly exist therein, and therefore, it is desirable that the polymerization activator of the invention is added to both the monomer liquid containing an oxidizing agent and the monomer liquid containing a reducing agent. In this case, the polymerization activators of the invention to be added to both the two may have the same composition or different compositions. The amount of the two to be added may be the same or different. Preferably, a polymerization activator having the same composition is added to the two in the same amount in both the two. In case where a condition in which the polymerization activator of the invention can be rapidly and uniformly dispersed in the oxidizing agent and the reducing agent that are mixed together is selected, then the polymerization activator of the invention may be added to any one of them to obtain a satisfactory polymerization activation effect.

The monomer liquid and the polymerization activator may be mixed in any method. For example, herein employable is a method of previously feeding the activator to the monomer liquid, or a method of mixing the two in a pipeline by the use of a line mixer. Preferably, the monomer liquid and the polymerization activator are mixed before the initiation of polymerization. However, the invention does not exclude a case where the polymerization activator is further added after the initiation of polymerization. The temperature at which the monomer liquid and the polymerization activator are mixed may be generally from room temperature to about 60° C., preferably from room temperature to about 40° C. If the temperature in mixing is too high, then the monomer liquid may lose its stability.

In the above description, an embodiment is exemplified in which a monomer is in both the liquid containing an oxidizing agent and the liquid containing a reducing agent. However, the monomer is not always required to be in both the two, and the invention includes an embodiment where the monomer is in any one of the two. Specifically, a monomer may be only in the liquid containing an oxidizing agent, or it may be only in the liquid containing a reducing agent. In this case, the polymerization activator of the invention may be added to the liquid containing a monomer, or may be added to the liquid not containing a monomer, or may be added to both the two. Preferably, the activator is added to both the two, or to the liquid containing a monomer.

(Reaction Condition)

The polymerization activator of the invention expresses its effect in a process of redox polymerization. Accordingly, the reaction condition for it is not specifically defined so far as redox polymerization may sufficiently go on under the condition. This will be concretely described hereinunder in the section of polymerization step.

(Effect)

Adding the polymerization activator of the invention may activate redox polymerization and may increase the polymerization speed, thereby realizing rapid polymerization. Concretely, when the polymerization activator of the invention is added, then the polymerization rate may be at least 50% in 0.7 seconds after the initiation of redox polymerization, or the polymerization rate may be at least 70% in 1.5 seconds after it. More preferably, the polymerization rate may be at least 55% in 0.7 seconds after the initiation of polymerization, or the polymerization rate may be at least 75% in 1.5 seconds after it. Even more preferably, the polymerization rate may be at least 60% in 0.7 seconds after the initiation of polymerization, or the polymerization rate may be at least 80% in 1.5 seconds after it.

(1-3) Anti-Polymerization Inhibitor:

The anti-polymerization inhibitor of the invention is a reagent for reducing the polymerization-inhibitory activity of a polymerization inhibitor existing in a reaction system of redox polymerization, thereby exhibiting an effect of not increasing the remaining monomer amount in the produced polymer. The anti-polymerization inhibitor of the invention is advantageously employed especially when a monomer containing a polymerization inhibitor is used in redox polymerization, in that it may retard the polymerization-inhibitory effect of the polymerization inhibitor. In particular, it is advantageously employed when a crude (meth)acrylic acid is used in redox polymerization. The concentration in addition, the method for addition and the reaction condition for it may be the same as those mentioned hereinabove for the polymerization activator.

(Effect)

Adding the anti-polymerization inhibitor of the invention may accelerate redox polymerization and may reduce the remaining monomer amount in the polymer obtained through redox polymerization. For example, in redox polymerization using crude (meth)acrylic acid, when the anti-polymerization inhibitor of the invention is added, then the remaining monomer amount in the polymer obtained may be preferably at most 2000 ppm by weight, more preferably at most 1000 ppm by weight, even more preferably at most 500 ppm by weight, most preferably at most 300 ppm by weight.

(1-4) Remaining Monomer Amount-Reducing Agent:

The remaining monomer amount-reducing agent of the invention is a reagent capable of reducing the remaining monomer amount in a polymer obtained through redox polymerization.

(Form)

The remaining monomer amount-reducing agent of the invention is preferably in the form of a solution thereof, in consideration of the easiness and the efficiency thereof in application to polymer. Not specifically defined, the concentration of the remaining monomer amount-reducing agent of the invention in the solution thereof may be generally from 0.01 to 5% by weight in terms of the metal therein.

(Concentration in Addition, Method for Addition)

The amount of the remaining monomer amount-reducing agent of the invention to be added is from 0.01 to 100 ppm by weight in terms of the metal therein relative to the dry weight of the polymer produced through polymerization, preferably from 0.05 to 50 ppm, more preferably from 0.1 to 20 ppm. If the amount is smaller than 0.01 ppm by weight, then the remaining monomer-reducing effect may be insufficient, but on the contrary, even if the agent over an amount of 100 ppm by weight is used, it could not increase its effect but is uneconomical.

For adding the remaining monomer amount-reducing agent of the invention, preferably employed is a method of spraying or applying a solution of the transition metal compound onto the intended polymer. Not specifically defined, the temperature in addition may be generally from room temperature to 100° C. Also not specifically defined, the atmosphere in addition may be an inert gas such as nitrogen, argon or carbon dioxide, but it may also be air. In view of the easy handlability and the economical advantage thereof, air is preferred.

(Reaction Condition)

In order that the remaining monomer amount-reducing agent of the invention may sufficiently exhibit its effect, it is necessary that the transition metal compound in the agent may be satisfactorily movable in the polymer to which the agent is applied. For this, it is desirable that the water content of the polymer is generally at least 40% by weight based on the wet weight thereof, more preferably at least 45% by weight, most preferably at least 50% by weight. Water may be added to the polymer so as to satisfy this requirement. The reaction temperature is preferably from 15 to 100° C., more preferably from 25 to 100° C., most preferably from 40 to 100° C. Preferably, the relative humidity in reaction is at least 80%, more preferably at least 85%, most preferably at least 90%. Varying depending on the water content and the reaction temperature, the reaction time is preferably from 0.1 seconds to 60 minutes, more preferably from 0.5 seconds to 30 minutes, most preferably from 1 second to 20 minutes.

(Effect)

When the remaining monomer amount-reducing agent of the invention is added, then the remaining monomer amount in a polymer obtained through redox polymerization may be preferably at most 500 ppm by weight, more preferably at most 300 ppm, most preferably at most 200 ppm. The remaining monomer amount as referred to herein indicates a ratio by weight of the remaining amount of the essential monomer component (that is, the monomer component accounting for at least 50% by weight of the overall monomer component) to the purified polymer.

2. Starting Materials for Production, and Polymerization Initiator:

(2-1) Monomer:

The monomer for use in the methods of the invention is a polymerizing monomer of which the polymerization is initiated by a redox initiator. Preferably, this is a water-soluble one capable of giving a hydrophilic resin through polymerization. The hydrophilic resin as referred to herein means a polymer or crosslinked polymer having a high affinity to water and having a property of swelling or dissolving in water or in an aqueous solution. This is widely used for water-absorbent resins, water-soluble resins, coagulants and dispersants.

Typical examples of the monomer that are preferred for use in the invention are aliphatic unsaturated carboxylic acids or their salts. Concretely, they include unsaturated monocarboxylic acid or their salts such as acrylic acid or its salts, methacrylic acid or its salts; and unsaturated dicarboxylic acids or their salts such as maleic acid or its salts, itaconic acid or its salts. One or more of these may be used herein either singly or as combined. Of those, preferred are acrylic acid or its salts, and methacrylic acid or its salts; more preferred are acrylic acid or its salts. As the starting material for acrylic acid and methacrylic acid, often used is propylene starting from petroleum-derived naphtha, but propylene according to coal-derived Fischer-Tropsch synthesis may also be used.

(Crude (Meth)acrylic Acid)

Using the anti-polymerization inhibitor of the invention, so-called crude (meth)acrylic acid not sufficiently purified may be subjected to redox polymerization. The crude (meth) acrylic acid as referred to herein is (meth) acrylic acid that contains one or more polymerization inhibitors mentioned hereinunder in an amount of from 1 to 1000 ppm by weight, or contains hydroquinone monomethyl ether (MQ) in an amount of from 23° to 5000 ppm by weight. On the other hand, (meth)acrylic acid in which the concentration of any of the following polymerization inhibitors is less than 1 ppm by weight and the concentration of MQ is less than 230 ppm by weight may be differentially referred to as high-purity (meth)acrylic acid.

The polymerization inhibitors include aldehydes having from 1 to 6 carbon atoms such as furfurals; saturated or unsaturated carboxylic acids having from 1 to 6 carbon atoms such as β-hydroxypropionic acid (but excepting acetic acid, propionic acid and dimer acid); esters having from 1 to 6 carbon atoms such as protoanemonin; alkoxyhydroxy-(polycyclic) aromatic hydrocarbons except hydroquinone monomethyl ether, such as hydroquinone, hydroxymethoxynaphthalene, which may be formed as side products or may mix in the product in production, purification, treatment, storage or transportation of (meth)acrylic acid. The dimer acid as referred to herein indicates β-acryloxypropionic acid formed through dimerization of addition reaction of acrylic acid. High-purity (meth)acrylic acid industrially produced generally contains acetic acid, propionic acid and dimer acid in an amount of from 10 to 1000 ppm by weight. In general, when the high-purity acrylic acid is polymerized, then in many cases it may be used for the polymerization without any treatment for removing or reducing acetic acid, propionic acid and dimer acid therein.

(Aqueous Solution of Monomer)

As so mentioned hereinabove, the monomer for use in the invention is preferably an aliphatic unsaturated carboxylic acid or its salt. Therefore, as the aqueous solution of the monomer, preferred is an aqueous solution comprising, as the essential ingredient thereof, an aliphatic unsaturated carboxylic acid or its salt. The wording “comprising, as the essential ingredient thereof, an aliphatic unsaturated carboxylic acid or its salt” as referred to herein means that the aqueous solution contains an aliphatic unsaturated carboxylic acid or its salt in an amount of at least 50 mol %, preferably at least 80 mol % relative to the overall monomer amount therein.

Salts of an aliphatic unsaturated carboxylic acid may be generally water-soluble salts thereof, for example, alkali metal salts, alkaline earth metal salts or ammonium salts thereof. The degree of neutralization of the salts may be determined depending on the object thereof. In case of (meth)acrylic acid of giving a water-absorbent resin, it is desirable that from 20 to 90 mol % of the carboxyl group of the acid is neutralized into an alkali metal salt or an ammonium salt. When the partial neutralization degree of the (meth)acrylic acid monomer is less than 20 mol %, then the water-absorbing capability of the water-absorbent resin produced may greatly lower.

For neutralization of (meth) acrylic acid monomer, usable are alkali metal hydroxides, bicarbonates or ammonium hydroxide; but preferred are alkali metal hydroxides. Their specific examples are sodium hydroxide and potassium hydroxide.

(Copolymerizable Monomer)

In the invention, in addition to the above-mentioned aliphatic unsaturated carboxylic acids, monomers capable of copolymerizing with them may also be used and copolymerized with them within a range within which the comonomers do not detract from the properties of the produced hydrophilic resins. The comonomers include, for example, (meth)acrylamide, (poly)ethylene glycol (meth)acrylate, 2-hydroxyethyl (meth)acrylate, and include alkyl(meth)acrylates such as methyl(meth)acrylate and ethyl(meth)acrylate though they are poorly water-soluble monomers. The term “(meth)acryl” as referred to herein is meant to indicate both “acryl” and “methacryl”.

Of the monomers, those capable of giving hydrophilic resins may be used not only as the auxiliary component for the aliphatic unsaturated carboxylic acid or its salt but also as the principal monomer in the “aqueous solution of a monomer capable of giving a hydrophilic resin”.

(Monomer Concentration)

The monomer concentration in the aqueous monomer solution that contains the above-mentioned aliphatic unsaturated carboxylic acid or its salt as the essential ingredient thereof may be generally at least 20% by weight, preferably at least 25% by weight. If the concentration is smaller than 20% by weight, then the water-absorbing capability of the hydrophilic resin produced through polymerization may be unsatisfactory. The uppermost limit of the concentration is preferably about 80% by weight or so in view of the handlability of the polymerization reaction liquid. The monomer weight in estimating the monomer concentration or the concentration of the reagent of the invention relative to the monomer is the overall weight of the monomer and its salt.

(2-2) Crosslinking Agent:

Depending on the use of the polymer obtained through redox polymerization, a crosslinked structure may be introduced into the polymer. In particular, when a water-absorbent resin is produced, it is often important to introduce a crosslinked structure thereinto. An aliphatic unsaturated carboxylic acid or its salt, especially (meth)acrylic acid or its salt may form a self-crosslinked polymer by itself, but as combined with a crosslinking agent, a crosslinked structure may be positively formed in the polymer. When combined with a crosslinking agent, in general, the water-absorbing capability of the produced water-absorbent resin is bettered. For the crosslinking agent, preferably used are divinyl compounds copolymerizable with the monomer, for example, N,N′-methylenebis(meth)acrylamide, (poly)ethylene glycol (poly)methacrylates, as well as water-soluble compounds having at least two functional groups capable of reacting with a carboxylic acid, for example, polyglycidyl ethers such as ethylene glycol diglycidyl ether, and polyethylene glycol polyglycidyl ethers such as polyethylene glycol diglycidyl ether or glycerol polyglycidyl ether. Of those, especially preferred are N,N′-methylenebis(meth)acrylamide, polyethylene glycol poly(meth)acrylate and glycerol polyglycidyl ether. The amount of the crosslinking agent to be used may be from 0.001 to 3% by weight, preferably from 0.01 to 2% by weight relative to the monomer.

(2-3) Polymerization Initiator:

The polymerization initiator for use in the invention is a combination of a non-metal oxidizing agent and a non-metal reducing agent, which forms a redox system that is soluble in water in some degree. The metal as referred to herein has the same meaning as that of the above-mentioned transition metal.

The non-metal oxidizing agent includes, for example, hydrogen peroxide; persulfates such as ammonium persulfate, potassium persulfate; t-butyl hydroperoxide, cumene hydroperoxide and others; and ceric salts, chlorites, hypochlorites. Above all, non-metal oxidizing agents having a redox potential of from 0.6 to 2.5 V are preferably used in the invention. Non-metal oxidizing agents having a redox potential of from 0.6 to 2.5 V are, for example, hydrogen peroxide (1.14 V), persulfates (2.01 V), chlorites (0.66 V), and hypochlorites (0.89 V). (The parenthesized numeral indicates the redox potential of the compound.) An especially preferred non-metal oxidizing agent for use herein is hydrogen peroxide. The amount of the non-metal oxidizing agent to be used may be from 0.01 to 10% by weight, preferably from 0.1 to 2% by weight relative to the monomer.

The non-metal reducing agent is one capable of forming a redox system along with the oxidizing agent. In the invention, preferably used are non-metal reducing agents having a redox potential of from −2 to 0.3 V. Non-metal reducing agents having a redox potential of from −2 to 0.3 V are, for example, ascorbic acid (0.127 V), erythorbic acid (0.127 V) and their salts (0.127 V); thiosulfates (−0.017 V), sulfites (−1.12 V), hydrogensulfites (−0.08 V). (The parenthesized numeral indicates the redox potential of the compound.) Of those, preferred are ascorbic acid, erythorbic acid and their salts; and more preferred are ascorbic acid and its salts. The amount of the non-metal reducing agent to be used may be 0.001 to 10% by weight, preferably from 0.01 to 2% by weight relative to the monomer.

In addition, except the combination of the oxidizing agent and the reducing agent, another polymerization initiator capable of being used in radical polymerization in aqueous solution and differing from the combined agents in point of the effect and the mechanism thereof may also be used along with the combination to form a redox system. The initiator includes inorganic and organic peroxides, for example, ammonium or alkali metal, especially potassium persulfates, hydrogen peroxide, t-butyl peroxide, acetyl peroxide.

Further, an initiator known as an azo compound may also be used. For example, 2,2′-azobis(2-amidinopropne) dihydrochloride that is soluble in water in some degree may be used herein.

3. Effect:

(Redox Cycle)

The detailed effect and mechanism of the non-metal reducing agent, the non-metal oxidizing agent and the transition metal compounds are not always clarified. Not restrained by any theory, it may be considered that they may form a redox cycle system mentioned below.

1) The non-metal reducing agent reduces the transition metal to convert it into a reduced transition metal. In this stage, the non-metal reducing agent is consumed through chemical change.

2) The non-metal oxidizing agent oxidizes the reduced transition metal (the reduced transition metal reduces the non-metal oxidizing agent).

3) In the reaction 2), the non-metal oxidizing agent itself is decomposed to generate a radical polymerization initiator. In this stage, the non-metal oxidizing agent is consumed.

4) The transition metal oxidized in the reaction 2) becomes an oxidized transition metal, and it loses the ability to reduce the non-metal oxidizing agent and is inactivated.

5) The nom-metal reducing agent reduces the inactivated oxidized transition metal, and activates it as a reduced transition metal. In this stage, the non-metal reducing agent is consumed through chemical change such as oxidation.

6) The activated reduced transition metal again brings about the reaction 2).

In this redox cycle, the transition metal is not consumed, and the non-metal oxidizing agent and the non-metal reducing agents are consumed. Accordingly, it is understood that the non-metal oxidizing agent and the non-metal reducing agents are needed relatively in a large amount but the transition metal may be enough even in a minor amount. In the redox cycle, the oxidized transition metal is reduced by the non-metal reducing agent, and the concentration of the reduced transition metal is thereby increased. Accordingly, the reason for the stable polymerization behavior, not depending on the electron condition of the transition metal added, is understood. In the redox cycle, a constant amount of the reduced transition metal always exist, and therefore a stable initiator concentration may be kept for a long period of time. In addition, since a constant or more initiator concentration can be stably fed to the cycle all the time, a stable polymerization behavior can be attained even in the presence of a polymerization inhibitor in the cycle.

The necessary conditions for the quantity of the non-metal reducing agent, the non-metal oxidizing agent and the transition metal compound for use in the invention may be considered as follows:

1) The amount of the non-metal oxidizing agent is one necessary for releasing the necessary polymerization initiator throughout the entire polymerization reaction.

2) The amount of the transition metal is one suitable for reducing (catalyzing) the non-metal oxidizing agent to generate the desired initiator concentration.

3) The amount of the non-metal reducing agent is one necessary for repeatedly reducing (activating) the transition metal throughout the entire polymerization reaction.

Having assiduously studied these, we have found out the following quantity relationship.

The non-metal oxidizing agent is preferably from 0.01 to 10% by weight, more preferably from 0.1 to 2% by weight relative to the monomer. The non-metal reducing agent is preferably from 0.001 to 10% by weight, more preferably from 0.01 to 2% by weight relative to the monomer. The transition metal compound is from 0.01 to 100 pm by weight, preferably from 0.05 to 50 ppm by weight, more preferably from 0.1 to 20 ppm by weight in terms of the metal thereof relative to the monomer. The transition metal compound is from 0.0001 to 100% by weight, more preferably from 0.001 to 10% by weight, even more preferably from 0.01 to 1% by weight in terms of the metal thereof relative to the non-metal reducing agent.

(Deodorization)

The polymer of the invention, containing a transition metal compound and a non-metal reducing agent, is characterized in that it may continuously deodorize amines and thiols which are evil-smelling substances in excrement and urine.

The detailed effect and mechanism of the non-metal reducing agent and the transition metal compounds are not always clarified. Not restrained by any theory, it may be considered that they may form a redox cycle system mentioned below.

1) The non-metal reducing agent reduces the transition metal to convert it into a reduced transition metal.

2) The reduced transition metal deodorizes evil-smelling substances.

3) The transition metal oxidized in the reaction 2) or by oxygen becomes an oxidized transition metal, and it loses the deodorizing capability and is inactivated.

4) The non-metal reducing agent reduces the inactivated oxidized transition metal, and activates it into a reduced transition metal.

5) The activated reduced transition metal again brings about the reaction 2).

In this redox cycle, the oxidized transition metal is always reduced by the non-metal reducing agent, and a constant amount of the reduced transition metal always exists therein.

Accordingly, since a minor amount of the transition metal exists for a long period of time, the cycle may keep a stable deodorizing function.

Further, the quantity relationship between the non-metal reducing agent and the transition metal necessary for deodorization may be considered as follows:

1) The amount of the transition metal is one suitable for reducing and deodorizing evil-smelling substances.

2) The amount of the non-metal reducing agent is one necessary for repeatedly reducing (activating) the transition metal throughout the deodorization reaction.

Having assiduously studied these, we have found out the following quantity relationship.

The transition metal compound is from 0.01 to 100 ppm by weight, preferably from 0.05 to 50 ppm, more preferably from 0.1 to 20 ppm by weight in terms of the metal thereof relative to the dry weight of the polymer.

The non-metal reducing agent is preferably from 0.001 to 10% by weight, more preferably from 0.01 to 2% by weight relative to the dry weight of the polymer. The transition metal compound is preferably from 0.0001 to 100% by weight, more preferably from 0.001 to 10% by weight, even more preferably from 0.01 to 1% by weight in terms of the metal thereof relative to the non-metal reducing agent.

4. Production Steps:

A process for producing a polymer having practicable applications according to the methods of the invention is described hereinunder. For producing a polymer having practicable applications, the process includes a polymerization step, a remaining monomer amount-reducing step, a drying steps and optionally other additional steps, which are described hereinunder. The remaining monomer amount-reducing step is not always necessary, but is preferably attained for increasing the usefulness of the polymer. The respective steps are concretely described hereinunder.

(4-1) Polymerization Step:

The polymerization step comprises stages of preparing starting materials for redox polymerization, mixing them, reacting them and recovering the product. The polymerization promoter and/or the anti-polymerization inhibitor of the invention may be added in the starting material preparation stage or the mixing stage of the polymerization step.

In a preferred redox polymerization process, a polymerization activator and/or an anti-polymerization inhibitor are/is added to an aqueous solution of a monomer capable of giving a hydrophilic resin, for example, an aqueous monomer solution comprising an aliphatic unsaturated carboxylic acid or its salt as the essential ingredient thereof, then a redox polymerization initiator is added to and mixed with it, the polymerization of the monomer is initiated, the reaction mixture under polymerization, which contains the monomer after the initiation of the reaction and the produced polymer, is formed into liquid droplets in a vapor phase, then the polymerization is completed and the resulting hydrophilic resin is recovered, or the reaction mixture under polymerization is contacted with and/or adhered to any other material, for example, fibers, nonwoven fabric, inorganic powder, organic powder or polymer powder to give a hydrophilic resin composite, and the composite is recovered. In this, the completion of the polymerization step is meant to indicate a condition where the polymerization rate has reached at least 50%.

In another process, simultaneously with the mixing of a redox polymerization initiator with an aqueous monomer solution comprising an aliphatic unsaturated carboxylic acid or its salt as the essential ingredient thereof, or immediately after the mixing, a polymerization activator and/or an anti-polymerization inhibitor are/is added to the mixture, the polymerization of the monomer is initiated, the reaction mixture under polymerization, which contains the monomer after the initiation of the reaction and the produced polymer, is formed into liquid droplets in a vapor phase, then the polymerization is completed and the resulting hydrophilic resin is recovered, or the reaction mixture under polymerization is contacted with and/or adhered to any other material, for example, fibers, nonwoven fabric, inorganic powder, organic powder or polymer powder to give a hydrophilic resin composite, and the composite is recovered.

One preferred method of polymerizing liquid droplets in a vapor phase comprises initiating the polymerization by mixing a first liquid, which comprises an aqueous monomer solution containing any one of the oxidizing agent and the reducing agent that constitute a redox polymerization initiator, with a second liquid, which comprises an aqueous solution containing the other agent of the redox polymerization initiator and optionally a monomer, in a vapor phase.

One concrete method for it comprises, for example, separately jetting out the first liquid and the second liquid through different nozzles in such a manner that they may be jetted out through the respective nozzles and may collide with each other as their columns crossing at an angle of at least 15 degrees. In that manner, since the two liquids are made to collide with each other at a crossing angle, a part of the flowing energy from the nozzles may be utilized for the mixing of the two liquids. The crossing angle of the first liquid and the second liquid that run out through the respective nozzles may be suitably determined depending on the properties of the monomer used and on the flow rate of the liquids. For example, when the linear velocity of the liquids is large, then the crossing angle may be small.

In this case, the temperature of the first liquid may be generally from room temperature to about 60° C., preferably from room temperature to about 40° C.; and the temperature of the second liquid may also be generally from room temperature to about 60° C., preferably from room temperature to about 40° C.

In that manner, the aqueous solutions jetted out through the nozzles are made to collide with each other as their liquid columns and the two liquids are thus combined. After combined, they form a liquid column and its condition is kept for a while. After still that, the liquid column is broken into liquid droplets. The polymerization of the resulting liquid droplets is thus promoted in a vapor phase. Preferably, the size of the liquid droplets is from about 5 to 3000 μm as the diameter thereof.

Apart from the above, other various nozzles such as those proposed in JP-A 11-49805, 2003-40903, 2003-40904, 2003-40905 and 2003-113203 may also be usable herein.

The gas for the vapor phase that gives the reaction field for the initiation of the polymerization and for the formation of liquid droplets under polymerization is preferably one inert to the polymerization, such as nitrogen, helium, carbon dioxide. However, it may also be air. Including water vapor alone, the humidity in the vapor is not specifically defined. However, if the humidity is too low, then water in the aqueous monomer solution may vaporize away and the monomer may deposit before the promotion of the polymerization and, as a result, the polymerization speed may significantly lower or the polymerization may be stopped during the course of the process. The temperature of the vapor may be from room temperature to 150° C., preferably up to 100° C. The flowing direction of the gas may be either a countercurrent direction or a parallel current direction relative to the running direction of the liquid columns and the liquid droplets. However, when the residence time of the liquid droplets in the vapor phase must be long, or that is, when the monomer polymerization rate must be increased to thereby increase the viscosity of the liquid droplets, then the countercurrent mode (in the anti-gravitation direction) is preferred.

(4-2) Remaining Monomer Amount-Reducing Step:

The remaining monomer amount-reducing step is a step for reducing the remaining monomer amount by applying a remaining monomer amount-reducing agent to the polymer after the polymerization step and reacting it with the polymer. In this, the polymer after the polymerization step is meant to indicate a product under polymerization, which has a polymerization rate of at least 50% by weight and which is recovered after the finish of the operation in the polymerization step. As mentioned hereinabove, a method of spraying or applying a solution of a remaining monomer amount-reducing agent onto the intended polymer is preferably selected for the method of adding the agent to the polymer. Concretely, one preferred embodiment comprises spraying a remaining monomer amount-reducing agent to the polymer by the use of a spray nozzle, or comprises applying the agent thereto by the use of a roller brush. The remaining monomer amount-reducing agent may be excessively applied to the polymer, and thereafter the polymer may be lightly sucked with a suction roll to such a degree that the hydrophilic resin particles are not crushed or the polymer may be exposed to blowing air to thereby remove the excessive remaining monomer amount-reducing agent.

The solvent for the solution is preferably a hydrophilic solvent, for which employable are water, ethanol and acetone. From the viewpoint of the safety, the sanitary aspect, the solubilizing capability and the economical advantage thereof, water is preferred. The atmosphere for addition is not specifically defined. It may be an inert gas such s nitrogen, argon or carbon dioxide, but may also be air. In view of the easy handlability and the economical advantage thereof, air is preferred. For keeping the hydrophilic resin to be mentioned hereinunder in wet, water vapor or air containing water mist is preferred.

In order that the remaining monomer amount-reducing agent of the invention may exhibit a sufficient effect, the agent must be sufficiently movable in the hydrophilic resin to which the agent is applied. For this, it is desired that the water content of the hydrophilic resin is generally at least 40% by weight based on the wet weight thereof, more preferably at least 45% by weight, most preferably at least 50% by weight. Accordingly, the atmosphere is preferably a wet atmosphere that contains water vapor or water mist. The reaction temperature is preferably from 15 to 100° C., more preferably from 25 to 100° C., most preferably from 40 to 100° C. Varying depending on the water content and the reaction temperature, the reaction time is preferably from 0.1 seconds to 60 minutes, more preferably from 0.5 seconds to 30 minutes, most preferably from 1 second to 20 minutes.

Apart from the above, any mode described in the section (2-4) production method for water-absorbent resin composition of the invention to be described hereinunder may be suitably selected and employed for the remaining monomer amount-reducing step herein.

(4-3) Drying Step:

In general, the hydrophilic resin obtained through redox polymerization is used in various applications in dry. Accordingly, in general, a drying step must be carried out in any stage after the polymerization step. Regarding the drying condition, it is desirable that the produced hydrophilic resin is dried under a condition under which it does not significantly decompose.

Preferably, hot water at 100 to 250° C. is used for the drying, more preferably at 120 to 200° C., most preferably at 130 to 180° C. Hot air lower than 100° C. is unfavorable since drying with it may be unsatisfactory. On the other hand, when hot air higher than 250° C. is used for the drying, then it is unfavorable since the decomposition of the hydrophilic resin could not be negligible and the quality of the hydrophilic resin may lower, for example, it is colored, or the capabilities of the resin may also worsen. The drying time may depends on the drying temperature, but may be generally from 0.1 to 30 minutes.

For the drying method that satisfies the above, employable are conventional driers. For example, those disclosed in “Chemical Engineering III, 2nd Ed.” (by Shigefumi Fujita, Heiichiro Higashihata; Tokyo Kagaku Dojin, 1972, p. 352) may be used herein. Concretelymentioned are tunnel drier, band drier, turbo vertical drier, vertical drier, drum drier, cylindrical drier, IR drier, high-frequency drier.

(4-4) Other Additional Steps:

In producing a polymer according to the methods of the invention, a surface-crosslinking step and an additive addition step may be added to the production process.

(Surface-Crosslinking Step)

The surface-crosslinking step is a step of crosslinking the surface of a polymer to thereby enhance the function of the polymer or impart an additional function to the polymer. For example, for the purpose of improving the water-absorbing capability thereof, the surface of a hydrophilic polymer maybe crosslinked with a crosslinking agent. In general, a suitable amount of water may be applied to the surface of a powder water-absorbent resin along with a crosslinking agent thereto, and then the resin surface may be crosslinked by heating so to improve the properties of the resin particles, and this method is known. It may be considered that, as a result of the formation of a crosslinked structure selective in the surface, the resin may keep its shape when having absorbed water to swell with no bar to the swelling. In this step, a solution of a surface-crosslinking agent is first applied to a water-absorbent resin.

For the surface-crosslinking agent, employable are polyfunctional compounds capable of copolymerizing with monomer, such as N,N′-methylenebis(meth)acrylamide, (poly) ethylene glycol bis(meth)acrylate; and compounds having plural functional groups capable of reacting with a carboxylic acid, such as (poly)ethylene glycol diglycidyl ether. The surface-crosslinking agent may be used generally in an amount of from 0.1 to 1% by weight, preferably from 0.2 to 0.5% by weight relative to the water-absorbent resin.

Preferably, the surface-crosslinking agent is used as its solution diluted with water, ethanol, methanol or the like to have a concentration of from 0.1 to 1% by weight, preferably from 0.2 to 0.5% by weight, in order that the agent could be uniformly applied to the entire surface of a water-absorbent resin. Preferably, the crosslinking agent solution is applied to a water-absorbent resin by spraying it onto the resin by the use of a spray or by brushing it thereonto by the use of a roll brush. After the crosslinking agent solution is applied excessively to the resin, the resin may be lightly sucked with a suction roll to such a degree that the resin particles are not crushed or the resin may be exposed to blowing air to thereby remove the excessive crosslinking agent solution. The crosslinking agent solution may be applied to the resin at room temperature. After given the crosslinking agent solution, the water-absorbent resin is then heated so as to promote the crosslinking reaction, whereby a crosslinked structure is formed selectively in the surface of the water-absorbent resin. The crosslinking reaction condition may be suitably determined depending on the crosslinking agent used. In general, the reaction is attained at a temperature not lower than 100° C. for 10 minutes or more. In the invention, a crosslinked product of an unsaturated carboxylic acid polymer or a crosslinked product of a partially-neutralized acrylic acid polymer is preferably used as the water-absorbent resin.

(Additive Addition Step)

Various additives may be added to the polymer for the purpose of imparting desired functions thereto in accordance with the intended object of the polymer. The additives include stabilizer for preventing decomposition and deterioration of polymer by liquid which the polymer has absorbed, antimicrobial agent, deodorant, smell remover, aromatic agent, foamingagent, pH buffer.

<Stabilizer>

Of those, the stabilizer for preventing decomposition or deterioration of polymer by liquid which the polymer has absorbed may be a stabilizer for preventing the decomposition or deterioration of a water-absorbent resin by excretions (e.g. human urine, feces), body fluids (e.g., human blood, menstrual blood, secretions). A method of adding an oxygen-containing reducing inorganic salt and/or an organic antioxidant to a polymer is proposed in JP-A 63-118375; a method of adding an oxidizing agent is in JP-A 63-153060; a method of adding an antioxidant is in JP-A 63-127754; a method of adding a sulfur-containing reducing agent is in JP-A 63-272349; a method of adding a metal chelating agent is in JP-A 63-146964; a method of adding a radical chain inhibitor is in JP-A 63-15266; a method of adding a phosphinic acid group or phosphonic acid group-containing amine compound or its salt is in JP-A 1-275661; a method of adding a polyvalent metal oxide is in JP-A 64-29257; a method of adding a water-soluble chain transfer agent during polymerization is in JP-A 2-255804 and 3-179008. These are all usable in the invention. In addition, the materials and the methods described in JP-A 6-306202, 7-53884, 7-62252, 7-113048, 7-145326, 7-145263, 7-228788, 7-228790 are also usable herein. Concretely, for example, they include potassium oxalate titanate, tannic acid, titanium oxide, phosphinic acid amine (or its salts), phosphonic acid amine (or its salts), metal chelates. Of those, the stabilizers to human urine, human blood and menstrual blood are referred to as human urine stabilizer, human blood stabilizer, menstrual blood stabilizer, respectively.

<Antimicrobial Agent>

For preventing the polymer from being putrefied by the liquid which the polymer has absorbed, an antimicrobial agent is used. The antimicrobial agent for use herein may be suitably selected, for example, from those introduced in “New Development of Microbicidal/Antimicrobial Techniques”, pp. 17-80 (Toray Research Center, 1994); “Method for Investigation and Evaluation of Antibacterial/Antifungal Agents, and Product Planning”, pp. 128-344 (NTS, 1997); Japanese Patent No. 2760814; JP-A 39-179114, 56-31425, 57-25813, 59-189854, 59-105448, 60-158861, 61-181532, 63-135501, 63-139556, 63-156540, 64-5546, 64-5547, 1-153748, 1-221242, 2-253847, 3-59075, 3-103254, 3-221141, 4-11948, 4-92664, 4-138165, 4-266947, 5-9344, 5-68694, 5-161671, 5-179053, 5-269164, 7-165981.

For example, there are mentioned alkylpyridinium salts, benzalkonium chloride, chlorohexidine gluconate, zinc pyridione, silver-based inorganic powder. Typical examples of quaternary nitrogen-based antimicrobial agents are methylbenzethonium chloride, benzalkonium chloride, dodecyltrimethylammonium bromide, tetradecyltrimethylammonium bromide and hexadecyltrimethylammonium bromide. Heterocyclic quaternary nitrogen-based antimicrobial agents include dodecylpyridinium chloride, tetradecylpyridinium chloride, cetylpyridinium chloride (CPC), tetradecyl-4-ethylpyridinium chloride and tetradecyl-4-methylpyridinium chloride.

Other preferred antimicrobial agents are bis-biguanides. These are described in detail, for example, in U.S. Pat. Nos. 2,684,924, 2,990,425, 2,830,006, 2,863,019. A most preferred bis-biguanide is 1,6-bis(4-chlorophenyl)diguanide-hexane, and this is known as chlorohexidine and its water-soluble salts. Especially preferred are chlorohexidine chloride, acetate and gluconate.

Other some types of antimicrobial agents are also useful. For example, their examples are carbanilides, substituted phenols, metal compounds and rare earth salts of surfactants. The carbanilides include 3,4,4′-trichlorocarbanilide (TCC, trichlorocarban) and 3-(trifluoromethyl-4,4′-dichlorocarbanilide) (IRGASAN). The substituted phenols include 5-chloro-2-(2,4-dichlorophenoxy)phenol (IRGASAN DP-300). The metal compounds include salts of graphite and tin, for example, zinc chloride, zinc sulfide and tin chloride. The rare earth salts of surfactants are disclosed in EP-A 10819. Examples of the rare earth salts of the type are lanthanum salts of linear alkylbenzenesulfonates having from 10 to 18 carbon atoms.

<Deodorant, Smell Remover, Aromatic Agent>

For preventing or relieving the offensive odor of the liquid which the polymer has absorbed, usable are a deodorant, a smell remover and an aromatic agent. The deodorant, smell remover and aromatic agent for use herein may be suitably selected, for example, from those introduced in “Novel Techniques and View of Deodorants and Smell Removers” (Toray Research Center, 1994); JP-A 59-105448, 60-158861, 61-181532, 1-153748, 1-221242, 1-265956, 2-41155, 2-253847, 3-103254, 5-269164, 5-277143. Concretely, the deodorant and the smell remover include iron complexes, tea extracts and activated charcoal. The aromatic agent includes, for example, perfumes (citral, cinnamic aldehyde, heliotopin, camphor, bornyl acetate) pyroligneous acid, paradichlorobenzene, surfactants, higher alcohols, terpene compounds (limonene, pinene, camphor, borneol, eucalyptol, eugenol).

<Foaming Agent, Foaming Promoter>

For increasing the porosity and increasing the surface area of the water-absorbent resin so as to improve the water-absorbing capability thereof, a foaming agent and a foaming promoter may be added to the resin. The foaming agent and the foaming promoter for use herein may be suitably selected from, for example, those introduced in “Chemicals for Rubber/Plastic” (Rubber Digest, 1989, pp. 259-267). For example, there are mentioned sodium bicarbonate, nitroso compounds, azo compounds, sulfonyl hydrazide.

<pH Buffer>

For deodorization and antimicrobial purpose, a pH buffer capable of controlling the pH of the hydrophilic resin may be added to the resin.

These additives may be suitably added in the process of producing the polymer through redox polymerization, depending on the object, the effect and the mechanism thereof. For example, the foaming agent is suitably added before or during the polymerization step in producing the hydrophilic resin. The human urine stabilizer, the human blood stabilizer, the antimicrobial agent, the deodorant, the aromatic agent and the pH buffer may be added in the process of producing the hydrophilic resin or in the process after it for producing hydrophilic articles.

[II] Water-Absorbent Resin Composite of the Invention

Preferably, the water-absorbent resin composite of the invention is a composite A described below, but may include other composite B and composite C to be described hereinunder.

1. Composite A:

(1-1) Structure and Constitutive Elements:

The composite A includes one nearly-spherical highly water-absorbent resin particle and two or more fibers. One or more fibers in the composite A are such that a part of the fibers are embedded in the highly water-absorbent resin particle while a part thereof are exposed out of the highly water-absorbent resin particle. One or more fibers in the composite A are such that the fibers are not embedded in the highly water-absorbent resin particle but a part of the fibers adhere to the surface of the highly water-absorbent resin particle. Accordingly, the indispensable constitutive elements of the composite A are the following three:

(1) a highly water-absorbent resin particle,

(2) a fiber partly embedded in the highly water-absorbent resin particle and partly exposed out of the highly water-absorbent resin particle (this is hereinafter referred to as “partly-embedded fiber”),

(3) a fiber partly adhering to the surface of the highly water-absorbent resin particle but not embedded in the highly water-absorbent resin particle (this is hereinafter referred to as “surface-adhering fiber”).

In the following, the fibers bonding to the highly water-absorbent resin particle in the composite A, or that is, the partly-embedded fiber and the surface-adhering fiber may be generically referred to as “bonding fibers”.

The dry weight ratio of the bonding fibers to the highly water-absorbent resin particles in the composite A is preferably from 1/1 to 1/1,000,000, more preferably from 1/2 to 1/100,000, even more preferably from 1/3 to 1/10,000.

The weight ratio of the partly-embedded fibers to all the bonding fibers constituting the composite A may be determined depending on the balance of the functions that the partly-embedded fibers and the surface-adhering fibers shall have, which will be described hereinunder, but may be generally from 0.01 to 0.99, preferably from 0.05 to 0.95, more preferably from 0.1 to 0.9.

(1-2) Individual Constitutive Elements:

1) Highly Water-Absorbent Resin:

In the composite A, the highly water-absorbent resin has a role of absorbing a liquid such as water, urine, blood or menstrual blood, depending on its object for use thereof.

(Chemical Composition)

The highly water-absorbent resin in the composite A is a polymer having a saturated water absorbability of from 1 to 1000 times or so of its self-weight at room temperature under normal pressure, as its saturated water absorbability of absorbing a liquid such as water, urine, blood, menstrual blood. For absorbing the liquid, the resin must have a functional group having a high affinity to the liquid, in the polymer chain thereof. For the functional group, usable are (partially) neutralized carboxylic acids, carboxylic acids, (partially) neutralized sulfonic acids, sulfonic acids, and hydroxy. Of those, preferred are partially-neutralized carboxylic acids. As the monomer capable of giving a partially-neutralized carboxylic acid to the polymer chain, preferred are unsaturated carboxylic acids, and more preferred is acrylic acid.

The molecular structure of the polymer may be linear, but it must keep its shape even after having absorbed a desired liquid and having thereby swollen. Accordingly, in general, the polymer is preferably a crosslinked polymer having a crosslinked structure of polymer chains therein so that the polymer chains do not dissolve. For the crosslinking, usable is chemical crosslinking such as covalent bonding or ionic bonding, or physical crosslinking formed through entangling of polymer chains. From the viewpoint of the chemical stability of the polymer, chemical crosslinking is preferred, and covalent bonding is more preferred.

Accordingly, One preferred embodiment of the highly water-absorbent resin is a crosslinked, unsaturated carboxylic acid polymer, more preferably a crosslinked acrylic acid polymer.

(Shape)

The highly water-absorbent resin particles are nearly spherical particles. The wording, nearly spherical as referred to herein is meant to indicate particles having a true-spherical or oval shape as a whole, and the surface of the particle may be rough (that is, it may have fine wrinkles, projections, recesses). Further, the surface and the inside of the particle may have voids such as pores or cracks. Preferably, the mean particle size of the highly water-absorbent resin particles is from 50 to 1000 μm, more preferably from 100 to 900 μm, even more preferably from 200 to 800 μm.

Those having indefinite and sharp cut sections, such as conventional, ground highly water-absorbent resin particles are defective in that they may too much irritate the skin and that their sharp cut sections may be broken to give fine particles when some mechanical load is applied thereto. However, the nearly spherical, highly water-absorbent resin particles for use in the invention are free from the drawback. In addition, as compared with the indefinitely-cut particles, they have another advantage that they may be compacted as they accept a mode of closest packing.

2) Bonding Fibers:

As so mentioned hereinabove, the bonding fibers include partly-embedded fibers and surface-adhering fibers. These fibers are described in detail hereinunder.

(Species of Fibers)

For the fibers, usable are synthetic fibers, natural fibers, semi-synthetic fibers, inorganic fibers.

Preferably, the fibers firmly adhere to the highly water-absorbent resin both before and after water absorption, from the viewpoint of the fixation property of the highly water-absorbent resin.

In general, it is known that the adhesion power between different substances is higher when the affinity between them is larger. The highly water-absorbent resin is one of most hydrophilic substances, and from this meaning, it may be said that more hydrophilic fibers may have a larger adhesion power to the highly water-absorbent resin. As a quantitative criterion for the hydrophilicity of fibers, herein employable is a contact angle with water. Specifically, when the contact angle is smaller (or that is, when the hydrophilicity is larger), then the adhesion power may be larger; but on the contrary, when the contact angle is larger (or that is, when the hydrophilicity is smaller), then the adhesion power may be smaller. To that effect, the contact angle with water on the surface of the fiber material is preferably at most 90°, more preferably at most 70°, even more preferably at most 60°, still more preferably at most 50°, most preferably at most 40°. The hydrophilic fibers having a higher degree of hydrophilicity as referred to herein are defined as such that the contact angle with water on the surface of the fiber material is at most 60°.

For such hydrophilic fibers, herein selected are one or more different types of fibers of pulp, rayon, cotton, regenerated cellulose and other cellulosic fibers, polyamides and polyvinyl alcohols. When such hydrophilic fibers are used, then not only the adhesion power thereof to the highly water-absorbent resin may be reinforced but also the other effects of the hydrophilic fibers, for example, the effect thereof for attracting water to the highly water-absorbent resin, or that is the liquid-attracting property thereof may be increased. In particular, in applications to sanitary materials, pulp is preferred as the hydrophilic fibers because of the low irritation thereof to the skin and of the soft touch thereof.

For the bonding fibers, also usable are fibers capable of adhering to the highly water-absorbent resin but having a small degree of hydrophilicity (or that is, having a high degree of hydrophobicity), namely, hydrophobic fibers. For example, they are polyester, polyethylene, polypropylene, polystyrene, polyvinyl chloride, polyvinylidene chloride, polyacrylonitrile, polyurea, polyurethane, polyfluoroethylene and polyvinylidene cyanide fibers. One or more different types of these fibers may be used either singly or as combined. The advantage of using the hydrophobic fibers includes improvement of liquid permeability and liquid diffusibility through the fibers.

In this case, for example, hydrophilic fibers may be selected for the partly-embedded fibers, and hydrophobic fibers for the surface-adhering fibers. In this embodiment, the hydrophilic fibers may be firmly embedded in the water-absorbent resin and the hydrophobic fibers may be expected to improve the water diffusibility through the water-absorbent resin.

For ensuring the necessary adhesiveness, the weight fraction of the hydrophilic fibers in the surface-adhering fibers is preferably at least 0.1, more preferably at least 0.2, even more preferably at least 0.3, most preferably at least 0.5.

The hydrophilicity and the hydrophobicity of the series of the fibers mentioned above are not absolute but may vary depending on the raw materials of the fibers, the presence or absence of modification treatment for them and the type of the fibers. Accordingly, the hydrophilicity and the hydrophobicity of the fibers to be used herein are evaluated through measurement of the contact angle thereof with water.

The contact angle with water depends on the shape and the surface smoothness of the fiber material to be measured. The contact angle with water in the invention means the contact angle with distilled water measured as follows: The fiber material to be measured is shaped into a film or a sheet, and the contact angle with distilled water of its smooth surface is measured, using the apparatus shown in the section of Examples given hereinunder.

(Shape)

From the viewpoint of blocking prevention, it is also important to select the bonding fibers in consideration of the rigidity and the diameter of the fibers to be mentioned hereinunder.

The bonding fibers for use in the invention preferably have a fiber length of from 50 to 50,000 μm. The fiber length of the bonding fibers is more preferably from 100 to 30,000 μm, even more preferably from 500 to 10,000 μm. If the fibers are longer than 50,000 μm, then plural fibers may adhere to the highly water-absorbent resin particle so that the independence of each composite A could not be ensured, and, as a result, the composition containing the composite A may be difficult to open. On the contrary, fibers shorter than 50 μm may be difficult to embed in the highly water-absorbent resin particle or to adhere to it.

In order that the composite A may have a desired shape, the ratio of the particle size of the highly water-absorbent resin particles/fiber length is preferably from 2/1 to 1/1000, more preferably from 1/1 to 1/500, even more preferably from 1/2 to 1/100.

In the invention, the fiber diameter of the bonding fibers is preferably from 0.1 to 500 decitex, more preferably from 0.1 to 100 decitex, even more preferably from 1 to 50 decitex, still more preferably from 1 to 10 decitex. When the fiber diameter of the bonding fiber is larger than 500 decitex, then the rigidity of the fibers may be too large so that not only the fibers may be difficult to embed in the highly water-absorbent resin particle or to adhere to it but also the fibers may be difficult to shape under compression and they may be unfavorable for thinned products. In addition, in applications to sanitary goods and the like, the fibers may be rough and may irritate the skin and their touch may be unfavorable. On the contrary, when the fiber diameter is smaller than 0.1 decitex, then the fibers may be too thin and could not ensure the above-mentioned liquid permeability and diffusibility through them. In addition, since the rigidity thereof is poor, the fibers could not prevent a blocking phenomenon (of forming lumps).

Regarding their outward appearance, the fibers may be either straight or shrunk such as crimped.

From the above-mentioned various viewpoints, the fiber species, the fiber length, the fiber diameter and the outward appearance of the bonding fibers may be suitably selected.

(Partly-Embedded Fibers)

The partly-embedded fibers have a role of ensuring the fixation of the highly water-absorbent resin particles. The fibers improve the fixation of the highly water-absorbent resin particles both before water absorption and after water absorption. Specifically, the fibers extending from the surfaces of the highly water-absorbent resin particles prevent the rotary movement and the parallel movement of the highly water-absorbent resin particles during under pressure. Since the fibers are partly embedded in the highly water-absorbent resin particles and therefore do not separate from the highly water-absorbent resin particles even after water absorption, they may exhibit an important role for fixation after water absorption. Regarding the shape thereof, the fibers to be used for the partly-embedded fibers may have a hollow shape or a side-by-side shape for increasing the liquid permeability through them.

In case where the partly-embedded fibers are formed of hydrophilic fibers, then the fibers exhibit an effect of increasing the water permeability to the highly water-absorbent resin particles. Specifically, water may be directly led to the inside of the highly water-absorbent resin particles via the fibers. For more effectively attaining the function, it is desirable that the above-mentioned fibers of high liquid permeability are selected and used for the partly-embedded fibers.

Further, the partly-embedded fibers have a role of ensuring the independence of the individual water-absorbent resin composite particles. In the step of polymerization of composite precursor to be mentioned hereinunder, the fibers prevent the fusion of the highly water-absorbent resin particles to each other owing to their steric hindrance from each other. Specifically, the fibers extending from the surfaces of the highly water-absorbent resin particles interfere with the contact of the highly water-absorbent resin particles to each other during the polymerization inside the composite precursor, and therefore prevent the fusion of the highly water-absorbent resin particles to each other. As a result, the individual water-absorbent resin composites (precursors) may ensure their independence, therefore being prevented from adhering to the reactor wall during the production step and the treatment step, and may ensure the openability thereof to be mentioned hereinunder.

On the other hand, the partly-embedded fibers may give suitable physical entanglement to the water-absorbent resin composites with each other, and when a plural number of the composites A's are collected and formed into a mass, the fibers may give a shape-retaining capability to the mass so that the mass is not readily pulverized by its self-weight or so. Specifically, even though any free fibers are not added thereto, the composite A may have a shape-retaining capability by itself.

Accordingly, the significant characteristic of the composite A is that it is openable and has a shape-retaining capability. In addition, the partly-embedded fibers may give a soft and smooth feel to the composite A, and combined with the nearly spherical, highly water-absorbent resin particles, they are extremely soft even when pressed while in dry, and are therefore favorable to sanitary materials.

(Surface-Adhering Fibers)

The surface-adhering fibers have an effect for ensuring the fixation of the highly water-absorbent resin particles before water absorption. Further, after swollen, the fibers on the surfaces of the highly water-absorbent resin particles may form voids between the highly water-absorbent resin particles, therefore having an effect of ensuring the pathways for water. For obtaining the effect, the surface-adhering fibers may not be always kept adhering to the highly water-absorbent resin particles after water absorption, but preferably at least the surface-adhering fibers are tightly disposed on the surfaces of the highly water-absorbent resin particles. For this, it is advantageous that the fibers are kept adhering to the highly water-absorbent resin particles before water absorption. As the case may be, it may also be favorable that, for forming voids between the highly water-absorbent resin particles so as to ensure the pathways for water, the fibers to be used have predetermined rigidity. Combined with the above-mentioned partly-embedded fibers, the surface-adhering fibers have an additional effect for ensuring the fixation of the highly water-absorbent resin particles before water absorption. Regarding the shape thereof, the fibers to be used for the surface-adhering fibers may have a hollow structure of a side-by-side structure for increasing the diffusibility through them.

When the surface-adhering fibers are formed of hydrophilic fibers, then the fibers exhibit an effect of preventing a blocking phenomenon (of forming lumps), which is such that the highly water-absorbent resin particles having absorbed water are swollen and are contacted with each other to block the pathways for water. Specifically, in water absorption, the fibers have a role of uniformly transporting and diffusing water to the surface of each water-absorbent resin composite. On the other hand, when the surface-adhering fibers are formed of hydrophobic resin, then the fibers exhibit a function of improving the water diffusibility between the water-absorbent resin composites.

Further, owing to the same effect thereof as that of the partly-embedded fibers mentioned above, the surface-adhering fibers may have a role of ensuring the independence, the shape-retaining capability and the soft and smooth touch of the individual composites A's, and may give them the same result as above.

(1-3) Characteristics:

1) Satisfaction of both Fixation Property and Water-Absorbing Capability (Composite Effects of Individual Fibers)

In general, the ability to ensure and maintain the fixation property of the highly water-absorbent resin particles and the ability thereof to ensure the water-absorbing capability such as that under pressure are contradictory to each other. Specifically, in order that the resin particles may ensure a sufficient fixation property not only before water absorption but also after water absorption, a strong adhesion power is needed between the highly water-absorbent resin and the fibers, which exceeds the water-absorbing and swelling power of the resin even after water absorption. This brings about nothing but the interference with the water-absorbing and swelling property of the highly water-absorbent resin itself by the fibers, and therefore does not give a sufficient water-absorbing capability. On the contrary, when the adhering face between the highly water-absorbent resin and the fibers is made to freely swell in order to ensure the fixation-retaining capability and the water-absorbing capability such as that under pressure, then this means breakage of the adhering face between the highly water-absorbent resin and the fibers, and therefore does not give a sufficient fixation property.

In the composite A, both the partly-embedded fibers and the surface-adhering fibers are indispensable. In other words, a composite having only the partly-embedded fibers could not have a sufficient effect for preventing the blocking phenomenon (of forming lumps) in water absorption. On the other hand, a composite having only the surface-adhering fibers is insufficient in point of the fixation property of the highly water-absorbent resin particles after water absorption. Accordingly, in order that the composite may exhibit the above-mentioned effects all the time before and after water absorption, both the fibers are indispensable therein.

In the composite A, the water-absorbent resin composite has both the partly-embedded fibers and the surface-adhering fibers, and the co-existence of the two therein has enabled both the retention of the fixation property and the retention of the water-absorbing capability of the highly water-absorbent resin particles, which are, however, naturally contradictory to each other. Specifically, the composite A has a remarkable characteristic in that it may ensure a sufficient fixation property not only before water absorption but also even after water absorption, and may ensure not only the shape-retaining capability but also the water-absorbing capability under pressure. The partly-embedded fibers and the surface-adhering fibers may be the same or different in point of the type of the fibers, and they may be suitably selected depending on the object for their use and for the purpose of expressing their respective effects.

2) Openability:

One characteristic of the composite A is that not only the aggregate of the composites A's is openable but also the water-absorbent resin composite composition containing the composite A may also be openable. The characteristic of the type is ensured since the individual composites A's are substantially independent of each other. Specifically, it is desirable that the fibers constituting one composite A do not substantially adhere to any other composite A. For this, it is desirable that the fiber length of the fibers to be used is suitably selected as in the above, though depending on the production condition. The openability may be evaluated by the easiness in combing and by the broken condition of the highly water-absorbing resin particles after combed, as demonstrated in Examples given hereinunder.

3) Shape-Retaining Property:

Further, the composite A is also characterized in that not only the aggregate of the composites A's has a shape-retaining property but also the water-absorbent resin composite composition containing the composite A may be made to have a shape-retaining property. As so mentioned hereinabove, the bonding fibers in the composite A give suitable physical entanglement to the individual water-absorbent resin composites with each other, and give thereto a shape-retaining property of such that, when the water-absorbent resin composite composition containing the composite A is formed into a mass, then the mass is not readily pulverized by its self-weight or so.

2. Composite B:

The “composite B” is “a water-absorbent resin composite in which the highly water-absorbent resin particles are nearly spherical, one or more of the above-mentioned fibers are partly embedded in the resin particles and are partly exposed out of the resin particles, and all the fibers do not adhere to the surfaces of the resin particles”, or that is, it contains one or more partly-embedded fibers as the bonding fibers but does not contain surface-adhering fibers.

The fibers in the composite B may be selected in the same manner as that for the fibers described in the section of the bonding fibers for the composite A.

The dry weight ratio of the bonding fibers (partly-embedded fibers) to the highly water-absorbent resin in the composite B is preferably from 1/1 to 1/1,000,000, more preferably from 1/2 to 1/100,000, even more preferably from 1/3 to 1/10,000.

3. Composite C:

The “composite C” is “a water-absorbent resin composite in which the highly water-absorbent resin particles are nearly spherical, one or more of the above-mentioned fibers partly adhere to the surfaces of the resin particles but the fibers are not embedded at all in the resin particles”, or that is, it contains one or more surface-adhering fibers as the bonding fibers but does not contain partly-embedded fibers.

The fibers in the composite C may be selected in the same manner as that for the fibers described in the section of the bonding fibers for the composite A.

The dry weight ratio of the bonding fibers (surface-adhering fibers) to the highly water-absorbent resin in the composite C is preferably from 1/1 to 1/1,000,000, more preferably from 1/2 to 1/100,000, even more preferably from 1/3 to 1/10,000.

4. Remaining Monomer:

The water-absorbent resin composite of the invention is characterized in that the amount of the remaining monomer in the composite is small. The acceptable remaining monomer concentration may vary depending on the field of applications, the use and the mode of use. In general, for example, the remaining monomer amount to be in sanitary materials is required to be small as compared with that in non-sanitary materials. The amount of the remaining monomer in the water-absorbent resin composite of the invention is at most 2000 ppm, preferably at most 1000 ppm, more preferably at most 500 ppm, most preferably at most 300 ppm. For realizing it, specific steps may be required as in the method for producing the water-absorbent resin composite described hereinunder. This is because, in general, when a side material such as fibers is made to exist in the system of polymerization, then the monomer may diffuse into the side material or impurities may mix in the monomer from the side material, and in general, the remaining monomer concentration in the water-absorbent resin composite is often higher than the remaining monomer concentration in a polymer not combined with a side material. The remaining monomer amount in the water-absorbent resin composite is desired to be as small as possible, but when it could be reduced to 500 ppm or so, then it may not cause any specific problem in applications of the composite for sanitary materials.

[III] Water-Absorbent Resin Composite Composition of the Invention

1. Structure:

The water-absorbent resin composite composition of the invention preferably contains the above-mentioned composite A. More preferably, it contains the composite A in a weight fraction of at least 0.1, even more preferably at least 0.2, still more preferably at least 0.3.

Containing the composite A, the water-absorbent resin composite composition of the invention may further contain the above-mentioned composite B and composite C and any other constitutive components such as free fibers mentioned hereinunder. However, it is important that the respective components are independent of each other and are openable by themselves and that the composition is also openable by itself.

(Free Fibers)

“Free fibers” are “fibers neither embedded nor adhering to the highly water-absorbent resin”, and the water-absorbent resin composite composition of the invention may contain one or more such free fibers. Containing free fibers, the water-absorbent resin composite composition of the invention may be further improved in point of the bending resistance, the soft touch, the liquid permeability, the liquid penetrability, the water diffusibility and the air permeability thereof.

For free fibers, employable are synthetic fibers, natural fibers, semi-synthetic fibers and inorganic fibers, like those for the bonding fibers. The fibers to be used for free fibers may be selected in accordance with the object for use of the water-absorbent resin composite composition of the invention. For example, when the water-absorbent resin composite composition is used for absorbent articles, then hydrophilic fibers are preferably selected for the free fibers therein.

For the hydrophilic fibers, herein selected are one or more different types of fibers of pulp, rayon, cotton, regenerated cellulose and other cellulosic fibers, polyamides and polyvinyl alcohols. When such hydrophilic fibers are used, they may improve the liquid permeability of the water-absorbent resin composite composition of the invention. In particular, in applications to sanitary materials, pulp is preferred as the hydrophilic fibers because of the low irritation thereof to the skin and of the soft touch thereof.

On the other hand, hydrophobic fibers may also be used for the free fibers. For example, they may be one or more different types of polyester, polyethylene, polypropylene, polystyrene, polyvinyl chloride, polyvinylidene chloride, polyacrylonitrile, polyurea, polyurethane, polyfluoroethylene and polyvinylidene cyanide fibers. The advantage of using the hydrophobic fibers includes improvement of liquid permeability and water diffusibility of the water-absorbent resin composite composition of the invention.

Different from the above-mentioned bonding fibers, the free fibers are not specifically defined in point of the affinity thereof to the highly water-absorbent resin or of the affinity thereof to the water-absorbent resin composite. Accordingly, the species of the fibers to be employed for the free fibers may be the same as or different from that of the bonding fibers to be in the above-mentioned composite A, composite B or composite C. For example, hydrophilic fibers may be selected for the bonding fibers and hydrophobic fibers may be selected for the free fibers. In this embodiment, when employed herein, the hydrophobic fibers may exhibit the function of improving the water diffusibility through the water-absorbent resin composites.

In addition, from the viewpoint of blocking prevention, it is also important to select the fibers in consideration of the rigidity and the diameter of the fibers to be mentioned hereinunder.

The free fibers for use in the invention preferably have a mean fiber length of from 50 to 100,000 μm, more preferably from 100 to 50,000 μm, even more preferably from 500 to 20,000 μm. When the fibers have a fiber length longer than 100,000, then the composition may be difficult to open. On the contrary, when the fibers are shorter than 50 μm, then their mobility is too large and would be problematic in that the fibers may leak from the composition.

The mean fiber diameter of the free fibers is preferably from 0.1 to 500 decitex, more preferably from 0.1 to 100 decitex, even more preferably from 1 to 50 decitex, still more preferably from 1 to 10 decitex. When the fiber diameter is larger than 500 decitex, then the rigidity of the fibers may be too high and, as a result, not only the fibers may be difficult to mix with the water-absorbent resin composite but also the composite may be difficult to shape under compression and may be unfavorable for thinned products. In addition, in applications to sanitary goods and the like, the fibers may be rough and may irritate the skin and their touch may be unfavorable. On the contrary, when the fiber diameter is smaller than 0.1 decitex, then the fibers may be too thin and could not ensure the above-mentioned liquid permeability and diffusibility through them. In addition, since the rigidity thereof is poor, the fibers could not prevent blocking (of forming lumps).

In case where free fibers are added, then the dry weight ratio of the highly water-absorbent resin to all the fibers (total of the free fibers and the bonding fibers) in the water-absorbent resin composite composition of the invention is preferably from 95/5 to 5/95, more preferably from 90/10 to 7/93, even more preferably from 85/15 to 10/90. When the amount of the fibers is larger than the range, then the composite may have drawbacks in that it may hardly express the substantial effect of the highly water-absorbent resin and its bulk density may be small. On the other hand, when the amount of the fibers is smaller than the range, then further improvement in the flexibility, the soft touch, the liquid permeability, the liquid penetrability, the water diffusibility and the vapor permeability of the resin composition would be insufficient.

2. Remaining Monomer:

It is desirable that the amount of the remaining monomer in the composition in the water-absorbent resin composite of the invention is small. The acceptable remaining monomer concentration may vary depending on the field of applications, the use and the mode of use. In general, for example, the remaining monomer amount to be in sanitary materials is required to be small as compared with that in non-sanitary materials. Concretely, the amount of the remaining monomer in the composite is preferably at most 2000 ppm, more preferably at most 1000 ppm, even more preferably at most 500 ppm, most preferably at most 300 ppm. For realizing it, specific steps must be carried out as in the production method described hereinunder. This is because, in general, when a side material such as fibers is made to exist in the system of polymerization, then the monomer may diffuse into the side material or impurities may mix in the monomer from the side material, and in general, the remaining monomer concentration in the water-absorbent resin composite composition is often higher than the remaining monomer concentration in a polymer not combined with a side material. The remaining monomer amount in the water-absorbent resin composite composition is desired to be as small as possible, but when it could be reduced to 500 ppm or so, then it may not cause any specific problem in applications of the composite composition for sanitary materials.

[IV] Method for Producing Water-Absorbent Resin Composite of the Invention

1. Starting Materials:

(1-1) Monomer:

The type of the monomer to be used is not defined so far as the monomer may give a highly water-absorbent resin. Especially preferably, however, a monomer of which the polymerization is initiated by a redox initiator is used, and, in general, the monomer is preferably soluble in water.

Typical examples of the monomer that are preferred for use in the invention are aliphatic unsaturated carboxylic acids or their salts. Concretely, they include unsaturated monocarboxylic acid or their salts such as acrylic acid or its salts, methacrylic acid or its salts; and unsaturated dicarboxylic acids or their salts such as maleic acid or its salts, itaconic acid or its salts. One or more of these may be used herein either singly or as combined. Of those, preferred are acrylic acid or its salts, and methacrylic acid or its salts; more preferred are acrylic acid or its salts.

As so mentioned hereinabove, the monomer of giving a highly water-absorbent resin for use in the invention is preferably an aliphatic unsaturated carboxylic acid or its salt. Therefore, as the aqueous solution of the monomer, preferred is an aqueous solution comprising, as the essential ingredient thereof, an aliphatic unsaturated carboxylic acid or its salt. The wording “comprising, as the essential ingredient thereof, an aliphatic unsaturated carboxylic acid or its salt” as referred to herein means that the aqueous solution contains an aliphatic unsaturated carboxylic acid or its salt in an amount of at least 50 mol %, preferably at least 80 mol % relative to the overall monomer amount therein.

Salts of an aliphatic unsaturated carboxylic acid may be generally water-soluble salts thereof, for example, alkali metal salts, alkaline earth metal salts or ammonium salts thereof. The degree of neutralization of the salts may be determined depending on the object thereof. In case of acrylic acid, it is desirable that from 20 to 90 mol % of the carboxyl group of the acid is neutralized into an alkali metal salt or an ammonium salt. When the partial neutralization degree of the acrylic acid monomer is less than 20 mol %, then the water-absorbing capability of the water-absorbent resin produced may greatly lower.

For neutralization of acrylic acid monomer, usable are one or more of alkali metal hydroxides, bicarbonates or ammonium hydroxide; but preferred are alkali metal hydroxides. Their specific examples are sodium hydroxide and potassium hydroxide.

In the invention, in addition to the above-mentioned aliphatic unsaturated carboxylic acids or their salts, monomers capable of copolymerizing with them may also be used within a range within which the comonomers do not detract from the properties of the produced highly water-absorbent resins. The comonomers include, for example, (meth)acrylamide, (poly)ethylene glycol (meth)acrylate, 2-hydroxyethyl (meth)acrylate, and include alkyl acrylates such as methyl acrylate and ethyl acrylate though they are poorly water-soluble monomers. The term “(meth)acryl” as referred to herein is meant to indicate both “acryl” and “methacryl”. Of the monomers, those capable of giving highly water-absorbent resins may be used not only as the auxiliary component for the aliphatic unsaturated carboxylic acid or its salt but also as the principal monomer in the “aqueous solution of a monomer capable of giving a highly water-absorbent resin”.

(Monomer Concentration)

The monomer concentration in the aqueous monomer solution that contains the above-mentioned aliphatic unsaturated carboxylic acid or its salt as the essential ingredient thereof may be generally at least 20% by weight, preferably at least 25% by weight. If the concentration is smaller than 20% by weight, then it is unfavorable since the water-absorbing capability of the highly water-absorbent resin produced through polymerization may be unsatisfactory.

(1-2) Crosslinking Agent:

An aliphatic unsaturated carboxylic acid or its salt, especially acrylic acid or its salt may form a self-crosslinked polymer by itself, but as combined with a crosslinking agent, a crosslinked structure may be positively formed in the polymer. When combined with a crosslinking agent, in general, the water-absorbing capability of the produced highly water-absorbent resin is bettered. For the specific examples and the amount to be used of the crosslinking agent, referred to is the description in (2-2) in the section of redox polymerization given hereinabove.

(1-3) Polymerization Initiator:

The polymerization initiator for use herein may be any one generally used in radical polymerization in aqueous solution. For the specific examples and the amount to be used of the polymerization initiator, referred to is the description in (2-3) in the section of redox polymerization given hereinabove.

Polymerization is initiated by decomposition of a radical polymerization initiator. A method generally well known for it is thermal decomposition. In some case, a polymerization initiator not heated is added to a monomer in a reaction liquid previously heated up to the decomposition temperature of the polymerization initiator, and the polymerization of the monomer is initiated. This also belongs to the category of thermal decomposition.

(1-4) Fibers:

The species and the form of the fibers for use herein may be suitably selected in the manner as above.

Preferably, the fibers are uniformly dispersed as microscopically as possible. In general, the fibers tend to form fiber masses through entanglement thereof. Preferably, the apparent diameter of the fiber mass is at most 20 mm, more preferably at most 10 mm, most preferably at most 5 mm. Needless-to-say, it is desirable that the fibers are independent of each other and are individually separated from each other. For ensuring the uniformity, generally employed is a method of opening. “Opening” is meant to include the two concepts of splitting and fibrillation. Splitting includes tearing a sheet of nylon or the like into strips or fibers. Fibrillation includes pulverizing raw paper cellulose into pulp.

For concrete methods for the technique, suitably employed are cotton spinning-type, worsted spinning-type, woollen spinning-type, hard and bast fiber spinning-type, waste silk spinning-type or rotary blade-type grinders, hammer-type grinders or pulp beaters, as introduced in “Fiber Handbook (edition for processing”)” (edited by the Fiber Society of Japan, Maruzen, 1969), p. 18, ff. Also employable is a known method of flocking, which comprises charging fibers and then making them substantially independent of each other by utilizing the electrostatic repulsion between the fibers to there by uniformly disperse them.

(1-5) Polymerization Activator:

The polymerization activator is a reagent of activating radical polymerization such as redox polymerization to thereby realize the reduction in the remaining monomer amount. The effect of the polymerization activator is evaluated by the relative polymerization rate increase between the system with the agent added and the system with the agent not added, in the polymerization rate of the product under polymerization. Specifically, the polymerization rate increase (%) is calculated according to the following formula:
[{(polymerization rate in the system with the agent added)−(polymerization rate in the system with the agent not added)}/(polymerization rate in the system with the agent not added)]×100.

Preferably, the polymerization activator attains a polymerization rate increase of at least 3%, more preferably at least 5%, most preferably at least 10%.

The polymerization activator preferably contains a transition metal compound. For the concrete examples and the amount to be used of the transition metal compound, referred to is the description in (1-1) in the section of redox polymerization given hereinabove.

2. Production Steps:

(2-1) Polymerization Step:

The method for producing the water-absorbent resin composite of the invention is not specifically defined. In one preferred method for it, a redox polymerization initiator is added to an aqueous solution of a monomer capable of giving a highly water-absorbent resin, for example, an aqueous solution of a monomer comprising an aliphatic unsaturated carboxylic acid or its salt as the essential ingredient thereof, then the polymerization of the monomer is initiated, the reaction mixture under polymerization, which contains the monomer after the initiation of the reaction and the produced polymer, is formed into liquid droplets in a vapor phase, the liquid droplets are contacted with fibers having been fed and dispersed in the vapor phase to give a water-absorbent resin composite precursor, the polymerization is then completed to give a water-absorbent resin composite, and the resulting composite is recovered.

One preferred method of polymerizing liquid droplets in a vapor phase comprises initiating the polymerization by mixing a first liquid, which comprises an aqueous monomer solution containing any one of the oxidizing agent and the reducing agent that constitute a redox polymerization initiator, with a second liquid, which comprises an aqueous solution containing the other agent of the redox polymerization initiator and optionally a monomer, in a vapor phase.

One concrete method for it comprises, for example, as shown in the following Example, separately jetting out the first liquid and the second liquid through different nozzles in such a manner that they may be jetted out through the respective nozzles and may collide with each other as their columns crossing at an angle of at least 15 degrees. In that manner, since the two liquids are made to collide with each other at a crossing angle, a part of the flowing energy from the nozzles may be utilized for the mixing of the two liquids. The crossing angle of the first liquid and the second liquid that run out through the respective nozzles may be suitably determined depending on the properties of the monomer used and on the flow rate of the liquids. For example, when the linear velocity of the liquids is large, then the crossing angle may be small.

In this case, the temperature of the first liquid may be generally from room temperature to about 60° C., preferably from room temperature to about 40° C.; and the temperature of the second liquid may also be generally from room temperature to about 60° C., preferably from room temperature to about 40° C.

In that manner, the aqueous solutions jetted out through the nozzles are made to collide with each other as their liquid columns and the two liquids are thus combined. After combined, they form a liquid column and its condition is kept for a while. After still that, the liquid column is broken into liquid droplets. The polymerization of the resulting liquid droplets is thus promoted in a vapor phase.

In order that the polymerization of the liquid droplets may be promoted while they are in contact with the fibers to form a suitable water-absorbent resin composite, the size of the droplets is generally preferably from 5 to 3,000 μm, more preferably from 50 to 1,000 μm. The space density of the liquid droplets in the reactor is preferably from 0.1 to 10,000 g/m³. If it is over the uppermost limit, then a highly water-absorbent resin not in contact with fibers may be formed; and if it is lower than the lowermost limit, then some fibers could not be in contact with the highly water-absorbent resin; and the cases may cause a problem in that the yield of the intended water-absorbent resin composite is relatively lowered.

The gas for the vapor phase that gives the reaction field for the initiation of the polymerization and for the formation of liquid droplets under polymerization is preferably one inert to the polymerization, such as nitrogen, helium, carbon dioxide. However, it may also be air. Including water vapor alone, the humidity in the vapor is not specifically defined. However, if the humidity is too low, then water in the aqueous monomer solution may vaporize away and the monomer may deposit before the promotion of the polymerization and, as a result, the polymerization speed may significantly lower or the polymerization may be stopped during the course of the process. The temperature of the vapor may be from room temperature to 150° C., preferably up to 100° C. The flowing direction of the gas may be either a countercurrent direction or a parallel current direction relative to the running direction of the liquid columns and the liquid droplets. However, when the residence time of the liquid droplets in the vapor phase must be long, or that is, when the monomer polymerization rate must be increased to thereby increase the viscosity of the liquid droplets, then the countercurrent mode (in the anti-gravitation direction) is preferred.

(2-2) Fibers Supply Step:

Preferably, the monomer conversion rate (that is, polymerization rate) of the liquid droplets in contact of liquid droplets with fibers is from 0 to 90%, more preferably from 0 to 80%, most preferably from 0 to 70%. If the polymerization rate is more than 90%, then there may be a possibility that the fibers used could neither be embedded in nor adhere to the highly water-absorbent resin.

In general, when the fibers are made to colloid with the liquid droplets while the monomer conversion rate is low, then the composite B may be easy to obtain where the fibers are embedded inside the water-absorbent resin; but when the fibers are made to colloid with the liquid droplets while the monomer conversion rate is high, then the composite C may be easy to obtain where the fibers adhere to the surface of the water-absorbent resin. When the fibers are made to collide with the liquid droplets at plural positions each having a different monomer conversion rate, then the composite A may be easy to obtain where a part of the fibers are embedded inside the water-absorbent resin while the other fibers adhere to the surface of the water-absorbent resin. Accordingly, for obtaining the structure of the especially preferred composite A, it is desirable that the fibers are fed to the reaction field of at least two different stages each having a different monomer polymerization rate. For this, it is desirable that the fibers are fed thereto through plural supply ports. For obtaining the composite having a desired structure, the monomer conversion rate in the liquid droplets that are to colloid with the fibers is suitably determined in consideration of the species of the fibers. In case where the liquid droplets are made to collide with the fibers at plural positions at which the monomer conversion rate differs, it is desirable that every monomer conversion rate at the positions is selected within the above-mentioned range.

For forming both the partly-embedded fibers and the surface-adhering fibers, the difference in the monomer conversion rate in the contact sites for the respective fibers and the monomer is preferably within a range of from 10% to 80%, more preferably from 10 to 70%, most preferably from 10 to 60%. The polymerization rate in each contact site may be suitably determined depending on the monomer type and the species of the fibers.

(2-3) Fibers Transportation Step:

For supplying the fibers so as to be in contact with the liquid droplets under polymerization, any known transportation method may be employed. The space density of the fibers in the reactor is preferably from 0.005 to 1,000 g/m³ in case where the fibers are partly embedded in the highly water-absorbent resin. If it is over the uppermost limit, then some fibers may remain, not embedded in the highly water-absorbent resin particles; and if it is lower than the lowermost limit, then a water-absorbent resin composite with no fiber embedded therein may be formed; and the cases may cause a problem in that the yield of the composite A is relatively lowered. In order that the fibers are fed as finely and uniformly as possible, it is desirable that the fibers are fed as a mixed flow with a vapor. The vapor to be used for it may be any one mentioned hereinabove for the vapor to give the reaction field. Above all, preferred is air from the economical viewpoint and for environmental load reduction.

The blend ratio by weight of the fibers and the vapor that are to be fed as their mixed flow is 1/1 or more, preferably 1/20 or less; and the linear velocity of the vapor is preferably within a range of from 1 to 50 m/sec. If they are over. the uppermost limit, then the route of the reaction mixture under polymerization in the reaction field may be disordered and the adhesion of the mixture to the inner surface of the reactor may be problematic. On the other hand, if they are lower than the lowermost limit, then the uniformity of the fibers could not be ensured.

It is desirable that the temperature of the vapor to be fed for the mixed flow is selected within a range not significantly interfering with the polymerization. To that effect, concretely, the temperature may be from room temperature to 150° C., preferably up to 100° C. From the viewpoint of fibers transportation, the humidity in the vapor is preferably low. However, if the humidity is too low, then the humidity in the reactor may be low, and water in the aqueous monomer solution may vaporize away and the monomer may deposit before the promotion of the polymerization and, as a result, the polymerization speed may significantly lower or the polymerization may be stopped during the course of the process.

(2-4) Remaining Monomer Amount-Reducing Step:

The methods mentioned below are preferably employed for the remaining monomer amount-reducing step. For reducing the remaining monomer in the polymer produced, more specific methods will be necessary in addition to the method generally employed for producing ordinary highly water-absorbent resin particles. This is because, different from true-spherical highly water-absorbent resin particles or true-spherical aggregates thereof that are obtained in a conventional suspension polymerization method and from amorphous highly water-absorbent resin particles that are obtained in a solution polymerization method, the water-absorbent resin composite of the invention has a stereo-structure of such that the fibers such as pulp are embedded in or adhere to the highly water-absorbent resin particles, and therefore has the following characteristics that may have some influences on the remaining monomer amount-reducing treatment of the composite:

(α) Since the water-absorbent resin is covered with fibers, the composite itself hardly undergoes rotary or parallel movement.

(β) Since the water-absorbent resin is covered with fibers, electromagnetic waves such as IR rays or radiations hardly run through it.

(γ) Since the water-absorbent resin is covered with fibers, a reagent applied to the composite could hardly disperse uniformly in the highly water-absorbent resin and the fibers.

For treating the remaining monomer, for example, herein employable are (i) a method of promoting the polymerization of the remaining monomer; (ii) a method of leading the remaining monomer into other derivatives, and (iii) a method of removing the remaining monomer. These methods are described in detail hereinunder in order.

(i) Method of Promoting the Polymerization of the Remaining Monomer:

The method of promoting the polymerization of the remaining monomer may be grouped into a method of activating the polymerization itself during the procedure of the polymerization; and a method of processing the water-absorbent resin composite after the polymerization. During the procedure of the polymerization as referred to herein means that the product under polymerization has a polymerization rate of less than 50% by weight. After the polymerization means that the product under polymerization has a polymerization rate of at least 50% by weight. The product under polymerization includes one that is actually being polymerized, and one of which polymerization is extremely slow and is substantially suspended or stopped.

For the method of activating the polymerization itself during the procedure of the polymerization, for example, the above-mentioned polymerization activator may be applied thereto. For the method of processing the water-absorbent resin composite after the polymerization, for example, herein employable are a) a method of further heating the water-absorbent resin composite; b) a method of adding a catalyst or a catalyst component capable of promoting the monomer polymerization to the water-absorbent resin composite; c) a method of irradiating the composite with UV rays; d) a method of irradiating the composite with electromagnetic radiations or particulate ionization radiations; e) a method of processing the composite with a polymerization activator. These methods are described below.

(Method of Activating the Polymerization Itself During the Procedure of the Polymerization)

In the method of activating the polymerization itself during the procedure of the polymerization to thereby reduce the amount of the remaining monomer, the polymerization activator may be applied thereto. This is described. This treatment is attained before the formation of the water-absorbent resin composite and is advantageous in that it may evade the above-mentioned characteristics (α), (β) and (γ) of the composite. The polymerization activator to be used is the same as that described hereinabove.

The amount of the polymerization activator to be added may be from 0.01 to 100 ppm by weight, preferably from 0.05 to 50 ppm by weight, more preferably from 0.1 to 20 ppm by weight in terms of the metal of the transition metal compound in the activator and relative to the monomer. If the amount is smaller than 0.01 ppm by weight, then a sufficient polymerization activation effect could not be obtained; but on the contrary, even if it is over 100 ppm by weight, it does no more increase the effect but is uneconomical.

For adding the polymerization activator in the invention, employable is any method capable of making the polymerization activator exist in the liquid droplets under polymerization, for which the polymerization activator may be previously added to the monomer or may be given to the liquid droplets under polymerization. For efficiently applying the polymerization activator to the liquid droplets, it is desirable that the polymerization activator is previously added to the monomer.

For previously adding the polymerization activator to the monomer, it may be added to the monomer liquid that contains an oxidizing agent, or to the monomer liquid that contains a reducing agent. It is desirable that, when the oxidizing agent and the reducing agent are mixed, the polymerization activator in the invention uniformly exists in the mixture, and therefore it is desirable that the polymerization activator in the invention is added to both the oxidizing agent-containing monomer liquid and the reducing agent-containing monomer liquid. In this case, the polymerization activator in the invention to be added to the two may have the same composition or may have different compositions. The amount of the activator to be added to the two may also be the same or different. Preferably, the polymerization activator having the same composition is added to the two in the same amount thereto. In case where a condition is selected, in which the polymerization activator in the invention may be rapidly uniformly dispersed in the mixture of an oxidizing agent and a reducing agent mixed together, then the polymerization activator in the invention may be added to any one of the two to attain a sufficient polymerization activation effect.

The monomer liquid and the polymerization activator may be mixed in any method. For example, herein employable is a method of previously feeding the activator to the monomer liquid, or a method of mixing the two in a pipeline by the use of a line mixer. Especially preferably, the monomer liquid and the polymerization activator are mixed before the initiation of polymerization.

However, the invention does not exclude a case where the polymerization activator is further added after the initiation of polymerization.

The temperature at which the monomer liquid and the polymerization activator are mixed may be generally from room temperature to about 60° C., preferably from room temperature to about 40° C. If the temperature in mixing is too high, then the monomer liquid may lose its stability.

In the above description, an embodiment is exemplified in which a monomer is in both the liquid containing an oxidizing agent and the liquid containing a reducing agent. However, the monomer is not always required to be in both the two, and the invention includes an embodiment where the monomer is in any one of the two. Specifically, the monomer may be only in the liquid containing an oxidizing agent, or it may be only in the liquid containing a reducing agent. In this case, the polymerization activator in the invention may be added to the liquid containing a monomer, or may be added to the liquid not containing a monomer, or may be added to both the two. Preferably, the activator is added to both the two, or to the liquid containing a monomer.

(Method of Processing the Water-Absorbent Resin Composite after the Polymerization)

Next described is the method of processing the water-absorbent resin composite after the polymerization to thereby reduce the remaining monomer amount.

a) Method of Further Heating the Water-Absorbent Resin Composite:

The method of further heating the water-absorbent resin composite comprises heating the water-absorbent resin composite at 40 to 250° C. to thereby polymerize the monomer remaining in the water-absorbent resin composite. In this stage, adding water to the system is effective for promoting the reaction. The added water increases the mobility of the remaining monomer and promotes the mobility of the polymer chain in the water-absorbent resin composite. To that effect, it is desirable that the water content of the water-absorbent resin composite is generally from 5 to 95% by weight, based on the wet weight thereof, more preferably from 10 to 90% by weight, most preferably from 15 to 85% by weight. Preferably, the reaction temperature is from 15 to 250° C., more preferably from 25 to 200° C., most preferably from 40 to 150° C. Depending on the water content and the reaction temperature, the reaction time is preferably from 0.1 seconds to 60 minutes, more preferably from 0.5 seconds to 30 minutes, most preferably from 1 second to 20 minutes.

b) Method of Adding a Catalyst or a Catalyst Component Capable of Promoting the Monomer Polymerization to the Water-Absorbent Resin Composite:

The method of adding a catalyst or a catalyst component capable of promoting the monomer polymerization to the water-absorbent resin composite is described. For example, when the polymerization is carried out by the use of a redox polymerization initiator, then the radical initiator used may often remain in the system. For the method, therefore, a reducing agent solution may be given to the water-absorbent resin composite in system. The reducing agent may be any of sodium sulfite, sodium hydrogensulfite or L-ascorbic acid used as the redox polymerization initiator. In general, the reducing agent is given to the water-absorbent resin composite, as an aqueous solution of from 0.5 to 5% by weight of the agent. The amount of the reducing agent to be given to the water-absorbent resin composite may be from 0.001 to 2% by weight, preferably from 0.01 to 1.5% by weight, more preferably from 0.05 to 1% by weight, based on the weight of the composite. In this case, the reducing agent solution must be uniformly given everywhere to the water-absorbent resin composite. To that effect, it is desirable that the reducing agent solution is sprayed on the composite as a mist thereof having a particle size of at most 1 μm by the use of a spraying tool, or the composite is dipped in the reducing solution. Thus given the reducing agent, the water-absorbent resin composite is then heated so that the monomer is polymerized. It may be heated, for example, at 100 to 150° C. for 10 to 30 minutes or so. Thus heated, the water content of the water-absorbent resin composite may lower. However, if the water content is high, then the composite is dried with a drier to be a final product.

c) Method of Irradiating the Water-Absorbent Resin Composite with UV Rays:

In the method of irradiating the water-absorbent resin composite with UV rays, an ordinary UV lamp may be used. The irradiation intensity and the irradiation time may vary, depending on the type of the fibers used and the remaining monomer amount. In general, the UV lamp is from 10 to 200 W/cm, preferably from 30 to 120 W/cm; the irradiation time is from 0.1 second to 30 minutes; and the lamp-composite distance is from 2 to 30 cm. In this stage, the surface of the dried composite scatters the UV rays applied thereto and the rays do not run through the inside of the composite. Therefore, the surface of the water-absorbent resin composite must be wetted so as to be smoothed and clarified. The water content of the water-absorbent resin composite in this stage may be generally from 0.01 to 40 parts by weight, preferably from 0.1 to 5 parts by weight relative to 1 part by weight of the dry water-absorbent resin. The water content smaller than 0.01 parts by weight or larger than 40 parts by weight is unfavorable since it has a significant influence on the reduction in the remaining monomer amount. The layer thickness of the water-absorbent resin composite is preferably at most 5 cm, more preferably at most 2 cm, most preferably at most 1 cm in order that the UV rays applied to the composite could pass through it. The atmosphere for irradiation with UV rays may be in vacuum or may be in an inorganic gas such as nitrogen, argon or helium or may be in air. The irradiation temperature is not specifically defined. The intended object may be attained sufficiently at room temperature. The UV irradiation apparatus to be used is not also specifically defined. Here in employable is any method of, for example, a method of irradiating the composite in a static condition for a predetermined period of time, or a method of continuously irradiating the composite by the use of a belt conveyor.

d) Method of Irradiating the Water-Absorbent Resin Composite with Radiations:

In the method of irradiating the water-absorbent resin composite with radiations, employable are high-energy radiations such as accelerated electrons or gamma rays. The dose to be given to the composite may vary depending on the remaining monomer amount or the water amount in the composite. In general, it may be from 0.01 to 100 megarad, preferably from 0.1 to 50 megarad. If the dose is over 100 megarad, then the water content of the composite may become too small; but if less than 0.01 megarad, then a composite intended by the invention, which has a good water-absorbing capability and a high water-absorbing speed and in which the remaining monomer is remarkably reduced, could hardly be obtained. The water content of the water-absorbent resin composite in this stage may be generally at most 40 parts by weight, preferably at most 10 parts by weight relative to one part by weight of the water-absorbent resin. If the water content is over 40 parts by weight, then it is unfavorable since it may be ineffective for improving the water-absorbing speed of the composite and especially it may have a significant influence on the reduction in the un-polymerized monomer. The atmosphere in which the composite is irradiated with high-energy radiations may be in vacuum, or in an inorganic gas such as nitrogen, argon, helium, or in air. Air is preferred for the atmosphere. When the irradiation is effected in air, then the water-absorbing capability and the water-absorbing speed of the composite may be much increased and the remaining monomer content of the composite may be significantly reduced. The irradiation temperature is not specifically defined. Room temperature may be enough for attaining the object.

e) Method of Processing with a Polymerization Activator:

Processing with a polymerization activator is for reducing the remaining monomer by the action of the above-mentioned polymerization activator after the polymerization. The type of the polymerization activator to be used may be the same as that mentioned hereinabove.

The polymerization activator may be given to the water-absorbent resin composite in any method capable of making the activator exist inside the composite after the polymerization. The activator may be previously added to the monomer or may be added during and/or after the polymerization.

The method of previously adding the polymerization activator to the monomer or adding it to the liquid droplets under polymerization is as described hereinabove, in which, however, the polymerization activator added may be embedded in the water-absorbent resin composite after the polymerization and therefore its mobility may be extremely lowered and, as a result, its effect may be apparently extremely lowered. Accordingly, in this method, while the remaining monomer reacts owing to the action of the polymerization activator inside the water-absorbent resin composite, the mobility of the polymerization activator inside the water-absorbent resin composite is ensured, and the method is thereby attained.

The mobility of the polymerization activator may be ensured when the water content of the water-absorbent resin composite is generally from 5 to 95% by weight, preferably from 10 to 90% by weight, most preferably from 15 to 85% by weight, based on the wet weight of the composite. The reaction temperature may be generally from 15 to 250° C., preferably from 25 to 200° C., more preferably from 40 to 150° C. Varying depending on the water content and the reaction temperature, the reaction time may be generally from 0.1 seconds to 60 minutes, preferably from 0.5 seconds to 30 minutes, more preferably from 1 second to 20 minutes.

For this, the water-absorbent resin composite is held under a wet condition while it contains water, or a hydrophilic solvent such as water is given to the water-absorbent resin composite, whereby the above-mentioned object may be attained.

For holding the water-absorbent resin composite under a wet condition, the composite may be kept having the above-mentioned water content at the above-mentioned temperature for the above-mentioned period of time. In the wet condition, in general, the relative humidity is at least 50%, preferably at least 70%, more preferably at least 80%. If the relative humidity is lower than 50%, then water inside the water-absorbent resin composite may evaporate away, and the polymerization activator may therefore lose its mobility inside the water-absorbent resin composite.

On the other hand, in the method of applying a hydrophilic solvent such as water to the water-absorbent resin composition, the hydrophilic solvent may be any of water, alcohols having from 1 to 3 carbon atoms, acetone, dimethylformamide, but is preferably water. The solvent may be applied thereto in liquid or in vapor.

In the method of adding the polymerization activator after the polymerization, the activator may be added to the water-absorbent resin composite after polymerization in an amount of from 0.01 to 100 ppm, preferably from 0.05 to 50 ppm, more preferably from 0.1 to 20 ppm, in terms of the metal and relative to the dry weight of the composite. If the amount is smaller than 0.01 ppm by weight, then the remaining monomer amount-reducing effect may be insufficient; but on the contrary, even if an amount over 100 ppm is used, it could not more increase the effect but is rather uneconomical.

Regarding the form thereof in addition, the polymerization activator may be alone by itself, or may be dissolved or dispersed in a suitable solvent. However, in consideration of the easiness and the efficiency in application thereof to the water-absorbent resin composite, the activator is preferably applied to the composite in the form of a solution thereof. The solvent for the solution is preferably a hydrophilic solvent, including water, ethanol, acetone. From the viewpoint of the safety, the sanitary aspect, the solubilizing capability and the economical advantage thereof, water is preferred. Not specifically defined, the concentration of the polymerization activator in the solution thereof for use in the invention may be generally from 0.01 to 5% by weight in terms of the metal.

Regarding the method of adding the polymerization activator solution, the activator must be uniformly dispersed relative to the stereo-structural characteristic of the composite. Accordingly, preferably employed for it is a method of giving the polymerization activator solution to the water-absorbent resin composite, in the form of liquid droplets thereof. The solution temperature may be generally from room temperature, 15° C. to 250° C. The atmosphere for the addition may be an inert gas such as nitrogen, argon or carbon dioxide, but may also be air. In view of the easiness in handling it and of the economical aspect thereof, air is preferred.

For attaining a sufficient, remaining monomer amount-reducing effect in this method, the polymerization activator must have sufficient mobility inside the water-absorbent resin composite. For this, it is desirable that a hydrophilic solvent such as water is given to the composite along with the activator. The hydrophilic solvent increases the mobility of the remaining monomer and further promotes the mobility of the polymer chain inside the absorbent resin. The hydrophilic solvent may be added as the solvent for the polymerization activator which is to be given to the composite as its solution, or may be given to the composite independently of the polymerization activator. The hydrophilic solvent includes water, alcohols having from 1 to 3 carbon atoms, acetone and dimethylformamide, but is preferably water. The solvent may be applied in liquid or in vapor, but is preferably in vapor. It is desired that the amount of the solvent to be given is such that the liquid content of the resulting water-absorbent resin composite could be generally from 5 to 95% by weight, more preferably from 10 to 90% by weight, most preferably from 15 to 85% by weight, based on the wet weight of the composite.

The water-absorbent resin composite to which the polymerization activator has been given is thereafter processed generally at 15 to 250° C., preferably at 25 to 200° C., more preferably at 40 to 150° C., for 0.1 seconds to 60 minutes, preferably for 0.5 seconds to 30 minutes, more preferably for 1 second to 20 minutes, whereby the remaining monomer amount in the composite may be reduced.

(ii) Method of Leading the Remaining Monomer into Other Derivatives:

The method of leading the remaining monomer into other derivatives includes a method of adding, for example, amine or ammonia to the produced water-absorbent resin composite, and a method of adding thereto a reducing agent such as hydrogensulfites, sulfites, pyrosulfites. The additive may be dissolved or dispersed in a suitable solvent. The solvent for the solution is preferably a hydrophilic solvent, including water, ethanol, acetone. From the viewpoint of the safety, the sanitary aspect, the solubilizing capability and the economical advantage thereof, water is preferred. The additive concentration is preferably from 0.01 to 5% by weight, and the amount of the additive to the water-absorbent resin composite is preferably from 0.02 to 3% by weight, more preferably from 0.05 to 2% by weight.

(iii) Method of Removing the Remaining Monomer:

The method of removing the remaining monomer includes, for example, a method of extracting it with an organic solvent or evaporating it away. In the method of extracting with an organic solvent, the water-absorbent resin composite is dipped in a water-containing organic solvent so that the remaining monomer is removed through extraction. For the water-containing organic solvent, usable are ethanol, methanol, acetone. Preferably, the water content of the solvent is from 10 to 99% by weight, more preferably from 30 to 60% by weight. In general, when the water content thereof is higher, then the ability of the solvent to remove the remaining monomer is higher. However, when a water-containing organic solvent having a high water content is used, then the energy consumption in the subsequent drying step may increase. The time of generally from 5 to 30 minutes or so may be enough, for which the composite is dipped in the water-containing organic solvent. Preferably, a method of shaking the composite to promote the extraction of the remaining monomer may be employed. After the dipping treatment, in general, the composite is dried by the use of a drier.

For evaporating the remaining monomer, herein employable is a method of processing the composite with overheated water vapor or water vapor-containing gas. For example, saturated water vapor at 110° C. is heated up to 120 to 150° C. to be overheated water vapor, and this is contacted with the water-absorbent resin composite, whereby the remaining monomer in the composite may be reduced. It is considered that, in this method, while water in the water-absorbent resin composite vaporizes to be water vapor, the remaining monomer therein may also vaporize away from the composite while water simultaneously with the water vapor. According to the method, the removal of the remaining monomer and the drying of the product may be attained at the same time.

In view of the above-mentioned characteristics of the composite or the composition of the invention, the bulk density of the composite or the composition must be lowered so as to realize them. The bulk density is preferably at most 0.85 g/cm³, more preferably at most 0.65 g/cm³, most preferably at most 0.45 g/cm³.

Of the above-mentioned various methods, preferred is the method of activating the polymerization itself by the polymerization activator during the procedure of the polymerization, or the method of adding the polymerization activator to the water-absorbent resin composite after the polymerization. The two methods may be combined.

(2-5) Other Additional Steps:

The method for producing the water-absorbent resin composite of the invention may further include any other additional steps of a surface-crosslinking step, an opening step, and an additive addition step of adding an additive of catalyst, reducing agent, deodorizer, human urine stabilizer or antimicrobial agent for imparting any other function to the composite.

(Surface-Crosslinking Step)

For the purpose of improving the water-absorbing capability thereof, the surface of the water-absorbent resin composite maybe crosslinked with a crosslinking agent. For the concrete contents of the surface-crosslinking step, the compounds to be used and the amount thereof to be used, referred to is the description in (4-4) in the section of redox polymerization given hereinabove.

(Opening Step)

In general, the water-absorbent resin composite is recovered as a deposit thereof. Since the individual water-absorbent resin composites are independent of each other, they are readily openable. For the opening, the opening method described in the section of the fibers may be similarly and suitably used. Preferred are an apparatus and a condition that give no mechanical shock to break the highly water-absorbent resin particles.

(Additive Addition Step)

Various additives may be added to the water-absorbent resin composite or the water-absorbent resin composite composition of the invention for the purpose of imparting desired functions thereto in accordance with the intended objects. The additives include stabilizer for preventing decomposition and deterioration of polymer by liquid which the polymer has absorbed, antimicrobial agent, deodorant, smell remover, aromatic agent, foaming agent. For the specific examples of these materials, the mode of using them and the amount to be used, referred to is the description in (4-4) in the section of redox polymerization given hereinabove.

These additives may be suitably added in the steps for producing the water-absorbent resin composite, in accordance with the object, the effect and the function thereof. Suitably, for example, foaming agent is added in the step of producing the highly water-absorbent resin, preferably before or during the polymerization step. Human urine stabilizer, human blood stabilizer, antimicrobial agent, deodorant and aromatic agent may be added in the step of producing the water-absorbent resin composite, or in the step of producing the water-absorbent resin composite composition of the invention, or in the step of producing absorbent articles. Needless-to-say, the additives may be previously applied to fibers. As the case may be, the additives may be added to a constitutive component of forming an absorption and storage layer, except the water-absorbent resin composite.

[V] Method for Producing Absorbent Resin Composite Composition of the Invention

1. Starting Materials and Production Steps:

The composition of the invention may be prepared preferably according to a method of suitably mixing and dispersing the produced composite A with the composite B and/or the composite C and/or free fibers that have been separately prepared (post-mixing method), or a method of obtaining the composition simultaneously with the polymerization step for the composite A (co-mixing method). If desired, the composition may be processed for compaction method after its production.

(1-1) Post-Mixing Method:

For example, the composite A deposited in the polymerization step for the composite A or the opened and independent composite A is mixed with one or more of the composite B, the composite C and free fibers in a mixer to produce a water-absorbent resin composite composition of the invention where the components are mixed in any desired ratio. In this stage, a solid-mixing apparatus may be used for the mixer, in which powders may be mixed together, or powder may be mixed with fibers or fibers may be mixed together. Concretely, this is described in detail in “Chemical Engineering II” (Yoshitoshi Oyama, Iwanami Zensho, 1963, p. 229). For example, herein usable are rotary mixers such as cylindrical mixer, V-shaped mixer, double conical mixer, cubic mixer; or stationary mixers such as screw mixer, ribbon mixer, rotary disc mixer, fluidized mixer.

(1-2) Co-Mixing Method:

By suitably adjusting the supply position for fibers, the water-absorbent resin composite composition of the invention may be obtained substantially in the process of producing the composite A. Specifically, when the system is brought into contact with fibers in a stage where the monomer polymerization rate is low, then a composite B-containing composition may be obtained; but when the contact is in a stage where the monomer polymerization rate is high, then a composite C-containing composition may be obtained.

Apart from the above, a composition containing free fibers may also be obtained by supplying, mixing and dispersing fibers in the water-absorbent resin composite being produced according to a method where the fibers are not substantially in contact with the highly water-absorbent resin under polymerization or with the highly water-absorbent resin in the water-absorbent resin composite.

(1-3) Compaction Method:

Compaction is attained by suitably controlling the conditions of pressure, temperature and humidity. For example, for a pressing machine, usable is any of a plate pressing machine or a roll pressing machine. The pressure may be within a range under which the water-absorbent resin particles are not broken. If the water-absorbent resin particles are broken, then the debris of broken particles may drop away from the fibers and may leak off from the final products, absorbent articles, or when swollen, the wet gel may separate from the fibers and may leak away and move, thereby worsening the properties of the absorbent articles.

When the compaction step is carried out under heat, then the composition may be heated at a temperature not higher than the melting point of the fibers used. If it is heated at a temperature higher than the melting point, then the fibers may fuse and bond together to form a network, therefore detracting from the function of the composite.

When the compaction step is carried out in wet, then water may be sprayed on the water-absorbent resin composite composition or water vapor may be applied thereto. Depending on the wetting condition, the density of the composition may be increased and the fixation of the water-absorbent resin particles to the fibers may be enhanced.

2. Opening of Water-Absorbent Resin Composite Composition:

In the water-absorbent resin composite composition, the constitutive components themselves are independent of each other, and therefore, like the above-mentioned composite A, the composition may be readily openable. For the opening, the opening method described in the section of the fibers may be similarly and suitably used. Preferred are an apparatus and a condition that give no mechanical shock to break the highly water-absorbent resin.

3. Remaining monomer Amount-Reducing Method:

For reducing the remaining monomer amount in the water-absorbent resin composite composition of the invention, employable is the method of using a water-absorbent resin composite having a reduced remaining monomer amount, described in the section of the production method for water-absorbent resin composite given hereinabove. Similarly, the remaining monomer amount-reducing method may also be applied to the composition. The concrete modes for the method, the quantity relationship such as the concentration in addition, and the other conditions may also be the same as those mentioned hereinabove.

[VI] Absorbent Article of the Invention

1. Production from Water-Absorbent Resin Composite and its Composition:

The above-mentioned water-absorbent resin composite and its composition of the invention are favorable for sanitary materials such as paper diapers, sanitary napkins and for industrial material such as other absorbent articles. Especially to the water-absorbent resin composite of the invention, the techniques utilized in absorbent sheet materials, as proposed in JP-A 63-267370, 63-10667, 63-295251, 63-270801, 63-294716, 64-64602, 1-231940, 1-243927, 2-30522, 2-153731, 3-21385, 4-133728, 11-156188, may be suitably applied in accordance with the object thereof.

2. Constitution of Absorbent Article:

The absorbent article of the invention preferably has an absorbent that contains a diffusion layer and an absorption and storage layer. The absorbent, the diffusion layer and the absorption and storage layer are described below.

(2-1) Absorbent:

The absorbent includes a diffusion layer and an absorption and storage layer mentioned below, as the indispensable layers thereof. A third layer such as a water-pervious layer may be sandwiched between the diffusion layer and the absorption and storage layer. Needless-to-say, the diffusion layer and the absorption and storage layer may have a multi-layered structure.

The absorbent is preferably as thin as possible in order that, when it is used in a sanitary material or the like, it may not give a feeling of wrongness to a wearer and may not be troublesome and that it may not be bulky while brought with a user. Preferably, the thickness is from 0.4 to 20 mm, more preferably from 0.4 to 10 mm. In addition, the absorbent must fit to the body form of a user, and must ensure its bending resistance so that it may follow the user's movement. The bending resistance is preferably from 6 to 9.5 cm, as measured according to JIS L1096. In case where thinned sanitary materials are produced, they may break the package owing to their recovery, or when a user has opened the package, then the thickness of the material therein may increase so that its shape may be greatly over the initial thickness, and as a result, the feeling in wearing it may be worse. Accordingly, the absorbent must keep its good shape stability for a long period of time. Preferably, the recovery of the absorbent is from 0 to 50%, as measured according to the method described in the section of Examples. When the absorbent slowly absorbs liquid and when it releases the liquid under pressure, then a wearer may have a feeling of wrongness and its skin may be exposed to liquid for a long period of time and may be thereby irritated. When the water-absorbent composite is efficiently used in the absorbent, then the absorption of the absorbent may be increased. Accordingly, it is desirable that the absorption rate of the absorbent is at most 5 seconds all in three times according to the method described in the section of Examples; and that the liquid release is at most 10 g all in three times according to the method described in the section of Examples, and the total of the liquid release data in three times is at most 24 g.

(2-2) Diffusion Layer:

Desirably, the diffusion layer has the ability to rapidly distribute a liquid to the entire absorbent article from the site where the liquid has been absorbed by the article, especially to the entire absorption and the storage layer of the article, and when the article has received external pressure applied thereto, the layer also has the ability to temporarily hold the liquid therein. For the diffusion layer, the most suitable substrate may be selected by determining the liquid diffusion speed, in order that the liquid may readily diffuse in the X-Y plane of the absorption and storage layer.

The liquid diffusion speed in the diffusion layer may be obtained by dividing the diffusion area of the liquid that diffuses through the diffusion layer by the absorption time. In the invention, the liquid diffusion speed in the diffusion layer is preferably higher. Concretely, the speed is preferably at least 10 cm²/sec, more preferably at least 20 cm²/sec, even more preferably at least 30 cm²/sec. When the liquid diffusion speed in the diffusion layer is low, then it means that the liquid absorption speed of the layer is low, or that is, the liquid could not be diffused efficiently to the entire absorbent article, especially to the entire absorption and storage layer, and, for example, in case of a sanitary material, the skin of a user of the absorbent article may be kept in contact with the liquid for a long period of time and the user may have an unpleasant feel. The liquid diffusion speed through the diffusion layer maybe generally at most 100 cm²/sec.

For the most suitable substrate satisfying these conditions, usable are fibrous, spongy or filmy substrates may be used, but fibrous substrates are especially preferred. The fibers may be any of synthetic fibers, natural fibers, semi-synthetic fibers and inorganic fibers.

Regarding the mechanical properties of the fibers, the mean diameter of the fibers is preferably from 0.1 to 50 μm, and the mean length is preferably from 0.01 to 10 cm. Regarding their shape, the fibers maybe linear, waved, coiled, branched, looped or starlike. Regarding their mechanical properties, it is desirable that, when the fibers are formed into the absorbent to be mentioned hereinunder, the absorbent may fall within the preferred range in point of the thickness, the flexibility, the recovery and the absorption speed thereof.

The chemical properties of the fibers are described. As hydrophilic fibers, for example, usable are those of pulp, rayon, cotton, regenerated cellulose or other cellulosic fibers, polyamides or polyvinyl alcohols. Especially for application to sanitary materials, tissues of pulp are preferred among the hydrophilic fibers, as they hardly irritate the skin and they give a soft touch to the skin. In case where tissues are used, they must not disintegrated when they have absorbed liquid many times. Accordingly, the “disintegrability” of the tissues, as measured according to JIS P4501, is preferably at least 100 seconds, more preferably at least 150 seconds, most preferably at least 200 seconds or they are not disintegrated at all.

On the other hand, as hydrophobic fibers, for example, selected for use herein are, polyester, polyethylene, polypropylene, polystyrene, polyamide, polyvinyl alcohol, polyvinyl chloride, polyvinylidene chloride, polyacrylonitrile, polyurea, polyurethane, polyfluoroethylene and polyvinylidene cyanide fibers. Two or more different types of the fibers may be combined also for use herein. Hydrophobic fibers are meant to indicate that the contact angle with water on the surface of the fiber material, as measured according to the method described in the section of Examples, is at least 90°.

The fibers for use herein may be formed from a single resin, or may be formed from two or more different types of resins. For example, a core fiber formed from a single resin may be sheathed in a thermoplastic sheath of a different resin, and the thermoplastic fibers of the type are also usable herein. As the sheath/core fibers comprising a combination of two different types of resins for use in the invention, there are mentioned polyethylene/polypropylene, polyethyl acetate/polypropylene, polyethylene/polyester, polypropylene/polyester, polyester copolymer/polyester. Especially preferred are fibers comprising a core of polypropylene or polyester and a sheath of polyester copolymer or polyethylene.

The fibrous substrate for the diffusion layer may be formed of any material that has the ability to diffuse liquid and the ability to temporarily hold liquid therein. For it, generally preferred are hydrophobic fibers. The hydrophobic fibers are such that their elasticity does not change before and after liquid absorption by the substrate when liquid has passed through them, and that the liquid pathway through them is always ensured and the next liquid that follows the previous liquid may smoothly diffuse through the fibers. On the other hand, hydrophilic fibers such as pulp swell by themselves, when having absorbed liquid, and therefore their elasticity and also their shape significantly change, and the next liquid that follows the previous liquid could not sufficiently diffuse through the fibers. The standard for the selection of the substrate having the properties as above is as follows: When the substrate to be used is dipped in water for 15 minutes, and then left on a 80-mesh metal screen for 15 minutes to remove water from it, then the apparent compression stress and bending stress thereof are not reduced to ¾ or less of the original.

Preferably, a shaped nonwoven fabric is used for the fibrous substrate. The nonwoven fabric to be used for it may be produced in any known production method (for example, fibers air-laid method, wet-laid method, water-jet method, stable length fibers carbon-bonded method, solution spinning method).

Preferably, the unit weight of the nonwoven fabric is from 5 to 300 g m², more preferably from 10 to 200 g/m², even more preferably from 20 to 150 g/m², most preferably from 20 to 80 g/m². If it is smaller than 5 g/m², liquid diffusion through the fabric may be insufficient. If larger than 200 g/m², then the feel of the fabric may be poor and the fabric may be uneconomical.

The thickness of the diffusion layer may be generally at least 0.2 mm, preferably at least 0.3 mm, and generally at most 3 mm, preferably at most 1.5 mm, more preferably at most 1 mm, as measured under a pressure of 0.2 psi in the manner to be mentioned hereinunder according to the method described in JP-A 9-117470. If the thickness is too small, then liquid diffusion through the layer may be insufficient. If too large, then it is unsuitable to thinned articles and its feel may be poor.

(2-3) Absorption and Storage Layer:

The absorption and storage layer in the invention is formed of the water-absorbent resin composite composition. Preferably, it contains the composite A.

[VII] Method for Producing Absorbent Article of the Invention

A method for producing the absorbent article of the invention is described in detail hereinunder. According to the production method of the invention, an absorbent article capable of rapidly absorbing, diffusing and holding a sufficient amount of liquid can be produced in a simplified manner. The absorbent article to be produced according to the production method of the invention is flexible and can be thinned, and therefore they may be widely used for various goods such as typically diapers and sanitary goods. In addition, according to the production method of the invention, an absorbent article can be produced in which the water-absorbent resin is fixed in a good manner not generating fiber waste and finely-pulverized water-absorbent resin particles.

The production method of the invention comprises a hybridizing step (A), a recovering step (B), a drying step (C) and a shaping step (D), as the indispensable steps thereof. These indispensable steps are first described in order, and then optional steps are described, and the production method comprising a combination of these steps is described as a whole.

1. Indispensable Steps:

(1-1) Hybridizing Step:

In the hybridizing step, liquid droplets that contain a monomer to give a water-absorbent resin and/or the monomer being polymerized are dispersed and polymerized in a vapor phase, and previously-opened fibers are supplied so that they may collide with the dispersed liquid droplets. The hybridizing step is generally carried out in a reactor such as a polymerization tank. In general, an aqueous monomer solution containing a polymerization initiator is fed to the monomer supply nozzle disposed above the polymerization tank and the aqueous monomer solution is released through the nozzle as liquid droplets, and while the liquid droplets drop in the polymerization tank, the monomer is polymerized and is contacted with the fibers fed into the polymerization tank so as to be hybridized with them. For its details, referred to is the description of from (1-1) to (2-3) in the section of the method for producing the water-absorbent resin composite of the invention given hereinabove.

In the hybridizing step, any one of the composites A to C may be selectively produced, or a mixture of these may also be produced. In case where the mixture is produced, the production conditions may be suitably selected in forming the mixture, or two or more composites may be separately produced and they may be mixed to give the mixture.

The composite A may give an absorbent article having the advantages in that the water-absorbent resin therein has good water penetrability, the water diffusibility through the absorbent article is good and the fixation of the water-absorbent resin in the absorbent article is good before and after water absorption. For application to sanitary materials such as disposable diapers, of which the requirements are that the water absorption rate and the water diffusion rate are both high and that the water-absorbent resin particles are firmly fixed in the absorbent article, the composite A is the most desirable.

In the composite B, the fibers embedded in the water-absorbent resin particles have the effect of increasing the water permeability into the water-absorbent resin particles and enhancing the fixation of the water-absorbent resin particles in the absorbent article before and after water absorption. Specifically, the composite B may give an absorbent article which has a high absorption speed and in which the fixation of the water-absorbent resin is good.

In the composite C, the fibers adhering to the surfaces of the water-absorbent resin particles have the effect of improving the water diffusibility in absorbent articles and preventing a so-called gel-blocking phenomenon of such that, while swollen after having absorbed water, water-absorbent resin particles are kept in contact with each other to interfere with the flow of water through them. Specifically, the composite C may give an absorbent article having excellent water diffusibility.

(1-2) Recovering Step:

The recovering step is for recovering an aggregate of the composites obtained in the hybridizing step and comprising a water-absorbent resin and fibers. In one preferred embodiment of the step, the aggregate is deposited in the bottom of the polymerization tank, and the resulting deposit is recovered. Concretely, a mesh or the like is disposed in the bottom of the polymerization tank, and the area below the mesh is kept under slightly-reduced pressure than inside the polymerization tank, whereby the aggregate may be efficiently deposited on the mesh and may be recovered. The vacuum degree below the mesh may be from −100 to −10000 Pa or so relative to the pressure inside the polymerization tank.

The recovery may be attained in a batchwise mode, but may be carried out continuously. Preferably, it is carried out continuously. In the continuous operation, the aggregate is continuously deposited on the mesh belt disposed in the bottom of the polymerization tank, and the deposit of the aggregate is then continuously recovered. Concretely, for example, a vacuum conveyor belt having a mesh belt, on which the aggregate may be deposited, is disposed in the bottom of the polymerization tank, fibers are fed into the polymerization tank as a mixed flow with air while air is sucked away downwardly at the bottom of the polymerization tank by the vacuum conveyor, and the composite is thereby deposited on the mesh belt, and an aggregate of the composite comprising a water-absorbent resin and fibers is continuously recovered as the deposit. In this stage, the air having been sucked and recovered by the vacuum conveyor contains some fine fibers and some monomer vapor, and therefore, it is desirable that the recovered air is recycled to be fed in the hybridizing step for feeding fibers to the step.

(1-3) Drying Step:

The drying step is for reducing the water content of the aggregate obtained after the hybridizing step and the recovering step. In general, the aggregate is dried so that it may have a water content of at most 10% by weight. Preferably, the drying temperature is set to fall within a range of from 100 to 150° C. If the drying temperature is too low, then the drying may take a long time and may be inefficient. However, if the drying temperature is too high, then the polymer chains may be cut so that the remaining monomer in the aggregate may increase and, as a result, the quality of the polymer may worsen in that the water-soluble content thereof may increase.

Though the drying efficiency may be poor, the drying treatment may be effected under a condition having a relative humidity of at least 50%, whereby the remaining monomer treatment to be mentioned below may also be attained along with the drying treatment.

(1-4) Shaping Step:

The shaping step is for shaping the aggregate obtained after the hybridizing step and the recovering step and comprising a water-absorbent resin and fibers, into a desired form. The shaping may be attained by suitably controlling the conditions of pressure, temperature and humidity.

Before or during the shaping, if desired, fibers such as pulp or an additional water-absorbent resin may be further added to the aggregate in accordance with the necessary properties of the absorbent articles to be produced, whereby the blend ratio of the water-absorbent resin to the fibers in the articles may be controlled. In general, the dry weight ratio of the fibers neither embedded in nor adhering to the water-absorbent resin, to the water-absorbent resin is preferably within a range of from 95/5 to 5/95, more preferably from 90/10 to 7/93, even more preferably from 85/15 to 10/90. If the proportion of the water-absorbent resin is too large, then it may cause gel-blocking; but on the contrary, if the proportion of the water-absorbent resin is too small, then the water-absorbing capability of the absorbent article may be insufficient.

In the shaping step, the aggregate is shaped so that the density of the shaped article could be generally from 0.20 to 0.85 g/cm³, preferably from 0.3 to 0.85 g/cm³, more preferably from 0.4 to 0.85 g/cm³. In addition, the aggregate is so shaped that the thickness of the shaped article could be generally from 0.2 to 20 mm, preferably from 0.2 to 10 mm, more preferably from 0.2 to 5 mm.

In case where the aggregate is compressed in the shaping step, then the presser to be used may be, for example, a plate pressing machine or a roll pressing machine. The pressure may be within a range under which the water-absorbent resin particles are not broken. If the water-absorbent resin particles are broken, then the debris of broken particles may drop away from the fibers and may leak off from the absorbent articles, or when swollen, the wet gel may separate from the fibers and may leak away and move, thereby worsening the properties of the absorbent articles.

When the shaping step is carried out under heat, then the aggregate may be heated at a temperature not higher than the melting point of the fibers used. If it is heated at a temperature higher than the melting point, then the fibers may fuse and bond together to form a network, therefore detracting from the function of the composite.

When the shaping step is carried out in wet, then water vapor may be used for wetting. Depending on the wetting condition, the density of the shaped article may be increased and the fixation of the water-absorbent resin particles to the fibers may be enhanced.

2. Optional Steps:

(2-1) Opening Step:

The opening step is for opening the aggregate obtained after the hybridizing step and the recovering step and comprising a water-absorbent resin and fibers, into smaller aggregates or composites.

Since the composites obtained in the invention are independent of each other, and are readily openable. The opening may be attained according to the opening method described in the section of fibers given hereinabove, for which, however, the apparatus and the condition must be so selected that the water-absorbent resin particles are not broken by mechanical shock applied thereto.

In the opening step, it is unnecessary to open all the constitutive components of the aggregate into the composites.

(2-2) Sieving Step:

Through the opening treatment, a part of the fibers having loosely adhered to the surface of the water-absorbent resin separate from the water-absorbent resin. In the sieving step, the independent fibers not adhering to the resin, such as the fibers not used for hybridization in the hybridizing step and the fibers having separated from the composite in the opening step are removed from the composite. The removed fibers may be recycled in the hybridizing step or the shaping step. The sieving may be attained according to an ordinary sieving method.

(2-3) Surface-Crosslinking Step:

The surface-crosslinking step is for crosslinking the surfaces of the water-absorbent resin particles with a crosslinking agent for the purpose of improving the water-absorbing capability of the particles. The crosslinking agent may be given to the composite, the aggregate or the shaped article in any stage after the hybridizing step and the recovering step and before the drying step. In general, the crosslinking reaction is promoted simultaneously with the drying operation by the heat treatment in the drying step, whereby a crosslinked structure is selectively introduced into the surfaces of the water-absorbent resin particles.

In general, it is known that, after a crosslinking agent has been given to the surfaces of powdery water-absorbent resin particles, it is heated so as to crosslink the surfaces to thereby improve the properties of the resin particles. It may be considered that, as a result of the formation of the crosslinked structure selectively in the surfaces thereof, the surface-crosslinked resin particles may keep their shape when having absorbed water to swell with no bar to the swelling.

(Surface-Crosslinking Agent)

For the surface-crosslinking agent, preferred are polyfunctional compounds capable of copolymerizing with monomer, such as N,N′-methylenebis(meth)acrylamide, (poly) ethylene glycol bis(meth)acrylate; and compounds having plural functional groups capable of reacting with a carboxylic acid, such as polyglycidyl compounds having at least two glycidyl groups. For the latter, especially preferred are aliphatic polyalcohol polyglycidyl ethers. Concretely, preferred for use herein are ethylene glycol diglycidyl ether, polyethylene glycol diglycidyl ether, glycerin diglycidyl ether, glycerin triglycidyl ether, polyglycerin polyglycidyl ether, propylene glycol diglycidyl ether, polypropylene glycol diglycidyl ether, pentaerythritol polyglycidyl ether. If desired, some of these may be combined and used herein. Above all, especially preferred are ethylene glycol diglycidyl ether, and glycerin (di, tri)glycidyl ether.

(Application of Surface-Crosslinking Agent)

The amount of the surface-crosslinking agent to be used may be generally from 0.005 to 1% by weight, preferably from 0.1 to 0.5% by weight, more preferably from 0.2 to 0.5% by weight relative to the composite. When the surface-crosslinking agent is used, it is desirable that it is sprayed as its solution diluted with water, ethanol, methanol or the like in order that it may be uniformly and entirely applied to the composite. The concentration of the surface-crosslinking agent solution may be generally from 0.1 to 10% by weight, preferably from 0.1 to 1% by weight, more preferably from 0.2 to 0.5% by weight. The surface-crosslinking agent solution may contain a surfactant for the purpose of improving the solubility and the dispersibility of the crosslinking agent and for promoting the diffusion of the agent on the surfaces of the water-absorbent resin particles when applied to the precursor of the particles.

In general, the surface-crosslinking agent solution is sprayed on the composite, the aggregate or the shaped article by the use of a spray. Also employable is a method of rotating a roll brush of which the lower part is dipped in a tank of a surface-crosslinking agent solution, and contacting the surface of the brush with the surface-crosslinking agent solution adhering thereto with the surface of a shaped article that contains water-absorbent resin particles. In this method, the surface-crosslinking agent solution may be applied excessively to the intended object, and then this may be lightly pressed with a pressure roll in such a manner that the water-absorbent resin particles are not crushed by the roll or this may be exposed to blowing air to thereby remove the excessive surface-crosslinking agent solution. The surface-crosslinking agent solution may be applied to the intended object at room temperature.

(Heating)

After given the surface-crosslinking agent solution, in general, the composite is then heated so as to promote the crosslinking reaction. The heating may be effected immediately after the application of the surface-crosslinking agent or may be effected simultaneously with drying in the subsequent drying step. Preferably, the heating is effected within 2 minutes after the application of the surface-crosslinking agent solution. Accordingly, the crosslinking agent may be reacted substantially only in the surfaces of the water-absorbent resin particles, and the formation of internal crosslinking may be readily retarded.

The heating condition must be appropriately selected depending on the type of the surface-crosslinking agent used. In general, the heating is attained at a temperature not lower than 100° C. for at least 10 minutes to promote the crosslinking reaction. In this stage, water may evaporate away from the water-absorbent resin particles being heated, and therefore the penetration of the crosslinking agent into the depth of the water-absorbent resin particles may be inhibited during the heating. Preferably, the heating condition is so controlled that the water content of the water-absorbent resin particles could be at most 15% by weight within 10 minutes after the start of the heating operation, more preferably the water content could be at most 15% by weight within 7 minutes, even more preferably within 5 minutes after the start of the heating operation.

(2-4) Pre-Drying Step:

The pre-drying step is a step for previously lowering the water content of the aggregate obtained in the hybridizing step so as to increase the process efficiency in the subsequent steps. For example, in the process of producing an absorbent article including the hybridizing step, the recovering step, the opening step, the sieving step, the surface-crosslinking step, the shaping step and the drying step, the aggregate obtained after the hybridizing step and the recovering step and comprising a water-absorbent resin and fibers is previously dried so that the water content of the aggregate could be on the level on which the aggregate is openable. The pre-dried composite comprising the water-absorbent resin and fibers is opened and sieved, whereby the composite with fibers adhering to the water-absorbent resin may be readily separated from the fibers not adhering to the water-absorbent resin. Thus separated, the composite comprising the water-absorbent resin and fibers is then processed in the surface-crosslinking step, in which the surface-crosslinking agent may be efficiently applied to the surfaces of the water-absorbent resin particles since any excessive fibers do not adhere to the surfaces thereof.

The water content of the water-absorbent resin particles that constitute the composite obtained after the pre-drying operation is generally from 10 to 30% by weight (based on the water-containing water-absorbent resin). If the water content is too low, then the surface-crosslinking agent could reach only the surfaces of the particles, and, as a result, the composite could not have a desired water-absorbing capability. On the other hand, if the water content is too high, then the opening treatment would be difficult. Like in the drying step, the pre-drying temperature may be generally from 100 to 150° C. If the drying temperature is too low, then the drying may take a long time and may be inefficient. On the other hand, if the drying temperature is too high, then it may cause breakage of the polymer chains or the remaining monomer in the composite may increase, and therefore causing quality deterioration such as increase in the water-soluble content of the product.

Though the drying efficiency may be low, the pre-drying treatment may be effected in a condition having a relative humidity of at least 50%, whereby the pre-drying treatment and the remaining monomer treatment may be completed at the same time.

(2-5) Remaining Monomer Amount-Reducing Step:

The remaining monomer amount-reducing step is for reducing the amount of the remaining monomer in the composite. The method of processing the remaining monomer includes 1) a method of promoting the monomer polymerization; 2) a method of leading the monomer into other derivatives; and 3) a method of removing the monomer. For their details, referred to is the description in (2-4) in the section of redox polymerization given hereinabove.

(2-6) Additive Addition Step:

Various additives may be added to the composite for the purpose of imparting desired functions thereto in accordance with the intended objects. The additives include stabilizer for preventing decomposition and deterioration of a water-absorbent resin by liquid which the resin has absorbed, antimicrobial agent, deodorant, smell remover, aromatic agent, foaming agent. For the specific examples of these materials, the mode of using them and the amount to be used, referred to is the description in (4-4) in the section of redox polymerization given hereinabove.

(Time for Addition)

These additives may be suitably added in any step of the production method of the invention, in accordance with the object, the effect and the function thereof. Suitably, for example, foaming agent is added before or during polymerization to give a water-absorbent resin. Human urine stabilizer, human blood stabilizer, antimicrobial agent, deodorant and aromatic agent may be added in the hybridizing step or the shaping step. Needless-to-say, the additives may be previously applied to fibers.

(2-7) Other Steps:

The production method of the invention may optionally include various steps of applying the techniques utilized in absorbent sheet materials, as proposed in JP-A 63-267370, 63-10667, 63-295251, 63-270801, 63-294716, 64-64602, 1-231940, 1-243927, 2-30522, 2-153731, 3-21385, 4-133728, 11-156188, suitably in accordance with the object thereof.

3. Sequence of Steps:

The production method of the invention comprises a hybridizing step, a recovering step, a drying step and a shaping step, as the indispensable steps thereof. Preferably, these indispensable steps are carried in a sequence of a hybridizing step, a recovering step, a drying step and a shaping step; or in a sequence of a hybridizing step, a recovering step, a shaping step and a drying step. In the invention, at least one of these indispensable steps may be carried out plural times. For example, a hybridizing step, a recovering step, a drying step, a shaping step, and a drying step may be carried out in that order, or the drying steps may be carried out two times. Further, a hybridizing step, a recovering step, a drying step, a shaping step, a drying step and a shaping step may be carried out in that order, and the drying step and the shaping step may be carried out two times each.

In addition, in the invention, two or more of the indispensable steps maybe carried out simultaneously. For example, drying may be carried out along with shaping, or that is the shaping step and the drying step may be carried out simultaneously. Also, drying may be carried out along with recovering, or that is, the recovering step and the drying step may be carried out simultaneously. Also, shaping may be carried out along with recovering, or that is, the recovering step and the shaping step may be carried out continuously without a break therebetween. Also, recovering and shaping may be carried out continuously further along with drying, or that is, the recovering step, the shaping step and the drying step may be carried out simultaneously.

The combination of the indispensable steps may be suitably determined in consideration of the type and the amount of the absorbent article to be produced, the production environment, and the usable equipment.

The production method of the invention may include optional steps such as an opening step, a sieving step, a surface-crosslinking step, a pre-drying step, a remaining monomer amount-reducing step, an additive addition step. These optional steps may be carried out before or after the indispensable steps, or simultaneously with the indispensable steps.

Of the optional steps, the opening step may be carried out for the aggregate obtained at least after the hybridizing step and the recovering step and comprising a water-absorbent resin and fibers. Accordingly, the opening step may be carried out after the hybridizing step and the recovering step, or may carried out after the hybridizing step and the recovering step and further after the drying step or the shaping step.

Of the optional steps, the sieving step is carried out at least after the hybridizing step. For example, it may be carried out after the hybridizing step, or after the hybridizing step and the recovering step, or after the hybridizing step, the recovering step and the drying step. In one preferred embodiment of the method, the sieving step is carried out after the opening step.

Of the optional steps, the surface-crosslinking step is carried out for the aggregate obtained at least after the hybridizing step and the recovering step and comprising a water-absorbent resin and fibers. Accordingly, the opening step may be carried out after the hybridizing step and the recovering step, or may be carried out after the hybridizing step and the recovering step and further after the shaping step. After the surface-crosslinking step, the crosslinking reaction is further promoted by heating in the drying step. The drying step may be carried out immediately after the surface-crosslinking step, or may be carried out after any other step has been carried out.

Of the optional steps, the pre-drying step may be carried out for the aggregate obtained at least after the hybridizing step and the recovering step and comprising a water-absorbent resin and fibers, and it is optionally carried out before the drying step. For example, in case where the opening step is carried out after the recovering step, then it is desirable that the pre-drying step is carried out before the opening step.

Of the optional steps, the remaining monomer amount-reducing step is carried out at least after the hybridizing step. For example, it may be carried out after the hybridizing step, or after the hybridizing step and the recovering step. The remaining monomer amount-reducing step may be carried out along with the other steps. For example, in the recovering step, the polymer may be heated so as to promote the polymerization of the remaining monomer therein. While the polymer is heated in the drying step or the pre-drying step, the polymerization of the remaining monomer therein may be promoted.

Of the optional steps, the additive addition step may be carried out in any stage, if desired. It may be carried out along with the other step. For example, an additive may be mixed in the material to be processed in the hybridizing step; or in the surface-crosslinking step, an additive may be sprayed on the resin composite while or before or after the surface-crosslinking agent is sprayed thereon.

Specific examples of the sequence of the indispensable steps and the optional steps that constitute the production method of the invention are described below. For example, in case where the indispensable steps are carried out in a sequence of a hybridizing step, a recovering step, a drying step and a shaping step, then a surface-crosslinking step may be preferably carried out between the recovering step and the drying step in the manner mentioned below.

Hybridizing Step—Recovering Step-A—Surface-crosslinking Step-B—Drying Step-C—Shaping Step

In this embodiment, an opening step may be preferably inserted in at least one timing between any of the recovering step and the surface-crosslinking step (above A), or the surface-crosslinking step and the drying step (above B), or the drying step and the shaping step (above C). Of the above A to C, the opening step is more preferably inserted in the timing of A or C. Subsequently to the opening step, a sieving step may be preferably inserted into the process. Further, in case where an opening step is carried out in the timing of A or B, then it is desirable that a pre-drying step is carried out before the opening step.

In case where the indispensable steps are carried out in a sequence of a hybridizing step, a recovering step, a shaping step and a drying step, then an opening step may be preferably carried out between the recovering step and the shaping step in the manner mentioned below.

Hybridizing Step—Recovering Step-D—Opening Step-E—Shaping Step-F—Drying Step

Preferably, a pre-drying step is carried out before the opening step. Also preferably, a sieving step may be inserted in the process subsequently to the opening step. Also preferably, a surface-crosslinking step may be inserted in at least one timing between any of the recovering step and the opening step (above D), or the opening step and the shaping step (above E), or the shaping step and the drying step (above F). Of D to F, the timing E is more preferred for the surface-crosslinking step.

Especially preferred embodiments of the sequence of the steps constituting the production method of the invention are the following (1) to (3):

(1) Hybridizing Step—Recovering Step—Surface-crosslinking Step—Drying Step—Opening Step—Sieving Step—Shaping Step.

(2) Hybridizing Step—Recovering Step—Pre-drying Step—Opening Step—Sieving Step—Surface-crosslinking Step—Drying Step—Shaping Step.

(3) Hybridizing Step—Recovering Step—Pre-drying Step—Opening Step—Sieving Step—Surface-crosslinking Step—Shaping Step—Drying Step.

In these embodiments, a remaining monomer amount-reducing step and an additive addition step may be optionally inserted, if desired. The other steps may also be suitably inserted, if desired.

In the absorbent article produced according to the production method of the invention, a water-absorbent resin is fixed to fibers at a high density and a high strength. Accordingly, the absorbent article may rapidly absorb liquid such as body fluid, and may diffuse it entirely in the article, and the liquid may be thus held in the absorbent article. In addition, according to the production method of the invention, flexible absorbent articles may be produced, and therefore, using them, diapers and sanitary goods of good and comfortable body fitness can be provided. Further, according to the production method of the invention, thinned absorbent articles may be produced, and therefore the cost for their transportation and handling may be reduced. Further, according to the production method of the invention, absorbent articles may be produced not generating fiber waste and finely-pulverized water-absorbent resin particles, and in addition, in the absorbent articles thus produced, the water-absorbent resin fixation is good. Having these advantages, the production method for absorbent articles of the invention may be widely utilized in various fields.

The characteristics of the invention are described more concretely with reference to the Examples and Comparative Examples given hereinunder. In the following Examples, the material used, its amount and the ratio, the details of the treatment and the treatment process may be suitably modified or changed not overstepping the spirit and the scope of the invention. Accordingly, the scope of the invention should not be limitatively interpreted by the Examples mentioned below. In Examples 1 to 31 and Comparative Examples 1 to 13, the weight ratio, the remaining monomer amount, and the water content are measured according to the methods described in Test Example 1.

### EXAMPLE 1

133.3 parts by weight of aqueous 25 wt. % sodium hydroxide solution and 3.3 parts by weight of distilled water were added to 100 parts by weight of high-purity acrylic acid containing 500 ppm by weight of acetic acid, 400 ppm by weight of propionic acid and 100 ppm by weight of dimer acid to prepare an aqueous, partially-neutralized acrylic acid solution having a monomer concentration of 50% by weight and a degree of neutralization of 60 mol %.

To 100 parts by weight of the aqueous partially-neutralized acrylic acid solution, added were 0.14 parts by weight of a crosslinking agent, N,N′-methylenebisacrylamide and 4.55 parts by weight of an oxidizing agent, aqueous 31 wt. % hydrogen peroxide solution to prepare a solution X. To the solution X, added was a polymerization activator, iron(III) chloride hexahydrate in an amount of 5 ppm by weight in terms of iron relative to the monomer, to prepare a solution A.

Apart from it, 0.14 parts by weight of a crosslinking agent, N,N′-methylenebisacrylamide and 0.57 parts by weight of a reducing agent, L-ascorbic acid were added to 100 parts by weight of the aqueous partially-neutralized acrylic acid solution to prepare a solution Y. To the solution Y, added was a polymerization activator, iron(III) chloride hexahydrate in an amount of 5 ppm by weight in terms of iron relative to the monomer, to prepare a solution B.

Thus prepared, the solution A and the solution B were mixed in a mixing apparatus shown in FIG. 1. The mixing apparatus comprises monomer solution supply pipes 21, 22 each with five jetting nozzles 21a, 22a provided at intervals of 1 cm, in which the inner diameter of the nozzles 21a, 22a is 0.13 mm. The crossing angle θ of the solution A and the solution B flowing out of the nozzles 21a, 22a was adjusted to be 30°, and the distance d between the nozzle tips was 4 mm. The solution A and the solution B were heated at 40° C., and supplied to the apparatus by a pump at a flow rate of 5 m/sec (20 ml/min each). The solution A and the solution B met together at a place where they left the nozzle of each nozzle pair, and after formed a liquid column 23 of about 10 mm long, it became liquid droplets 24 dropping in a vapor phase, in which the monomer was under polymerization (in air, at 50° C.). The polymerization rate at a position of 1.6 m vertically below the meeting point of the solution A and the solution B was measured. The result is given in Table 1. In Examples 1 to 10, 21, 22 and Comparative Examples 1, 2, the mean residence time of the product under polymerization between the meeting point and the position 1.6 m vertically below the meeting point was 0.57 seconds in every case.

### EXAMPLE 2

The same process as in Example 1 was repeated, except that the polymerization activator, iron(III) chloride hexahydrate was added to both the solutions X and Y in an amount of 1 ppm by weight, but not 5 ppm by weight, in terms of iron relative to the monomer. The result is given in Table 1.

### EXAMPLE 3

The same process as in Example 1 was repeated, except that the polymerization activator, iron(III) chloride hexahydrate was added to both the solutions X and Y in an amount of 10 ppm by weight, but not 5 ppm by weight, in terms of iron relative to the monomer. The result is given in Table 1.

### EXAMPLE 4

The same process as in Example 1 was repeated, except that iron(II) chloride tetrahydrate was added to both the solutions X and Y as the polymerization activator in place of iron(III) chloride hexahydrate. The result is given in Table 1.

### EXAMPLE 5

The same process as in Example 1 was repeated, except that iron(III) sulfate heptahydrate was added to both the solutions X and Y as the polymerization activator in place of iron(III) chloride hexahydrate. The result is given in Table 1.

### EXAMPLE 6

The same process as in Example 1 was repeated, except that iron(II) sulfate heptahydrate was added to both the solutions X and Y as the polymerization activator in place of iron(III) chloride hexahydrate. The result is given in Table 1.

### EXAMPLE 7

The same process as in Example 1 was repeated, except that the polymerization activator, iron(III) chloride hexahydrate was added to only the solution X, but not to both the solutions X and Y, in an amount of 10 ppm by weight in terms of iron relative to the monomer. The result is given in Table 1.

### EXAMPLE 8

The same process as in Example 1 was repeated, except that the polymerization activator, iron(III) chloride hexahydrate was added to only the solution Y, but not to both the solutions X and Y, in an amount of 10 ppm by weight in terms of iron relative to the monomer. The result is given in Table 1.

### EXAMPLE 9

The same process as in Example 1 was repeated, except that a polymerization activator, iron(II) chloride tetrahydrate was added to only the solution X, but not to both the solutions X and Y, in an amount of 10 ppm by weight in terms of iron relative to the monomer. The result is given in Table 1.

### EXAMPLE 10

The same process as in Example 1 was repeated, except that a polymerization activator, iron(II) chloride tetrahydrate was added to only the solution Y, but not to both the solutions X and Y, in an amount of 10 ppm by weight in terms of iron relative to the monomer. The result is given in Table 1.

### EXAMPLE 11

133.3 parts by weight of aqueous 25 wt. % sodium hydroxide solution and 3.3 parts by weight of distilled water were added to 100 parts by weight of crude acrylic acid containing protoanemonin at a concentration of 50 ppm by weight and containing 500 ppm by weight of acetic acid, 400 ppm by weight of propionic acid and 100 ppm by weight of dimer acid to prepare an aqueous, partially-neutralized acrylic acid solution having a monomer concentration of 50% by weight and a degree of neutralization of 60 mol %.

To 100 parts by weight of the aqueous partially-neutralized acrylic acid solution, added were 0.14 parts by weight of a crosslinking agent, N,N′-methylenebisacrylamide and 4.55 parts by weight of an oxidizing agent, aqueous 31 wt. % hydrogen peroxide solution to prepare a solution X. To the solution X, added was an anti-polymerization inhibitor, iron(III) chloride hexahydrate in an amount of 5 ppm by weight in terms of iron relative to the monomer, to prepare a solution A.

Apart from it, 0.14 parts by weight of a crosslinking agent, N,N′-methylenebisacrylamide and 0.57 parts by weight of a reducing agent, L-ascorbic acid were added to 100 parts by weight of the aqueous partially-neutralized acrylic acid solution to prepare a solution Y. To the solution Y, added was an anti-polymerization inhibitor, iron(III) chloride hexahydrate in an amount of 5 ppm by weight in terms of iron relative to the monomer, to prepare a solution B.

Thus prepared, the solution A and the solution B were mixed by the use of the nozzles shown in FIG. 1. In FIG. 1, the inner diameter of the nozzles is 0.13 mm, and five nozzles are disposed for each solution at intervals of 1 cm. The crossing angle of the solution A and the solution B flowing out of the nozzles was adjusted to be 30 degrees, and the distance d between the nozzle tips was 4 mm. The solution A and the solution B were heated at 40° C., and supplied to the nozzles by a pump at a flow rate of 5 m/sec.

The solution A and the solution B met together at a place where they left the nozzle of each nozzle pair, and after formed a liquid column of about 10 mm long, it became liquid droplets dropping in a vapor phase, in which the monomer was under polymerization (in air, at 50° C.). A 200-mesh screen of Teflon® was disposed at 2.6 m vertically below the meeting point of the solution A and the solution B, on which about 10 g of a product under polymerization was obtained. The water content of the product under polymerization was measured, and was 40% by weight. Immediately after its recovery, the polymer was dried in a hot air drier of which the inner temperature was set at 150° C., for 30 minutes, and the remaining monomer concentration was measured. The result is given in Table 2. In Examples 11 to 20 and Comparative Examples 3 to 12, the mean residence time of the product under polymerization between the meeting point and the position 2.6 m vertically below the meeting point was 1.2 seconds in every case.

### EXAMPLE 12

The same process as in Example 11 was repeated, except that crude acrylic acid containing β-hydroxypropionic acid at a concentration of 500 ppm by weight, but not containing protoanemonin at a concentration of 50 ppm by weight, was used. The result is given in Table 2.

### EXAMPLE 13

The same process as in Example 11 was repeated, except that crude acrylic acid containing acetaldehyde at a concentration of 500 ppm by weight, but not containing protoanemonin at a concentration of 50 ppm by weight, was used. The result is given in Table 2.

### EXAMPLE 14

The same process as in Example 11 was repeated, except that crude acrylic acid containing benzaldehyde at a concentration of 500 ppm by weight, but not containing protoanemonin at a concentration of 50 ppm by weight, was used. The result is given in Table 2.

### EXAMPLE 15

The same process as in Example 11 was repeated, except that crude acrylic acid containing furfural at a concentration of 500 ppm by weight, but not containing protoanemonin at a concentration of 50 ppm by weight, was used. The result is given in Table 2.

### EXAMPLE 16

The same process as in Example 11 was repeated, except that crude acrylic acid containing maleic anhydride at a concentration of 500 ppm by weight, but not containing protoanemonin at a concentration of 50 ppm by weight, was used. The result is given in Table 2.

### EXAMPLE 17

The same process as in Example 11 was repeated, except that crude acrylic acid containing hydroquinone at a concentration of 100 ppm by weight, but not containing protoanemonin at a concentration of 50 ppm by weight, was used. The result is given in Table 2.

### EXAMPLE 18

The same process as in Example 11 was repeated, except that crude acrylic acid containing MQ at a concentration of 1000 ppm by weight, but not containing protoanemonin at a concentration of 50 ppm by weight, was used. The result is given in Table 2.

### EXAMPLE 19

The same process as in Example 11 was repeated, except that sodium L-ascorbate was used in place of L-ascorbic acid. The result is given in Table 1.

### EXAMPLE 20

The same process as in Example 11 was repeated, except that erythorbic acid was used in place of L-ascorbic acid. The result is given in Table 1.

### EXAMPLE 21

133.3 parts by weight of aqueous 25 wt. % sodium hydroxide solution and 3.3 parts by weight of distilled water were added to 100 parts by weight of high-purity acrylic acid containing 500 ppm by weight of acetic acid, 400 ppm by weight of propionic acid and 100 ppm by weight of dimer acid to prepare an aqueous, partially-neutralized acrylic acid solution having a monomer concentration of 50% by weight and a degree of neutralization of 60 mol %.

To 100 parts by weight of the aqueous partially-neutralized acrylic acid solution, added were 0.14 parts by weight of a crosslinking agent, N,N′-methylenebisacrylamide and 4.55 parts by weight of an oxidizing agent, aqueous 31 wt. % hydrogen peroxide solution to prepare a solution X.

Apart from it, 0.14 parts by weight of a crosslinking agent, N,N′-methylenebisacrylamide and 0.57 parts by weight of a reducing agent, L-ascorbic acid were added to 100 parts by weight of the aqueous partially-neutralized acrylic acid solution to prepare a solution Y.

Thus prepared, the solution X and the solution Y were mixed by the use of the nozzles shown in FIG. 1. In FIG. 1, the inner diameter of the nozzles is 0.13 mm, and five nozzles are disposed for each solution at intervals of 1 cm. The crossing angle of the solution X and the solution Y flowing out of the nozzles was adjusted to be 30 degrees, and the distance d between the nozzle tips was 4 mm. The solution X and the solution Y were heated at 40° C., and supplied to the nozzles by a pump at a flow rate of 5 m/sec. The solution A and the solution B met together at a place where they left the nozzle of each nozzle pair, and after formed a liquid column of about 10 mm long, it became liquid droplets dropping in a vapor phase, in which the monomer was under polymerization (in air, at 50° C.). A 200-mesh screen of Teflon® was disposed at 2.6 m vertically below the meeting point of the solution X and the solution Y, on which about 10 g of a product under polymerization was obtained. The water content of the product under polymerization was measured, and was 41% by weight. In addition, the polymerization rate at this position was measured, and was 60% by weight. Accordingly, it may be said that the polymer is a polymer after the polymerization step that satisfies the requirements in the remaining monomer amount-reducing step of the invention. An aqueous solution of 100 ppm by weight, in terms of the metal thereof, of a remaining monomer amount-reducing agent, iron(III) chloride hexahydrate was sprayed on the polymer being still under polymerization, in an amount of 10 ppm in terms of the metal thereof relative to the dry weight of the polymer, and kept at room temperature for 30 minutes, and then dried in a hot air drier of which the inner temperature was set at 150° C., for 30 minutes, and the remaining monomer amount and the L-ascorbic acid amount were measured. Further, the product was subjected to a powder deodorization test and a gel deodorization test. The results are given in Table 3.

### EXAMPLE 22

The same process as in Example 21 was repeated, except that iron(II) chloride tetrahydrate was used as the remaining monomer amount-reducing agent in place of iron(III) chloride hexahydrate. The results are given in Table 3.

### EXAMPLE 23

The same process as in Example 21 was repeated, except that iron(III) sulfate heptahydrate was used as the remaining monomer amount-reducing agent in place of iron(III) chloride hexahydrate. The results are given in Table 3.

### EXAMPLE 24

The same process as in Example 21 was repeated, except that iron(II) sulfate heptahydrate was used as the remaining monomer amount-reducing agent in place of iron(III) chloride hexahydrate. The results are given in Table 3.

### EXAMPLE 25

The same process as in Example 21 was repeated, except that copper(I) chloride was used as the remaining monomer amount-reducing agent in place of iron(III) chloride hexahydrate. The results are given in Table 3.

### EXAMPLE 26

The same process as in Example 21 was repeated, except that copper(II) chloride was used as the remaining monomer amount-reducing agent in place of iron(III) chloride hexahydrate. The results are given in Table 3.

### EXAMPLE 27

The same process as in Example 21 was repeated, except that copper(II) sulfate pentahydrate was used as the remaining monomer amount-reducing agent in place of iron(III) chloride hexahydrate. The results are given in Table 3.

### EXAMPLE 28

The same process as in Example 21 was repeated, except that manganese(II) chloride tetrahydrate was used as the remaining monomer amount-reducing agent in place of iron(III) chloride hexahydrate. The results are given in Table 3.

### EXAMPLE 29

The same process as in Example 21 was repeated, except that manganese(II) sulfate pentahydrate was used as the remaining monomer amount-reducing agent in place of iron(III) chloride hexahydrate. The results are given in Table 3.

### COMPARATIVE EXAMPLE 1

The same process as in Example 1 was repeated, except that the polymerization activator was not added to both the solution X and the solution Y. The result is given in Table 1.

### COMPARATIVE EXAMPLE 2

The same process as in Example 1 was repeated, except that the polymerization activator, iron(III) chloride hexahydrate was added to both the solution X and the solution Y in an amount of 0.01 ppm by weight, but not 5 ppm by weight, in terms of iron relative to the monomer. The results are given in Table 1.

### COMPARATIVE EXAMPLES 3 to 10

The same process as in Examples 11 to 18 was repeated, except that the anti-polymerization inhibitor, iron(III) chloride hexahydrate was not added to both the solution X and the solution Y. The results are given in Table 2.

### COMPARATIVE EXAMPLE 11

The same process as in Example 21 was repeated, except that the remaining monomer amount-reducing agent was not added. The results are given in Table 3.

TABLE 1

| | Polymerization Activator | | | |
|---|---|---|---|---|
| | | Amount Added | | Result |
| | | (in terms of iron relative to acrylic acid) | Initiator | Polymerization |
| | Type of Iron Compound | (ppm by mass) | Reducing Agent | Rate (%) |
| Example 1 | iron(III) chloride hexahydrate | 5 | L-ascorbic acid | 72 |
| Example 2 | iron(III) chloride hexahydrate | 1 | L-ascorbic acid | 55 |
| Example 3 | iron(III) chloride hexahydrate | 10 | L-ascorbic acid | 85 |
| Example 4 | iron(II) chloride tetrahydrate | 5 | L-ascorbic acid | 72 |
| Example 5 | iron(III) sulfate heptahydrate | 5 | L-ascorbic acid | 72 |
| Example 6 | iron(II) sulfate heptahydrate | 5 | L-ascorbic acid | 72 |
| Example 7 | iron(III) chloride hexahydrate | 10 to only X | L-ascorbic acid | 67 |
| Example 8 | iron(III) chloride hexahydrate | 10 to only Y | L-ascorbic acid | 67 |
| Example 9 | iron(II) chloride tetrahydrate | 10 to only X | L-ascorbic acid | 67 |
| Example 10 | iron(II) chloride tetrahydrate | 10 to only Y | L-ascorbic acid | 67 |
| Example 19 | iron(III) chloride hexahydrate | 5 | sodium L-ascorbate | 71 |
| Example 20 | iron(III) chloride hexahydrate | 5 | erythorbic acid | 70 |
| Comparative Example 1 | — | 0 | L-ascorbic acid | 29 |
| Comparative Example 2 | iron(III) chloride hexahydrate | 0.001 | L-ascorbic acid | 31 |

TABLE 2

| | Anti-Polymerization Inhibitor | | Impurity | | Result |
|---|---|---|---|---|---|
| | | Amount Added | | Concentration | Remaining |
| | | (in terms of iron | | (relative to | Monomer |
| | | relative to acrylic acid) | | acrylic acid) | Amount |
| | Type of Iron Compound | (ppm by weight) | Type of Impurity | (ppm by weight) | (ppm by weight) |
| Example 11 | iron(III) chloride hexahydrate | 5 | protoanemonin | 50 | 230 |
| Example 12 | iron(III) chloride hexahydrate | 5 | β-hydroxypropionic acid | 500 | 220 |
| Example 13 | iron(III) chloride hexahydrate | 5 | acetaldehyde | 500 | 220 |
| Example 14 | iron(III) chloride hexahydrate | 5 | benzaldehyde | 500 | 220 |
| Example 15 | iron(III) chloride hexahydrate | 5 | furfural | 500 | 220 |
| Example 16 | iron(III) chloride hexahydrate | 5 | maleic anhydride | 500 | 220 |
| Example 17 | iron(III) chloride hexahydrate | 5 | hydroquinone | 100 | 210 |
| Example 18 | iron(III) chloride hexahydrate | 5 | MQ | 1000 | 210 |
| Comparative Example 3 | — | 0 | protoanemonin | 50 | 3700 |
| Comparative Example 4 | — | 0 | β-hydroxypropionic acid | 500 | 3500 |
| Comparative Example 5 | — | 0 | acetaldehyde | 500 | 3500 |
| Comparative Example 6 | — | 0 | benzaldehyde | 500 | 3500 |
| Comparative Example 7 | — | 0 | furfural | 500 | 3500 |
| Comparative Example 8 | — | 0 | maleic anhydride | 500 | 3500 |
| Comparative Example 9 | — | 0 | hydroquinone | 100 | 3000 |
| Comparative Example 10 | — | 0 | MQ | 1000 | 3000 |

TABLE 3

| | Remaining Monomer | | | | | | | | |
|---|---|---|---|---|---|---|---|---|---|
| | Amount-Reducing Agent | | | | | | | | |
| | | Amount | Result | | | | | | |
| | | Added | | Remaining | | | | | |
| | | (in terms | | L- | | | | | |
| | | of metal | Remaining | Ascorbic | | | Gel Deodorization Test | | |
| | | relative to | Monomer | Acid | Powder Deodorization Test | | | Hydrogen | |
| | | polymer) | Amount | Amount | Methylamine | | Methylamine | Sulfide | |
| | Transition Metal | (ppm by | (ppm by | (ppm by | (ppm by | T-butylmercaptan | (ppm by | (ppm by | Methylmercaptan |
| | Compound | weight) | weight) | mass) | weight) | (ppm by weight) | weight) | weight) | (ppm by weight) |
| Example 21 | iron(III) chloride | 10 | 150 | 500 | 23 | 3.2 | 40 | 0.9 | 0.4 |
| | hexahydrate | | | | | | | | |
| Example 22 | iron(II) chloride | 10 | 150 | 500 | 23 | 3.2 | 40 | 0.9 | 0.4 |
| | tetrahydrate | | | | | | | | |
| Example 23 | iron(III) sulfate | 10 | 150 | 500 | 23 | 3.2 | 40 | 0.9 | 0.4 |
| | heptahydrate | | | | | | | | |
| Example 24 | iron(III) sulfate | 10 | 150 | 500 | 23 | 3.2 | 40 | 0.9 | 0.4 |
| | heptahydrate | | | | | | | | |
| Example 25 | copper(I) chloride | 10 | 160 | 500 | 23 | 3.2 | 40 | 0.9 | 0.4 |
| Example 26 | copper(II) chloride | 10 | 160 | 500 | 23 | 3.2 | 40 | 0.9 | 0.4 |
| Example 27 | copper(II) sulfate | 10 | 160 | 500 | 23 | 3.2 | 40 | 0.9 | 0.4 |
| | pentahydrate | | | | | | | | |
| Example 28 | manganese(II) | 10 | 170 | 500 | 23 | 3.2 | 40 | 0.9 | 0.4 |
| | chloride tetrahydrate | | | | | | | | |
| Example 29 | manganese(II) | 10 | 170 | 500 | 23 | 3.2 | 40 | 0.9 | 0.4 |
| | sulfate pentahydrate | | | | | | | | |
| Comparative | — | — | 2100 | 1000 | 36 | 5 | 81 | 1.7 | 0.8 |
| Example 11 | | | | | | | | | |

### EXAMPLE 101

### 1) Preparation of Water-Absorbent Resin Composite

133.3 parts by weight of aqueous 25 wt. % sodium hydroxide solution and 3.3 parts by weight of distilled water were added to 100 parts by weight of acrylic acid to prepare an aqueous, partially-neutralized acrylic acid solution having a monomer concentration of 50% by weight and a degree of neutralization of 60 mol %. To 100 parts by weight of the aqueous partially-neutralized acrylic acid solution, added were 0.14 parts by weight of a crosslinking agent, N,N′-methylenebisacrylamide and 4.55 parts by weight of an oxidizing agent, aqueous 31 wt. % hydrogen peroxide solution to prepare a solution X. To the solution X, added was a polymerization activator, iron(III) chloride hexahydrate in an amount of 1 ppm by weight in terms of the metal thereof to prepare a solution A.

Apart from it, 0.14 parts by weight of a crosslinking agent, N,N′-methylenebisacrylamide and 0.57 parts by weight of a reducing agent, L-ascorbic acid were added to 100 parts by weight of the aqueous partially-neutralized acrylic acid solution to prepare a solution Y. To the solution Y, added was a polymerization activator, iron(III) chloride hexahydrate in an amount of 1 ppm by weight in terms of the metal thereof to prepare a solution B.

Thus prepared, the solution A and the solution B were mixed in a mixing apparatus shown in FIG. 1. The mixing apparatus comprises monomer solution supply pipes 21, 22 each with five jetting nozzles 21a, 22a provided at intervals of 1 cm, in which the inner diameter of the nozzles 21a, 22a is 0.13 mm. The crossing angle θ of the solution A and the solution B flowing out of the nozzles 21a, 22a was adjusted to be 30°, and the distance d between the nozzle tips was 4 mm. The solution A and the solution B were heated at 40° C., and supplied to the apparatus by a pump at a flow rate of 5 m/sec (20 ml/min each).

The solution A and the solution B met together at a place where they left the nozzle of each nozzle pair, and after formed a liquid column 23 of about 10 mm long, it became liquid droplets 24 dropping in a vapor phase, in which the monomer was under polymerization (in air, at 50° C.). The space density of the liquid droplets in the reactor, as estimated from the space capacity of the reactor, the monomer supply amount and the dropping speed of the liquid droplets, was 2 g/m³.

On the other hand, opened fibers were fed through a supply port disposed at 0.8 m or 1.6 m below the nozzle tips, as a mixed flow thereof with air (fibers/air=1/100, blend ratio by weight). In this stage, the temperature of the air in the mixed flow was room temperature and the linear velocity thereof was 10 m/sec. At 0.8 m and 1.6 m below the nozzle tips, the polymerization rate of the monomer was 35% and 55%, respectively. In this case, the polymerization rate increase was 94% and 90%, respectively. The fibers used are of pulp having a contact angle with water of 0°, and having a fiber diameter (mean fiber diameter) of 2.2 decitex and a length (mean fiber length) of 2.5 mm. Their supply rate was 11.5 g/min. The space density of the fibers in the reaction field, as estimated from the space capacity of the reaction field, the supply amount of the fibers and the dropping speed thereof, was 8 g/m³.

The liquid droplets collided with the fibers in a vapor phase and formed a water-absorbent resin composite precursor, which was recovered as a deposit on a belt conveyor having a mesh belt as the conveyor part thereof, disposed at 3 m below the nozzle tips. Thus recovered, the deposit had a water content of 40% by weight. The recovered deposit was dried in a hot air drier of which the inner temperature was set at 120° C., for 30 minutes, and then sieved to remove the free fibers not contacted with the water-absorbent resin, thereby obtaining a product that comprises a water-absorbent resin and fibers.

The product was observed with a microscope, and it was confirmed that the product is a water-absorbent resin composite (composite A) comprising one highly water-absorbent resin particle and two or more fibers, in which the highly water-absorbent resin particle is nearly spherical, at least one of the two or more fibers is partly embedded in the resin particle and partly exposed out of the resin particle, and at least one of the two or more fibers is not embedded in the resin particle but partly adheres to the surface of the resin particle.

### 2) Preparation of Compacted Water-Absorbent Resin Composite Composition

To the water-absorbent resin composite produced in the above, added were a predetermined amount of the same free fibers as those used in production of the water-absorbent resin composite, in a dry weight ratio of highly water-absorbent resin to fibers (bonding fibers+free fibers) of 20/80 to prepare a water-absorbent resin composite composition.

Specifically, based on the weight ratio of the water-absorbent resin composite and the dry weight ratio of the bonding fibers and the water-absorbent resin constituting the water-absorbent resin composite, the water-absorbent resin composite was mixed with free fibers so that the unit weight of the highly water-absorbent resin and the dry weight ratio of the fibers (bonding fibers+free fibers) and the highly water-absorbent resin could be predetermined values, thereby obtaining a water-absorbent resin composite composition.

For example, when a water-absorbent resin composite composition (absorption and storage layer) having a highly water-absorbent resin unit weight, P [g/m²], and a dry weight ratio of fibers to highly water-absorbent resin, F [w/w], is produced from a water-absorbent resin composite x [g/m²] and free fibers [g/m²], in which the dry weight ratio of the composites A, B and C is a, b, and c (a+b+c=1), respectively, and the dry weight proportion of the bonding fibers that form each composite is α, β and γ, respectively; then the following relational formulae are established:
{a(1−α)+b(1−β)+c(1−γ)}x=P[g/m²]
[{(a·α+b·β+c·γ)x+y}]/[{a(1−α)+b(1−β)+c(1−γ)}]x=F[w/w]
in which x and y can be computed when a, b, c, α, β, γ, and P and F are given.

Thus obtained, the water-absorbent resin composite composition was uniformly spread on a stainless plate in a unit amount of 300 g/m² in an area of 40 cm×10 cm, and another stainless plate was put on it, and a load of 0.6 MPa was applied to both sides of the structure. After left for 20 minutes as such, the pressure was removed, and a compacted water-absorbent resin composite composition was thus obtained.

### 3) Preparation of Absorbent Article

Using the compacted water-absorbent resin composite composition, an absorbent article, diaper was produced according to the process mentioned below.

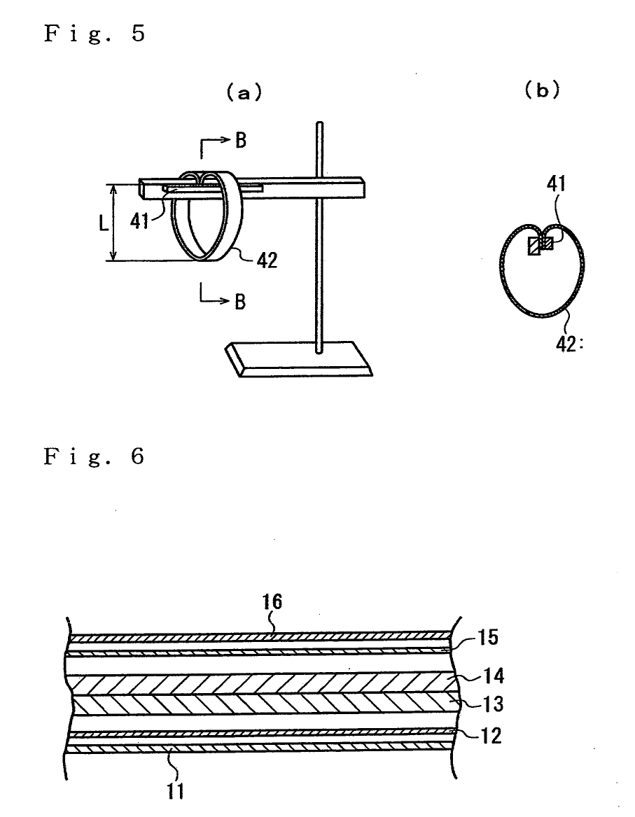

As in FIG. 6, a tissue (unit weight 14 g/m²) 12, a compacted water-absorbent resin composite composition (in such an amount that the water-absorbent resin therein could be 300 g/m², and having a size of 10 cm×40 cm) 13, a diffusion layer, nonwoven fabric of polyester fibers (unit weight 40 g m²) 14, a tissue (unit weight 14 g/m²) 15, and a water-pervious nonwoven fabric of polyester fibers (unit weight 23 g/m²) 16 were placed on a water-impervious polyethylene sheet (unit weight 18 g/m²) 11 in that order. Sandwiched between stainless sheets applied to both sides thereof, this was kept under a pressure of 0.6 MPa for 20 minutes, and was thus compacted. After this, the pressure was removed, and the four sides of the resulting absorbent article were thermally fused. The fused sides were trimmed to give an absorbent article 1 having a size of about 10 cm×about 40 cm.

### EXAMPLE 102

A product was produced in the same manner as in Example 101, except that polyethylene terephthalate (PET) fibers having a fiber diameter of 1.7 decitex, a length of 0.9 mm and a contact angle with water of 800 were used in place of the pulp fibers. The water-absorbent resin composite was observed with a microscope, and it was confirmed that the composite is a water-absorbent resin composite (composite A) having the same structure as that obtained in Example 101.

### EXAMPLE 103

A product was produced in the same manner as in Example 101, except that nylon fibers having a fiber diameter of 1.7 decitex, a length of 0.9 mm and a contact angle with water of 50° were used in place of the pulp fibers. The water-absorbent resin composite was observed with a microscope, and it was confirmed that the composite is a water-absorbent resin composite (composite A) having the same structure as that obtained in Example 101.

### EXAMPLE 104

A product was produced in the same manner as in Example 101, except that a fiber mixture of nylon fibers having a fiber diameter of 1.7 decitex, a length of 0.9 mm and a contact angle with water of 50° and rayon fibers having the same fiber diameter and length as those of the nylon fibers and having a contact angle with water of 0° in a ratio by weight of 1/1 was used in place of the pulp fibers. The water-absorbent resin composite was observed with a microscope, and it was confirmed that the composite is a water-absorbent resin composite (composite A) having the same structure as that obtained in Example 101.

### EXAMPLE 105

A product was produced in the same manner as in Example 101, except that polytetrafluoroethylene (PTFE) fibers having a fiber diameter of 1.7 decitex, a length of 0.9 mm and a contact angle with water of 108° were used in place of the pulp fibers. The water-absorbent resin composite was observed with a microscope, and it was confirmed that the composite is a water-absorbent resin composite (composite A) having the same structure as that obtained in Example 101.

### EXAMPLE 106

A product was produced in the same manner as in Example 101, except that the fibers were fed through only a fiber supply port disposed at 0.8 m below the nozzle tips, at a rate of 23 g/min. The water-absorbent resin composite was observed with a microscope, and it was confirmed that the composite comprises a water-absorbent resin composite (composite A) having the same structure as that obtained in Example 101 and a water-absorbent resin composite (composite B) in which the highly water-absorbent resin particles are nearly spherical, one or more of the fibers are partly embedded in the resin particles and are partly exposed out of the resin particles, and all the fibers do not adhere to the surfaces of the resin particles, in a dry weight ratio, composite A to composite B of 30/70.

### EXAMPLE 107

A product was produced in the same manner as in Example 101, except that the fibers were fed through only a fiber supply port disposed at 1.6 m below the nozzle tips, at a rate of 23 g/min. The water-absorbent resin composite was observed with a microscope, and it was confirmed that the composite comprises a water-absorbent resin composite (composite A) having the same structure as that obtained in Example 101 and a water-absorbent resin composite (composite C) in which the highly water-absorbent resin particles are nearly spherical, one or more of the fibers partly adhere to the surfaces of the resin particles but the fibers are not embedded at all in the resin particles, in a dry weight ratio, composite A to composite C of 20/80.

### EXAMPLE 108

In the process of producing a water-absorbent resin composite in Example 101, the deposit recovered on the belt conveyor was exposed to a water vapor atmosphere under a condition of a temperature of 85° C. and a humidity of 95% in a constant-temperature constant-humidity chamber, for 1 hour. During the exposure, the water content of the product was 36% by weight. Then, this was dried in a hot air drier of which the inner temperature was set at 120° C., for 30 minutes, and then sieved to remove the free fibers not contacted with the water-absorbent resin, thereby obtaining a water-absorbent resin composite that comprises a water-absorbent resin and fibers. The other operations were the same as those in Example 101, and the product was thus obtained.

The water-absorbent resin composite was observed with a microscope, and it was confirmed that the composite is a water-absorbent resin composite (composite A) comprising one highly water-absorbent resin particle and two or more fibers, in which the highly water-absorbent resin particle is nearly spherical, at least one of the two or more fibers is partly embedded in the resin particle and partly exposed out of the resin particle, and at least one of the two or more fibers is not embedded in the resin particle but partly adheres to the surface of the resin particle. Specifically, there was found no morphological difference between the product obtained herein and that obtained in Example 101.

### EXAMPLE 109

In the process of producing a water-absorbent resin composite in Example 101, the deposit recovered on the belt conveyor was sprayed with water so that the water content of the water-absorbent resin in the recovered product could be 67%. Next, the water-sprayed water-absorbent resin composite was dried in a hot air drier of which the inner temperature was set at 120° C., for 30 minutes, and then sieved to remove the free fibers not contacted with the water-absorbent resin, thereby obtaining a water-absorbent resin composite that comprises a water-absorbent resin and fibers. The other operations were the same as those in Example 101, and the product was thus obtained.

The water-absorbent resin composite was observed with a microscope, and it was confirmed that the composite is a water-absorbent resin composite (composite A) comprising one highly water-absorbent resin particle and two or more fibers, in which the highly water-absorbent resin particle is nearly spherical, at least one of the two or more fibers is partly embedded in the resin particle and partly exposed out of the resin particle, and at least one of the two or more fibers is not embedded in the resin particle but partly adheres to the surface of the resin particle. Specifically, there was found no morphological difference between the product obtained herein and that obtained in Example 101.

### EXAMPLE 110

In the process of producing a water-absorbent resin composite in Example 101, the deposit recovered on the belt conveyor was sprayed with an aqueous solution of 5 ppm iron (III) chloride hexahydrate so that the additive could be given to the deposit in an amount of 2 ppm in terms of the metal thereof relative to the dry weight of the water-absorbent resin composite, and then this was exposed to a water vapor atmosphere under a condition of a temperature of 85° C. and a humidity of 95% in a constant-temperature and constant-humidity chamber, for 1 hour. During the exposure, the water content of the product was 36% by weight. Next, this was dried in a hot air drier of which the inner temperature was set at 120° C., for 30 minutes, and then sieved to remove the free fibers not contacted with the water-absorbent resin, thereby obtaining a water-absorbent resin composite that comprises a water-absorbent resin and fibers. The other operations were the same as those in Example 101, and the product was thus obtained.

The water-absorbent resin composite was observed with a microscope, and it was confirmed that the composite is a water-absorbent resin composite (composite A) comprising one highly water-absorbent resin particle and two or more fibers, in which the highly water-absorbent resin particle is nearly spherical, at least one of the two or more fibers is partly embedded in the resin particle and partly exposed out of the resin particle, and at least one of the two or more fibers is not embedded in the resin particle but partly adheres to the surface of the resin particle. Specifically, there was found no morphological difference between the product obtained herein and that obtained in Example 101.

### COMPARATIVE EXAMPLE 101

A product was produced in the same manner as in Example 101, except that the polymerization activator, iron(III) chloride hexahydrate was not added to the solution X and the solution Y in the step of producing the water-absorbent resin composite in Example 101. The water-absorbent resin composite was observed with a microscope, and it was confirmed that the composite is a water-absorbent resin composite (composite A) having the same structure as that obtained in Example 101.

### COMPARATIVE EXAMPLE 102

In the process of producing a water-absorbent resin composite in Example 101, the polymerization activator, iron(III) chloride hexahydrate was not added to the solution X and the solution Y, and the product was recovered on a belt conveyor. The recovered product was exposed to a water vapor atmosphere under a condition of a temperature of 85° C. and a humidity of 95% in a constant-temperature and constant-humidity chamber, for 1 hour. During the exposure, the water content of the product was 36% by weight. Next, this was dried in a hot air drier of which the inner temperature was set at 120° C., for 30 minutes, and then sieved to remove the free fibers not contacted with the water-absorbent resin, thereby obtaining a water-absorbent resin composite that comprises a water-absorbent resin and fibers. The other operations were the same as those in Example 101, and the product was thus obtained.

The water-absorbent resin composite was observed with a microscope, and it was confirmed that the composite is a water-absorbent resin composite (composite A) having the same structure as that obtained in Example 101.

### COMPARATIVE EXAMPLE 103

A water-absorbent resin composite composition was produced in the manner mentioned below, according to Examples described in JP-A 63-63723.

45.0 g of acrylic acid and 1.5 g of distilled water were metered in a 200-ml beaker, and neutralized with 60.0 g of aqueous 25 wt. % sodium hydroxide solution with cooling at 35° C. or lower, thereby obtaining an aqueous partially-neutralized acrylic acid solution (having a monomer concentration of 50% by weight and a degree of neutralization of 60 mol %); and 41.9 mg of N,N′-methylenebisacrylamide and 0.31 g of L-ascorbic acid were dissolved in it. A 300-ml stainless beaker was completely sealed up with a polyester sheet on its top, then the sheet was holed, and a rubber tube was inserted into it through the hole, via which the beaker was fully purged with nitrogen. The aqueous monomer mixture solution was put into the stainless beaker, this was dipped in a water bath at 50° C., and with stirring, 0.84 g of 30% aqueous hydrogen peroxide was added to it, and the monomer was thus polymerized. After about 1 minute, the highest temperature of the system was 110° C. Then, this was kept dipped in the water bath at 50° C. for 2 hours, and then cooled to 20° C. to obtain a water-containing water-absorbent resin. 70 g of the water-containing water-absorbent resin (35 g of the water-absorbent resin) was kneaded with 200 g of water and 10 g of the same opened pulp as that used in Example 101, using a screw-type rotary mixer, for about 2 hours, then dried in a reduced-pressure drier at 100° C. for 8 hours, then ground with a rotary blade grinder, and sieved to remove free fiber, thereby obtaining a water-absorbent resin composite composition.

The product was observed with a microscope, and it was confirmed that the product has a structure where the fibers are partly embedded in the water-absorbent resin. However, no structure was found where the fibers are not embedded in the resin particles but partly adhere to the surfaces of the resin particles.

Then, according to the same process as in Example 101, a compacted water-absorbent resin composite composition and an absorbent article were obtained.

### COMPARATIVE EXAMPLE 104

A water-absorbent resin composite composition was produced in the manner mentioned below, according to Examples described in JP-A 11-93073.

125 parts by weight of aqueous 80 wt. % acrylic acid solution and 133 parts by weight of aqueous 30 wt. % sodium hydroxide solution were mixed to obtain an aqueous, partially-neutralized acrylic acid solution having a degree of neutralization of 72 mol % and a concentration of 47% by weight. To the aqueous partially-neutralized acrylic acid solution, added was a solution prepared by dissolving 0.04 parts by weight of a crosslinking agent, N,N′-methylenebisacrylamide and 0.3 parts by weight of an initiator, 2,2′-azobis(2-amidinopropane) dihydrochloride in 13 parts by weight of distilled water. This was degassed with nitrogen to prepare an aqueous monomer solution. Using a one-liquid-type spray nozzle in place of the nozzle used in Example 101, this was supplied by a pump at a flow rate of 40 ml/min, while kept at 25° C.

The monomer solution dropped in the vapor phase (in air at 25° C.), while forming droplets and kept under polymerization. The space density of the liquid droplets in the reactor, as estimated from the space capacity of the reactor, the monomer supply amount and the dropping speed of the liquid droplets, was 3 g/m³.

On the other hand, opened fibers were fed through a supply port disposed at 0.8 m below the nozzle tip, as a mixed flow thereof with air (fibers/air=1/100, blend ratio by weight). In this stage, the temperature of the air in the mixed flow was 25° C. and the linear velocity thereof was 10 m/sec. At 0.8 m below the nozzle tip, the polymerization rate was less than 1%. The fibers used are of pulp having a fiber diameter of 2.2 decitex and a length of 2.5 mm, and having a contact angle with water of 0°. Their supply rate was 11.5 g/min. The space density of the fibers in the reaction field, as estimated from the space capacity of the reaction field, the supply amount of the fibers and the dropping speed thereof, was 8 g/m³.

The liquid droplets collided with the fibers in a vapor phase and formed a water-absorbent resin composite precursor, which was recovered as a deposit on a belt conveyor having a mesh belt as the conveyor part thereof, disposed at 3 m below the nozzle tip. Thus recovered, the deposit was put in an oven at 80° C., in which the aqueous monomer solution adhering thereto was polymerized for 30 minutes, and then, this was treated with hot air at 140° C.

The recovered deposit was sieved so as to remove the free fibers not contacted with the water-absorbent resin, in which, however, the water-absorbent resin acted as an adhesive between the fibers and, in fact, no free fibers existed therein. In that manner, a water-absorbent resin composite comprising a water-absorbent resin and fibers was obtained.

The product was observed with a microscope, and it was confirmed that the product has a structure where the fibers partly adhere to the surfaces of the water-absorbent resin particles. However, no structure was found where the fibers are partly embedded in the water-absorbent resin.

Then, according to the same process as in Example 101, a compacted water-absorbent resin composite composition and an absorbent article were obtained.

### TEST EXAMPLE 1

In the above-mentioned Examples and Comparative Examples, the space density of fibers, the mean diameter of liquid droplets, the space density of liquid droplets, the contact angle with water of fibers used in producing water-absorbent resin composites, the polymerization degree of a monomer at a point at which the monomer is contacted with fibers in producing a water-absorbent resin composite, the morphology confirmation of the produced water-absorbent resin composites, the dry weight ratio of the respective composites constituting a water-absorbent resin composite, the dry weight ratio of the bonding fibers and the highly water-absorbent resin that constitute a water-absorbent resin composite, the water absorption of a highly water-absorbent resin, the remaining monomer amount, the L-ascorbic acid amount, the powder deodorization test, the gel deodorization test, the water content, the mean particle size of highly water-absorbent resins, and the openability of water-absorbent resin composites were determined according to the methods mentioned below, and the results are given in Tables 3 to 6.

1) Space Density of Fibers:

On the presumption that fibers may move downwardly from the above, as flying in the air stream to be fed as a mixed flow with them, the residence amount of the fibers in the reaction field is computed, and by dividing the residence amount by the volume of the entire reaction field, the space density of the fibers in the reaction field is computed.

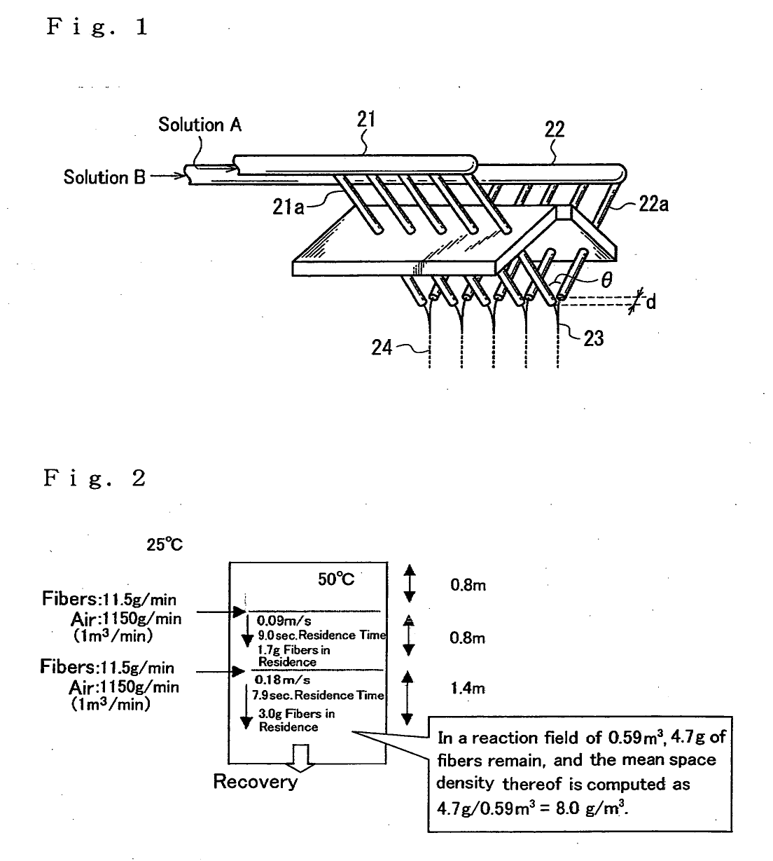

For example, in Example 101, the reaction filed is an empty cylinder having a diameter of 0.5 m and a height of 3 m, and the space density of the fibers in the reaction field is computed as in FIG. 2.

2) Mean Diameter of Liquid Droplets:

From the mean diameter dp and the monomer concentration (concentration of (acrylic acid+sodium acrylate)) Cm of the highly water-absorbent resin particles that constitute a water-absorbent resin composite, which will be mentioned below, it is computed according to the following formula:
Diameter of Liquid Droplets dd=dp/(Cm)^{1/3}
3) Space Density of Liquid Droplets:

On the presumption that liquid droplets may drop in a reaction field at a downwardly-jetting speed from the nozzle as the initial speed thereof, the residence amount of the liquid droplets in the reaction field is computed, and by dividing the residence amount by the volume of the entire reaction field, the space density of the liquid droplets in the reaction field is computed.

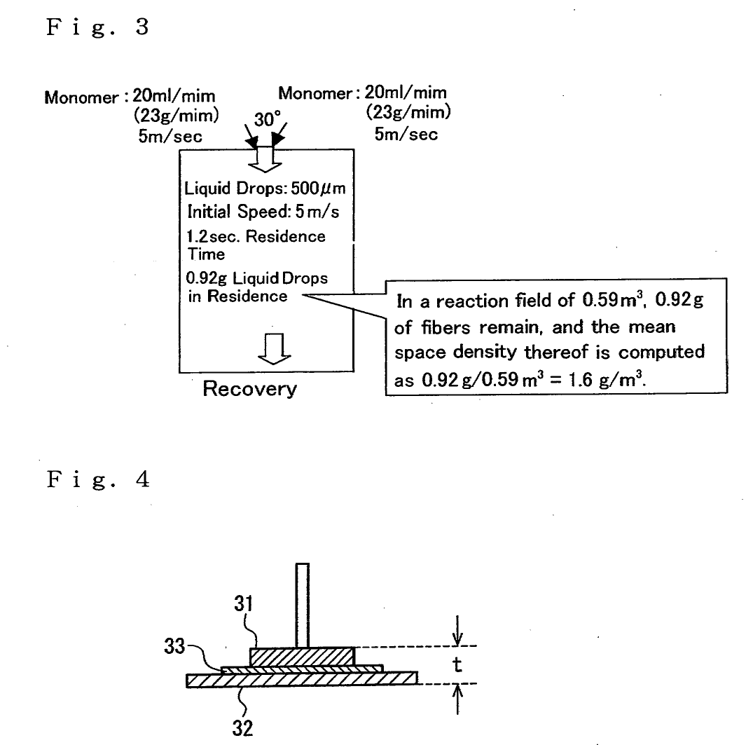

For example, in Example 101, the reaction filed is an empty cylinder having a diameter of 0.5 m and a height of 3 m, and the space density of the liquid droplets in the reaction field is computed as in FIG. 3.

4) Contact Angle with Water of Fibers:

(1) Using a solvent capable of dissolving or dispersing the fibers used, the fibers are formed into a solution thereof having a concentration of from 1 to 10% by weight.

(2) The solution is thinly spread on a laboratory dish, and the solvent is gently evaporated away in dry air at room temperature. After fully dried, a thinly-spread and shaped film is thus obtained.

(3) A contact angle with distilled water at room temperature of the air-facing surface of the shaped film is determined. The contact angle is determined, using an automatic contact angle meter Model CA-V (by Kyowa Kaimen Kagaku KK).

5) Monomer Polymerization Rate at a Point at which the Monomer is Contacted with Fibers:

(1) A beaker with about 150 g of methanol put therein is so disposed that the methanol liquid level could be at a position at which fibers are introduced, and liquid droplets of a reaction mixture where the monomer is under polymerization are formed in a vapor phase and about 1 g of the liquid drops under polymerization are dropwise led into the methanol in the beaker.

(2) The monomer amount in methanol is determined through liquid chromatography.

(3) The polymer in methanol is dried under reduced pressure at 130° C. for 3 hours, and then its weight is measured.

(4) Next, the polymerization rate is computed from the weight data, according to the following formula (In which Mp indicates the polymer weight, and Mm indicates the monomer weight):
Polymerization Rate(%)=[Mp/(Mm+Mp)]×100.
6) Morphology Confirmation:

(1) A water-absorbent resin composite is observed with a scanning electronic microscope, as enlarged by from 20 to 20,000-power magnifications, to thereby confirm the structure thereof as to whether the fibers are partly embedded inside the resin and partly exposed out of it, or as to how the fibers adhere to the resin surface.

(2) Further, the composite is continuously cut into pieces with a precision cutting tool such as a microtome, and the cut section of each piece is observed, as enlarged by from 2o to 20,000-power magnifications, to thereby confirm the structure thereof as to whether the fibers are partly embedded inside the resin and partly exposed out of it, or as to how the fibers adhere to the resin surface.

7) Dry Weight Ratio of Water-Absorbent Resin Composites:

(1) About 1 g of a water-absorbent resin composite is grouped into a composite A, a composite B and a composite C, using an optical microscope (in this, every sample does not have a water-absorbent resin having neither free fibers nor bonding fibers).

(2) The weight of each composite is measured with a precision balance, and the dry weight ratio of the respective water-absorbent resin composites is obtained.

8) Dry Weight Ratio of Bonding Fibers and Water-Absorbent Resin that Constitute Water-Absorbent Resin Composite:

In the individual water-absorbent resin composites that have been grouped in the previous section for determination of the dry weight ratio of water-absorbent resin composites, the fibers are isolated using an agent which selectively decomposes the water-absorbent resin in the composite, and their weight is measured. The entitled dry weight ratio is obtained from the thus-measured weight data.

Concretely, for the composite A:

(1) the weight of the composite A obtained in the previous section is represented by Wc. The water-absorbent resin composite A is fed into a 50-ml sealable glass container, and an aqueous solution prepared by dissolving 0.03 g of L-ascorbic acid in 25 g of distilled water is added to it to swell the composite, and then this is left at 40° C. for 24 hours.

(2) Next, this is dried under reduced pressure at 80° C. for 3 hours, and after having reached a constant amount, the contents in the glass container are filtered under suction through filter paper, using an aspirator under an ultimate vacuum degree of from 10 to 25 mmHg. Then, the fibers on the filter paper are well washed with water, dried at 100° C. for 5 hours, and their weight is accurately measured. Its weight value is represented by Wf.

(3) The dry weight ratio of the bonding fibers and the water-absorbent resin that constitute the composite A is obtained according to the following formula:
Bonding Fibers/Water-Absorbent Resin(ratio by dry weight)=Wf/(Wc−Wf).
9) Water-Absorbing Capability of Highly Water-Absorbent Resin:

1,000 ml of physiological saline having a concentration of 0.9% by weight is put into a 2000-ml beaker. About 1.0 g of a water-absorbent resin composite is put into a 250-mesh nylon bag (having a size of 10 cm×20 cm), and this in the bag is dipped in the above physiological saline for 30 minutes. Next, the nylon bag is pulled up, and left for 15 minutes to remove water from it, and its weight is then measured. This is represented by W1 (g). As a blank, fibers having the same weight as that of the fibers contained in the water-absorbent resin composite used for the measurement of W1 are prepared, and after they have absorbed the physiological saline, their weight is measured in the same manner as that for W1. This is represented by W2 (g). The weight of the highly water-absorbent resin contained in the water-absorbent resin composite used for the measurement of W1 is measured in the same manner as in the previous section, and this is represented by W3 (g). The ability of the highly water-absorbent resin to absorb physiological saline is computed according to the following formula:
Physiological Saline-Absorbing Capability(g/g)=(W1−W2)/W3.
10) Remaining Monomer (L-Ascorbic Acid) Amount:

The monomer (or L-ascorbic acid) amount remaining in the recovered water-absorbent resin composite or water-absorbent resin composite composition (sample) is obtained according to the method mentioned below.

(1) About 1 g of a sample is accurately measured and dipped in 250 ml of distilled water for 24 hours so that the remaining monomer (L-ascorbic acid) is extracted out into the aqueous phase.

(2) The resulting aqueous extract is filtered through a membrane filter of cellulose acetate having a pore size of 0.45 μm, and the filtrate is recovered. The monomer (L-ascorbic acid) amount in the recovered filtrate is determined through liquid chromatography equipped with a water-based column, and the remaining monomer amount (ppm) is computed according to the following formula:
[Extracted monomer(L-ascorbic acid)weight(g)]/[sample weight(g)]×1,000,000.
11) Powder Deodorization Test:

One g of a polymer is put into the bottom of a glass container having a capacity of about 500 ml, and 400 μl of an aqueous solution of 0.1% by weight of an evil-smelling substance, t-butylmercaptan is injected into it through a syringe. This is sealed up and left at room temperature for 30 hours. Using a detector-type vapor meter (detector 70 L) by Gastec, the t-butylmercaptan concentration in the vapor phase in the container is measured.

On the other hand, an aqueous solution of 0.1 wt. % methylamine is used in place of the aqueous solution of 0.1 wt. % t-butylmercaptan, and the sample is tested in the same manner as above but using a detector 180 in place of the detector 70L.

12) Gel Deodorization Test:

4 g of a polymer is uniformly spread on a cotton nonwoven fabric (unit weight, 150 g/m²; size, 1 cm×8 cm). Further, a cotton nonwoven fabric of the same material and the same size as above is placed on this nonwoven fabric to prepare a simple liquid-absorbent pad sample. This is put into a 250-ml glass container equipped with a cap, and 100 g of human urine (mixture of human urine of 5 adults) is absorbed by it, and the container is capped and left at 40° C. for 24 hours. Then, using a detector-type vapor meter (methylamine: detector 180, hydrogen sulfide: detector 4LT, methylmercaptan: detector 70L) byGastec, the methylamine, hydrogen sulfide and methylmercaptan concentration in the vapor phase in the container is measured.

13) Water Content of Water-Absorbent Resin Composite:

About 7 g of a water-absorbent resin composite is analyzed with an IR moisture determination balance (Kett Scientific Laboratory's FD-100, having a dry heat source of 280 W ring-shaped ceramic spray-coated sheath heater) to determine the water content of the water-absorbent resin composite (based on the wet weight of the sample).

14) Mean Particle Size of Highly Water-Absorbent Resin Particles:

An optical microscopic picture of a water-absorbent resin composite is taken, in which 100 highly water-absorbent resin particles constituting the composite (the highly water-absorbent resin particles are all nearly spherical) are selected at random, and their diameter is measured. The data are averaged to give a mean value by number, and this is the mean particle size of the particles.

15) Openability of Water-Absorbent Resin Composite:

(1) About 5 g of a water-absorbent resin composite is sandwiched between a pair of hand cutters (22 cm×12.5 cm) made by Ashford, and carded five times by hand.

(2) The sample is evaluated in the following three ranks, depending on the cardability thereof and on the broken condition of the carded water-absorbent resin particles.

O: Readily cardable, and after carded, the water-absorbent resin particles are broken little.

Δ: Resistant to carding, and after carded, some water-absorbent resin particles are broken.

x: Too much resistant to carding, and the sample could not be carded; or strongly resistant to carding, and after carded, the water-absorbent resin particles are extremely broken.

### TEST EXAMPLE 2

The thickness, the bulk density, the bending resistance and the recovery of the compacted water-absorbent resin composite composition prepared in Examples and Comparative Examples are determined according to the methods mentioned below. The results are given in Tables 4 to 6.

1) Thickness:

A sample piece of 5 cm×5 cm is cut out of a compacted water-absorbent resin composite composition, and its thickness is measured according to JIS 1-1096, as in FIG. 4.

(1) An adaptor 31 having a diameter of 30 mm is attached to a rheometer (Model, NRM-2003J by FUDOH), which is so set that the sample bed 32 could elevate at a speed of 2 cm/min and could stop when a pressure of 0.2 psi is applied thereto.

(2) A sample (compacted water-absorbent resin composite composition) 33 is put on the sample bed 32, and the sample bed 32 is elevated and stopped when a pressure of 0.2 psi is applied thereto. At that position, the distance t between the upper face of the adaptor 31 and the lower face of the sample bed 32 is measured with calipers.

(3) Five samples are tested, and their mean value is obtained.

(4) No sample is put on the sample bed 32 for a blank test, and the blank value is obtained.

(5) The thickness is computed according to the following formula:
Thickness(mm)=sample data(mm)−blank data(mm).
2) Bulk Density:

A sample piece of 5 cm×5 cm is cut out of a compacted water-absorbent resin composite composition, and its weight is measured. According to the following formula, the bulk density of the sample is obtained. Five samples are tested, and their mean value is obtained.
Bulk Density(g/cm³)=(sample weight(g))/(sample thickness(cm)×sample area(cm²)).
3) Bending Resistance:

A sample piece of 2 cm×25 cm is cut out of a compacted water-absorbent resin composite composition, and kept at a temperature of 25° C. and a humidity of 50° C. for one full day, and then its bending resistance is measured according to a heart-loop process applied to relatively soft fabrics in JIS L-1096, as in FIG. 5.

(1) A sample piece 42 is fitted, like a heart-loop, to the clamp 41 of a horizontal bar in FIG. 5 so that the effective length of the sample piece 42 could be 20 cm.

(2) After 1 minute, the distance L (cm) between the top of the horizontal bar and the lowermost bottom of the loop is measured. In this, L is defined as the bending resistance of the sample. Five samples are tested, and their mean value is obtained.

4) Recovery:

A sample piece of 5 cm×5 cm is cut out of a compacted water-absorbent resin composite composition, and compressed under a pressure of 10 MPa for 10 minutes. Then, the pressure is removed, and the thickness of the compressed absorbent is measured according to the above-mentioned thickness-measuring method, immediately after compression and after kept released from the pressure at a temperature of 25° C. and a humidity of 50° C. for 30 days. The recovery of the sample is computed according to the following formula. Five samples are tested, and their mean value is obtained.
Recovery(%)=(thickness in 30 days kept in release from pressure−thickness immediately after release from pressure (mm))/(thickness immediately after release from pressure(mm)×100.

### TEST EXAMPLE 3

The water absorption speed, the amount of released water, the highly water-absorbent resin dropping ratio, and the gel dropping ratio of the absorbent article obtained in Examples and Comparative Examples are determined according to the methods mentioned below. The results are given in Tables 4 to 6.

Artificial urine used in evaluation of the absorbent article is prepared to have the following composition:

<Composition of Artificial Urine>

| | |
|---|---|
| Urea | 1.94% by weight |
| Sodium Chloride | 0.80% by weight |
| Calcium Chloride | 0.06% by weight |
| Magnesium Sulfate | 0.11% by weight |
| Distilled Water | 97.09% by weight |

1) Water Absorption Speed and Amount of Released Water:

A sample piece of 10 cm×40 cm is cut out of an absorbent article, and using artificial urine, the water absorption speed and the amount of released water of the sample are measured according to the methods mentioned below as in FIG. 7.

(1) A sample (absorbent article) 52 is put on a horizontal flat bed 51. An acrylic plate 55 (100×100×10 mm, overall weight 150 g), to which a cylinder 53 having an inner diameter 40 mm and whose top end is opened is fitted in the center thereof and in which seven through-holes 54 each having a diameter of 5 mm are formed in the area surrounded by the cylinder 53 with nearly regular intervals therebetween is placed on the sample 52.

(2) Further, a metal disc 56 (1250 g) having a diameter of 100 mm and having a hole 56A with a diameter of 45 mm formed in the center thereof is put on the sample, as inserted through the cylinder 53. 25 ml of artificial urine is put in the cylinder 53, and the time taken before it is absorbed by the sample is measured with a stopwatch. This is the water absorption speed (sec) of the sample.

(3) After 10 minutes, the disc 56 and the cylinder-combined acrylic plate 55 are removed, and 20 sheets of filter paper (Toyo Filter's ADVANTEC No. 424, 100×100 mm) piled up in one are put on the same place where the acrylic plate 55 was on the sample 52, and a load of 4 kg having a bottom area of 10 cm×10 cm is put on the filter paper. After 5 minutes, the load is removed, and the weight of the filter paper is measured, and the amount of the artificial urine absorbed by the filter paper is measured. This is the amount of released water from the sample (g).

(4) The operation of (1) to (3) is repeated further two times, and the mean value is obtained.

2) Highly Water-Absorbent Resin Dropping Ratio:

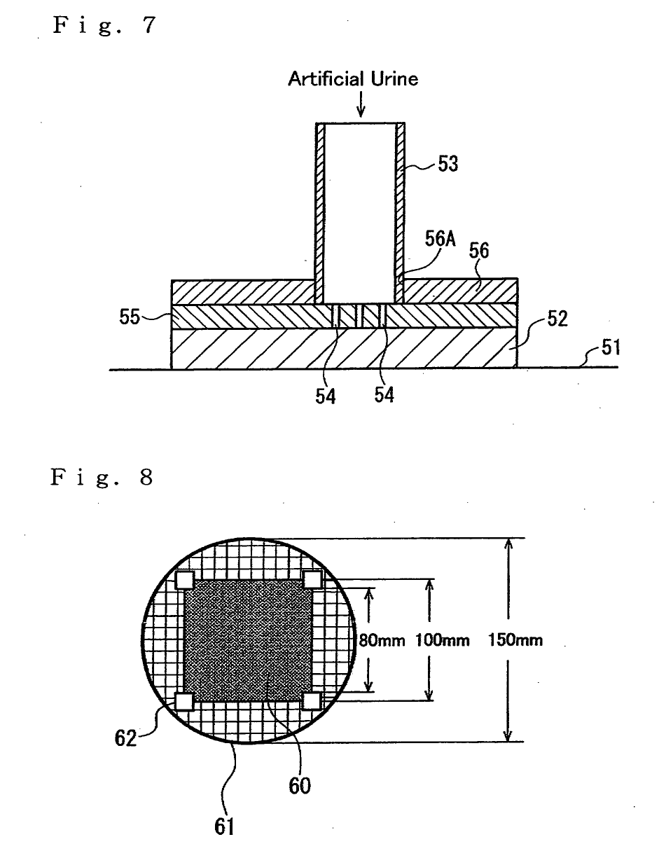

(1) A sample piece of 10 cm×10 cm is cut out of an absorbent article (of which all the four sides are open), and its weight is measured. From the constitution of the absorbent article, the overall amount of the highly water-absorbent resin is obtained. As in FIG. 8, the sample piece of absorbent article 60 is fixed on a standard screen (the dimension of the inner frame is as follows: the inner diameter is 150 mm, the depth is 45 mm; 20-mesh screen) 61, as defined in JISZ8801, at the four corners thereof each with a tape 62.

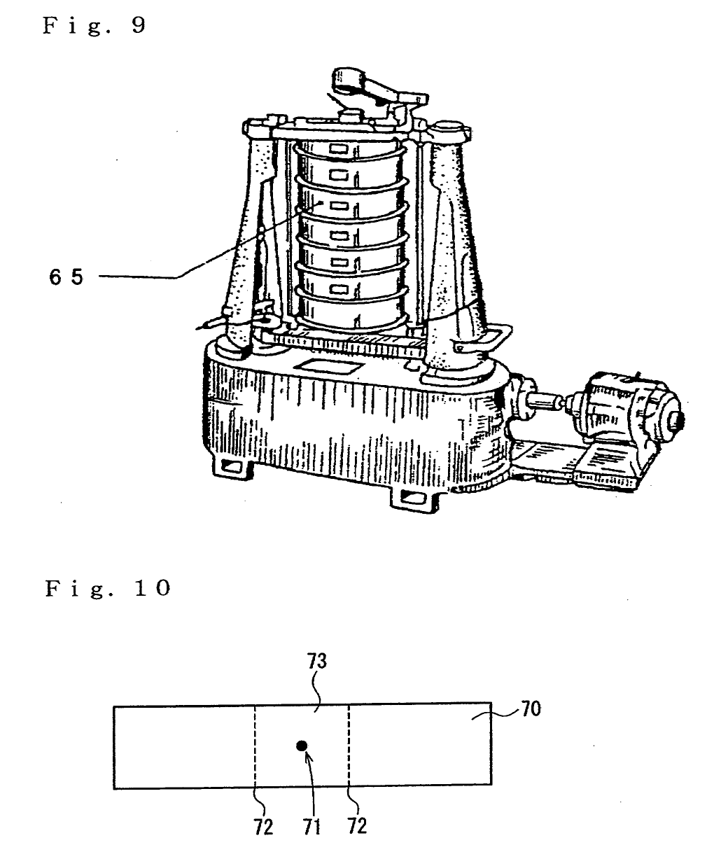

(2) Using a ro-tap shaker 65 of Model SS-S-228 (JIS Z8815) made by Tokyo Shinohara Seisaku-sho shown in FIG. 9, the absorbent article sample is fixed only in the uppermost stage thereof.

(3) The shaker is so set that its pulse frequency is 165/min and its revolution number is 290 rpm, and after shaken for 60 minutes with it, the weight of the water-absorbent resin composite separated from the absorbent article is measured. From the polymerization ratio of the highly water-absorbent resin in the water-absorbent resin composite, the dropped, highly water-absorbent resin amount is obtained, and the dropping ratio is obtained according to the following formula:
Dropping Ratio(%)=[propped highly water-absorbent resin amount(g)]/[highly water-absorbent resin amount(g)before shaking]×100.
3) Gel Dropping Ratio:

The dropping ratio of the water-absorbent gel in an absorbent article, when a force acting to rub the absorbent article is repeatedly applied to it, is measured according to the process mentioned below.

(1) As in FIG. 7, a sample (absorbent article) 52 is put on a horizontal flat bed 51. An acrylic plate 55 (100×100×10 mm, overall weight 150 g), to which a cylinder 53 having an inner diameter 40 mm and whose top end is opened is fitted in the center thereof, and in which seven through-holes 54 each having a diameter of 5 mm are formed in the area surrounded by the cylinder 53 with nearly regular intervals therebetween is placed on the sample. In this, however, a disc 56 is not used.

(2) 150 ml of artificial urine is put into the cylinder 53, and absorbed by the absorbent article.

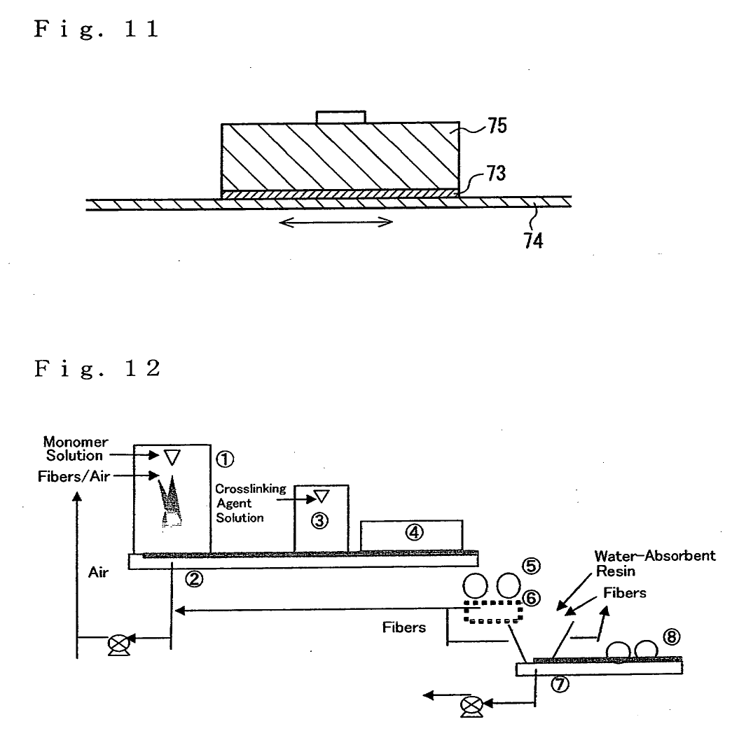

(3) For 30 minutes after the complete absorption, this is left at room temperature, and then cut at lines 72 separated from its center 71 by 5 cm to give a sample piece 73, as in FIG. 10, and its weight is measured.

(4) After the measurement, the sample 73 is put on the center of an acrylic plate 74 having a size of 20 cm×20 cm, and a load (3 kg) 75 having the same bottom area as the size of the sample piece (10 cm×10 cm) is put on it in accordance with the shape of the sample piece so that the load does not shift from the sample, as in FIG. 11.

(5) Thus integrated, the sample is set in a shaker (Model MS-1 by Iuchi Seieido) in such a manner that the cut face of the sample could be vertical to the moving direction of the shaker, and in that condition, this is shaken to an amplitude of 50 mm at a frequency of 80/min for 30 minutes.

(6) After thus shaken, the load is removed, and the weight of the water-absorbent gel dropped from the sample is measured. According to the following formula, the gel dropping ratio is computed:
Gel Dropping Ratio(%)=[extruded gel amount(g)/gel amount (g)before extrusion]×100.

TABLE 4

| | | | Example | | | | |
|---|---|---|---|---|---|---|---|
| | | | 101 | 102 | 103 | 104 | 105 |
| Production of | Fibers | Species of Fibers | pulp | PET | nylon | nylon/rayon | PTFE |
| Water-Absorbent | | Mean Fiber Length [mm] | 2.5 | 0.9 | 0.9 | 0.9 | 0.9 |
| Resin Composite | | Mean Fiber Diameter [dtex] | 2.2 | 1.7 | 1.7 | 1.7 | 1.7 |
| | | Contact Angle with Water [°] | 0 | 80 | 50 | 50/0 | 108 |
| | | Space Density [g/m³] | 8 | 8 | 8 | 8 | 8 |
| | | Polymerization Rate in Supply of Fibers [%] | 15/40 | 15/40 | 15/40 | 15/40 | 15/40 |
| | Liquid Drops | Mean Diameter [μm] | 500 | 500 | 500 | 500 | 500 |
| | | Space Density [g/m³] | 2 | 2 | 2 | 2 | 2 |

| Evaluation of | Water-Absorbent Resin Composite Constitution (A/B/C) | | 100/0/0 | 100/0/0 | 100/0/0 | 100/0/0 | 100/0/0 |
|---|---|---|---|---|---|---|---|
| Water-Absorbent | [ratio by weight] | | | | | | |
| Resin Composite | Mean Diameter of Highly Water-Absorbent Resin Particles [μm] | | 400 | 400 | 400 | 400 | 400 |
| | Water-Absorbing Capability of Highly Water-Absorbent | | 45 | 45 | 45 | 45 | 45 |
| | Resin Particles [g/g] | | | | | | |
| | Remaining Monomer Amount [ppm] | | 480 | 460 | 470 | 475 | 460 |
| | Openability | | ◯ | ◯ | ◯ | ◯ | ◯ |
| Evaluation of | Composition (composites A/B/C/free fibers) [ratio by weight] | | 89/0/0/11 | 89/0/0/11 | 89/0/0/11 | 89/0/0/11 | 89/0/0/11 |
| Compacted | Water-Absorbent Resin/Fibers (bonding fibers + free fibers) [ratio by | | 80/20 | 80/20 | 80/20 | 80/20 | 80/20 |
| Water-Absorbent | weight] | | | | | | |
| Resin Composite | Remaining Monomer Amount [ppm] | | 430 | 410 | 420 | 420 | 410 |
| Composition | Thickness [mm] | | 1.0 | 1.5 | 1.5 | 1.5 | 1.5 |
| | Bending Resistance [cm] | | 9.0 | 9.0 | 9.0 | 9.0 | 9.0 |
| | Recovery [%] | | 9 | 40 | 40 | 40 | 40 |
| | Bulk Density [g/cm³] | | 0.375 | 0.25 | 0.25 | 0.25 | 0.25 |
| Evaluation of | Water Absorption (g) | 1st test | 1 | 1 | 1 | 1 | |
| Absorbent Article | | 2nd test | 1 | 1 | 1 | 1 | |
| | | 3rd test | 2 | 2 | 2 | 2 | |
| | Water Release (g) | 1st test | 1.9 | 1.5 | 1.5 | 1.5 | |
| | | 2nd test | 2.1 | 1.8 | 1.8 | 1.8 | |
| | | 3rd test | 2.5 | 1.9 | 1.9 | 1.9 | |

| | | | | | |
|---|---|---|---|---|---|
| Highly Water-Absorbent Resin Dropping Ratio [%] | 0.5 | 0.0 | 0.0 | 0.0 | 4.0 |
| Gel Dropping Ratio [%] | 0.5 | 1.0 | 2.0 | 2.0 | 4.0 |

TABLE 5

| | | | Example | | | | |
|---|---|---|---|---|---|---|---|
| | | | 106 | 107 | 108 | 109 | 110 |
| Production of | Fibers | Species of Fibers | pulp | pulp | pulp | pulp | pulp |
| Water-Absorbent | | Mean Fiber Length [mm] | 2.5 | 2.5 | 2.5 | 2.5 | 2.5 |
| Resin Composite | | Mean Fiber Diameter [dtex] | 2.2 | 2.2 | 2.2 | 2.2 | 2.2 |
| | | Contact Angle with Water [°] | 0 | 0 | 0 | 0 | 0 |
| | | Space Density [g/m³] | 8 | 5 | 8 | 8 | 8 |
| | | Polymerization Rate in Supply of Fibers [%] | 15 | 40 | 15/40 | 15/40 | 15/40 |
| | Liquid Drops | Mean Diameter [μm] | 500 | 500 | 500 | 500 | 500 |
| | | Space Density [g/m³] | 2 | 2 | 2 | 2 | 2 |

| Evaluation of | Water-Absorbent Resin Composite Constitution (A/B/C) | | 30/70/0 | 20/0/80 | 100/0/0 | 100/0/0400 | 100/0/0 |
|---|---|---|---|---|---|---|---|
| Water-Absorbent | [ratio by weight] | | | | | | |
| Resin Composite | Mean Diameter of Highly Water-Absorbent Resin Particles [μm] | | 400 | 400 | 400 | 400 | 400 |
| | Water-Absorbing Capability of Highly Water-Absorbent Resin | | 45 | 45 | 45 | 45 | 45 |
| | Particles [g/g] | | | | | | |
| | Remaining Monomer Amount [ppm] | | 485 | 475 | 90 | 70 | 50 |
| | Openability | | ◯ | ◯ | ◯ | ◯ | ◯ |
| Evaluation of | Composition (composites A/B/C/free fibers) [ratio by weight] | | 26/62/0/12 | 18/0/70/12 | 89/0/0/11 | 89/0/0/11 | 89/0/0/11 |
| Compacted | Water-Absorbent Resin/Fibers (bonding fibers + free fibers) [ratio by | | 80/20 | 80/20 | 80/20 | 80/20 | 80/20 |
| Water-Absorbent | weight] | | | | | | |
| Resin Composite | Remaining Monomer Amount [ppm] | | 430 | 420 | 80 | 60 | 45 |
| Composition | Thickness [mm] | | 1.0 | 1.0 | 1.0 | 1.0 | 1.0 |
| | Bending Resistance [cm] | | 9.0 | 9.0 | 9.0 | 9.0 | 9.0 |
| | Recovery [%] | | 9 | 9 | 9 | 9 | 9 |
| | Bulk Density [g/cm³] | | 0.375 | 0.375 | 0.375 | 0.375 | 0.375 |
| Evaluation of | Water Absorption (g) | 1st test | 1 | 1 | 1 | 1 | 1 |
| Absorbent Article | | 2nd test | 1 | 1 | 1 | 1 | 1 |
| | | 3rd test | 2 | 2 | 2 | 2 | 2 |
| | Water Release (g) | 1st test | 1.9 | 1.9 | 1.9 | 1.9 | 1.9 |
| | | 2nd test | 2.1 | 2.1 | 2.1 | 2.1 | 2.1 |
| | | 3rd test | 2.5 | 2.5 | 2.5 | 2.5 | 2.5 |

| | | | | | |
|---|---|---|---|---|---|
| Highly Water-Absorbent Resin Dropping Ratio [%] | 1.5 | 0.5 | 0.5 | 0.5 | 0.5 |
| Gel Dropping Ratio [%] | 0.5 | 1.5 | 0.5 | 0.5 | 0.5 |

TABLE 6

| | | | Comparative Example | | | |
|---|---|---|---|---|---|---|
| | | | 101 | 102 | 103 | 104 |
| Production of | Fibers | Species of Fibers | pulp | pulp | pulp | pulp |
| Water-Absorbent | | Mean Fiber Length [mm] | 2.5 | 2.5 | 2.5 | 2.5 |
| Resin Composite | | Mean Fiber Diameter [dtex] | 2.2 | 2.2 | 2.2 | 2.2 |
| | | Contact Angle with Water [°] | 0 | 0 | 0 | 0 |
| | | Space Density [g/m³] | 8 | 8 | — | 8 |
| | | Polymerization Rate in Supply of Fibers [%] | 15/40 | 15/40 | — | <1 |
| | Liquid Drops | Mean Diameter [μm] | 500 | 500 | — | 250 |
| | | Space Density [g/m³] | 2 | 2 | — | 3 |

| | | | | | |
|---|---|---|---|---|---|
| Evaluation of | Water-Absorbent Resin Composite Constitution (A/B/C) [ratio by weight] | 100/0/0 | 100/0/0 | 0/100/0 | 0/0/100 |
| Water-Absorbent | Mean Diameter of Highly Water-Absorbent Resin Particles [μm] | 400 | 400 | — | 200 |
| Resin Composite | Water-Absorbing Capability of Highly Water-Absorbent Resin Particles | 45 | 45 | 30 | 37 |
| | [g/g] | | | | |
| | Remaining Monomer Amount [ppm] | 2800 | 2300 | 2300 | 3500 |
| | Openability | ◯ | ◯ | X | X |
| Evaluation of | Composition (composites A/B/C/free fibers) [ratio by weight] | 89/0/0/11 | 89/0/0/11 | 0/89/0/11 | 0/0/89/11 |
| Compacted | Water-Absorbent Resin/Fibers (bonding fibers + free fibers) [ratio by | 80/20 | 80/20 | 80/20 | 80/20 |
| Water-Absorbent | weight] | | | | |
| Resin Composite | Remaining Monomer Amount [ppm] | 2500 | 2050 | 2050 | 3100 |
| Composition | Thickness [mm] | 1.0 | 1.0 | 1.5 | 1.5 |
| | Bending Resistance [cm] | 9.0 | 9.0 | 9.0 | 9.0 |
| | Recovery [%] | 9 | 9 | 20 | 40 |
| | Bulk Density [g/cm³] | 0.375 | 0.375 | 0.25 | 0.25 |

| | | | | |
|---|---|---|---|---|
| Evaluation of | Water Absorption (g) | 1st test | 1 | 1 |
| Absorbent Article | | 2nd test | 1 | 1 |
| | | 3rd test | 2 | 2 |
| | Water Release (g) | 1st test | 1.9 | 1.9 |
| | | 2nd test | 2.1 | 2.1 |
| | | 3rd test | 2.5 | 2.5 |

| | | | | |
|---|---|---|---|---|
| Highly Water-Absorbent Resin Dropping Ratio [%] | 0.5 | 0.5 | 6.0 | 20.0 |
| Gel Dropping Ratio [%] | 0.5 | 0.5 | 13.0 | 15.0 |

### EXAMPLE 201

A concrete process of the production method of the invention is described with reference to the flowchart of FIG. 12.

The production method of Example 201 is carried out in accordance with the above-mentioned process (1).

(Hybridizing Step)

133.3 parts by weight of aqueous 25 wt. % sodium hydroxide solution and 3.3 parts by weight of distilled water were added to 100 parts by weight of acrylic acid to prepare an aqueous, partially-neutralized acrylic acid solution having a monomer concentration of 50% by weight and a degree of neutralization of 60 mol %. To 100 parts by weight of the aqueous partially-neutralized acrylic acid solution, added were 0.14 parts by weight of a crosslinking agent, N,N′-methylenebisacrylamide and 4.55 parts by weight of an oxidizing agent, aqueous 31 wt. % hydrogen peroxide solution to prepare a solution A.

Apart from it, 0.14 parts by weight of a crosslinking agent, N,N′-methylenebisacrylamide and 0.57 parts by weight of a reducing agent, L-ascorbic acid were added to 100 parts by weight of the aqueous partially-neutralized acrylic acid solution to prepare a solution B.

Thus prepared, the solution A and the solution B were mixed by the use of the nozzles disposed above the polymerization tank 1 in FIG. 12. The nozzles have the structure of FIG. 1, in which the inner diameter of the nozzles is 0.13 mm, and five nozzles are disposed for each solution at intervals of 1 cm. The crossing angle of the solution A and the solution B flowing out of the nozzles was adjusted to be 30 degrees, and the distance between the nozzle tips was 4 mm. The solution A and the solution B were heated at 40° C., and supplied to the nozzles by a pump at a flow rate of 5 m/sec.

The solution A and the solution B met together at a place where they left the nozzle of each nozzle pair, and after formed a liquid column of about 10 mm long, it became liquid droplets dropping in a vapor phase, in which the monomer was under polymerization (in air, at 50° C.). The space density of the liquid droplets in the reactor, as estimated from the space capacity of the reactor, the monomer supply amount and the dropping speed of the liquid droplets, was 3 g/m³.

On the other hand, opened fibers were fed through a supply port disposed at 0.8 m or 1.6 m below the nozzle tips, as a mixed flow thereof with air. In this stage, the temperature of the air in the mixed flow was room temperature and the linear velocity thereof was 10 m/sec. At 0.8 m and 1.6 m below the nozzle tips, the monomer conversion rate was 15% and 40%, respectively. The fibers used are of pulp having a contact angle with water of 0°, and having a fiber diameter of 2.2 decitex and a length of 2.5 mm. Their supply rate was 11.5 g/min. The space density of the fibers in the reaction field, as estimated from the space capacity of the reaction field, the supply amount of the fibers and the dropping speed thereof, was 6 g/m³. The liquid droplets dropped in the vapor phase, while colliding with the fibers fed thereto in the manner as above and forming a composite.

(Recovering Step)

The composite was deposited on the vacuum conveyor 2 disposed at 3 m below the nozzle tips. The vacuum conveyor 2 has a mesh belt as the convey or part. Since the reduced pressure degree below the mesh was set at −1000 Pa relative to the inside of the polymerization tank 1, the composite could be efficiently deposited on the vacuum conveyor 2 while prevented from scattering. The air sucked by the vacuum conveyor 2 was recycled as the air to form a mixed flow in supplying fibers into the polymerization tank 1.

(Surface-Crosslinking Step)

The deposit recovered in the recovering step was transported to the surface-protecting agent spray tank 3 by the rotating vacuum conveyor 2, in which a surface-crosslinking agent was sprayed on it. Ethylene glycol diglycidyl ether was used as the surface-crosslinking agent; water was used as the solvent; and the concentration of the surface-crosslinking agent was 0.5% by weight. The surface-crosslinking agent was sprayed at room temperature. The spraying was so controlled that ethylene glycol diglycidyl ether could adhere to the water-absorbent resin particles in an amount of 1000 ppm by weight. The crosslinking reaction was effected in the next drying step.

(Drying Step)

The recovered deposit on which the surface-crosslinking agent had been sprayed was further transported out of the surface-crosslinking agent spray tank 3 by the rotating vacuum conveyor 2, and then dried with hot air from the drier 4. The time taken before exposure to hot air after spraying with the surface-crosslinking agent was 1 minute. The hot air temperature was 130° C. Thus exposed to hot air for 2 minutes, the water content of the deposit became at most 10% by weight.

(Opening Step)

The dried deposit was opened with the opener 5. For the opening, herein used was an electromotive drum carder, in which fiber masses are made to pass between two rotary drums each with a large number of needles fixed thereto, one being large and the other being small, and they are carded. In the deposit recovered in this Example, the individual composites were independent of each other, and therefore, the deposit was readily opened.

(Sieving Step)

The opened product was led into the sieving unit 6 disposed below the opener 5, in which it was sieved. Using the sieving unit 6, the product was sieved through a shaking sieve (1000 cpm) with a 20-mesh sieving screen (pore size, 850 μm) fitted thereto. Thus sieved, the fibers not adhering to the composite were removed from the composite. The recovered fibers were recycled as the fibers to be fed to the polymerization tank 1.

(Shaping Step)

The composite obtained in the sieving step was collected on the rotating vacuum conveyor 7, and transported to the crimper 8. Before collected on the vacuum conveyor 7, the composite was further mixed with a water-absorbent resin and/or fibers whereby the weight ratio of the water-absorbent resin to the fibers was controlled. The production line was so planned that the fibers recovered in the sieving step could be suitably used as the fibers to be mixed in this step. The composite was shaped into a desired form by the crimper 8, and finally an absorbent article comprising a water-absorbent resin and fibers was thus obtained. Accordingly, an absorbent article was obtained in which the dry weight ratio of the fibers neither embedded in nor adhering to the water-absorbent resin to the water-absorbent resin was 30/70 and the unit weight of the water-absorbent resin was 300 g/m². The density of the absorbent article was 0.3 g/cm³, and the thickness thereof was 1.3 mm.

The absorbent article produced according to the production method of the invention is further processed in the subsequent cutting step and others, therefore giving final products. The absorbent article waste discharged in the cutting step may be opened and recycled in any step of the process of producing absorbent articles.

(Confirmation of Structure of Composite)

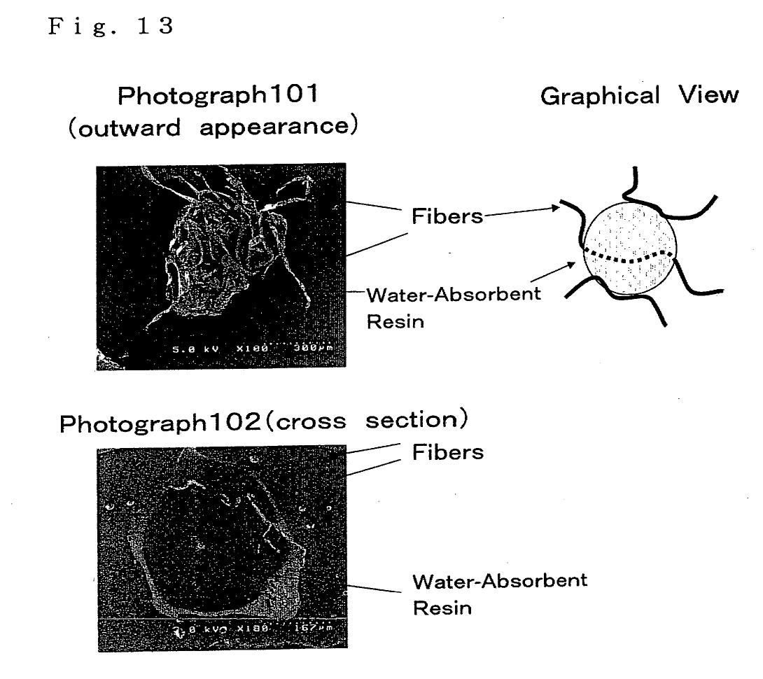

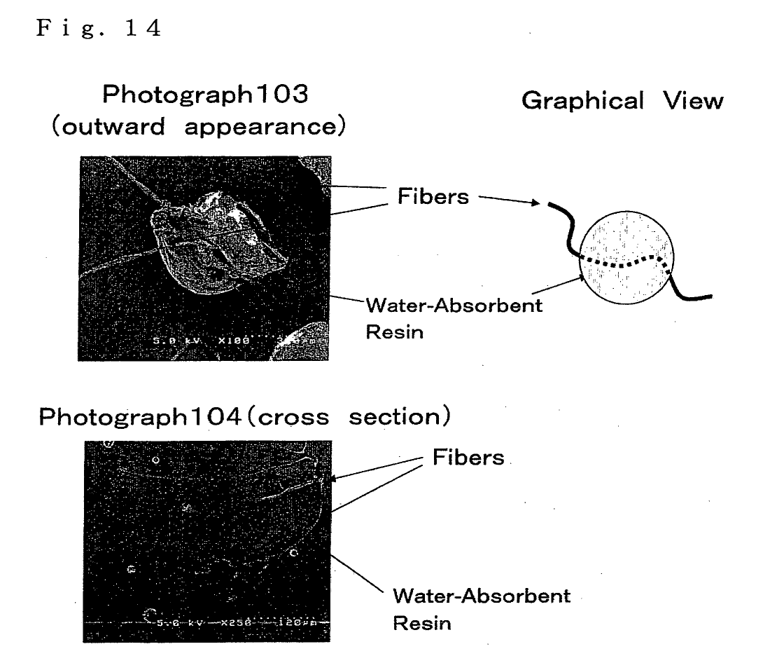

For confirming its structure, the recovered deposit obtained in the recovering step was sampled and sieved so as to remove the free fibers not contacted with a water-absorbent resin, thereby obtaining a composite comprising a water-absorbent resin and fibers. The composite was observed with a microscope, and it was confirmed that the composite contains one water-absorbent resin particle and two or more fibers and has a structure of such that the water-absorbent resin particle is nearly spherical, at least one fiber of the two or more fibers is partly embedded in the resin particle and is partly exposed out of it, and at least one fiber of the two or more fibers is not embedded in the resin particle but partly adheres to the surface of the resin particle (FIG. 13).

In the above-mentioned production method, it was also confirmed that, [1] when polyethylene terephthalate (PET) fibers having a fiber diameter of 1.7 decitex and a length of 0.9 mm and having a contact angle with water of 80° were used in place of pulp fibers, [2] when nylon fibers having a fiber diameter of 1.7 decitex and a length of 0.9 mm and having a contact angle with water of 50° were used in place of pulp fibers, [3] when a fiber mixture of nylon fibers having a fiber diameter of 1.7 decitex and a length of 0.9 mm and having a contact angle with water of 50° and rayon fibers having the same fiber diameter and length as those of the nylon fibers and having a contact angle with water of 0° in a ratio by weight of 1/1 was used in place of the pulp fibers, and [4] when polytetrafluoroethylene (PTFE) fibers having a fiber diameter of 1.7 decitex and a length of 0.9 mm and having a contact angle with water of 108° were used in place of pulp fibers; composites having the same structure as above were obtained in every case.

### EXAMPLE 202

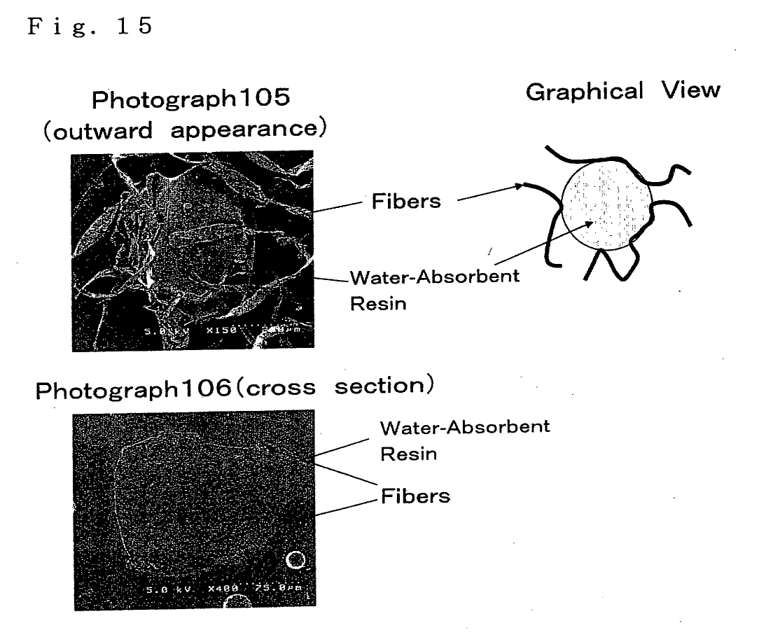

An absorbent article was produced in the same manner as in Example 201, except that in the hybridizing step in the production method in Example 201, fibers were supplied only through the fiber supply port disposed at 0.8 m below the nozzle tips. The structure of the composite was analyzed in the same manner as in Example 201, and it was confirmed that the composite is a mixed composition of a composite having the same structure as in Example 201 (30%) and a composite containing at least one water-absorbent resin particle and at least one fiber, in which the water-absorbent resin particle is nearly spherical, at least one fiber is partly embedded in the resin particle and is partly exposed out of the resin particle and no fiber adheres to the surface of the resin particle (FIG. 14) (70%).

### EXAMPLE 203

An absorbent article was produced in the same manner as in Example 201, except that in the hybridizing step in the production method in Example 201, fibers were supplied only through the fiber supply port disposed at 1.6 m below the nozzle tips. The structure of the composite was analyzed in the same manner as in Example 201, and it was confirmed that the composite is a mixed composition of a composite having the same structure as in Example 201 (20%) and a composite containing at least one water-absorbent resin particle and at least one fiber, in which the water-absorbent resin particle is nearly spherical, at least one fiber partly adheres to the surface of the resin particle and no fiber is embedded in the resin particle (FIG. 15) (80%).

### INDUSTRIAL APPLICABILITY

According to the method of using a transition metal compound of the invention, the speed of redox polymerization may be significantly increased. Even in a redox polymerization system containing a polymerization inhibitor, stable polymerization behavior may be realized with little polymerization retardation. Further, when redox polymerization is attained according to the method, then the remaining monomer amount in the polymer obtained may be reduced. For attaining these, the polymerization activator, the anti-polymerization inhibitor and the remaining monomer amount-reducing agent of the invention may be effectively used.

According to the invention, there are provided a water-absorbent resin composite and a water-absorbent resin composite composition in which the remaining monomer amount is reduced and which are excellent in point of their water absorption and sanitation. Using the water-absorbent resin composite composition, an absorbent article having a high commercial value can be provided. According to the production method for an absorbent article of the invention, an absorbent article can be simply produced, which may rapidly absorb a sufficient amount of liquid and may diffuse and hold it therein. In particular, according to the invention, there are provided a composite of highly water-absorbent resin particles and fibers, in which the remaining monomer amount is reduced, the fibers are stably fixed to the highly water-absorbent resin particles not only in dry but also in wet and swollen condition, and the highly water-absorbent resin can be fixed to the fibers uniformly to a high content, which is flexible and may be thinned, and which is openable by itself and may be uniformly mixed with any other material; and a composition containing the composite. The water-absorbent resin composite and the water-absorbent resin composite composition are extremely industrially useful as constitutive materials for absorbent articles such as sanitary materials, e.g., paper diapers and sanitary napkins, and also industrial materials.

The present disclosure relates to the subject matter contained in PCT/JP2004/015652 filed on Oct. 15, 2004, which is expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A method for producing a water-absorbent resin composite that contains highly water-absorbent resin particles hybridized with fibers, which comprises contacting liquid droplets that contain a monomer and/or the monomer being polymerized with fibers in a vapor phase and promoting the polymerization of the monomer;
wherein the polymerization of the monomer is promoted through radical polymerization in the presence of a polymerization activator, and
wherein the method includes:
redox polymerizing in an aqueous solution a monomer by the use of a non-metal reducing agent and a non-metal oxidizing agent, wherein at least one transition metal compound selected from the group consisting of transition metal salts of an inorganic or organic acid, transition metal oxides and alloys comprising a transition metal is used in addition to the reducing agent and the oxidizing agent, in an amount of from 0.01 to 100 ppm by weight in terms of the metal thereof relative to the monomer, in order to produce said polymer.

2. A method for producing a water-absorbent resin composite that contains highly water-absorbent resin particles hybridized with fibers, which comprises contacting liquid droplets that contain a monomer and/or the monomer being polymerized with fibers in a vapor phase and promoting the polymerization of the monomer;
wherein the polymerization of the monomer is promoted through radical polymerization and, after the polymerization, the product is kept under a condition of a relative humidity of at least 80% in the presence of a polymerization activator, and
wherein the method includes:
redox polymerizing in an aqueous solution a monomer by the use of a non-metal reducing agent and a non-metal oxidizing agent, wherein at least one transition metal compound selected from the group consisting of transition metal salts of an inorganic or organic acid, transition metal oxides and alloys comprising a transition metal is used in addition to the reducing agent and the oxidizing agent, in an amount of from 0.01 to 100 ppm by weight in terms of the metal thereof relative to the monomer, in order to produce said polymer.

3. A method for producing a water-absorbent resin composite that contains highly water-absorbent resin particles hybridized with fibers, which comprises contacting liquid droplets that contain a monomer and/or the monomer being polymerized with fibers in a vapor phase and promoting the polymerization of the monomer;
wherein the polymerization of the monomer is promoted through radical polymerization and, after the polymerization, water is given to the product in the presence of a polymerization activator, and
wherein the method includes:
redox polymerizing in an aqueous solution a monomer by the use of a non-metal reducing agent and a non-metal oxidizing agent, wherein at least one transition metal compound selected from the group consisting of transition metal salts of an inorganic or organic acid, transition metal oxides and alloys comprising a transition metal is used in addition to the reducing agent and the oxidizing agent, in an amount of from 0.01 to 100 ppm by weight in terms of the metal thereof relative to the monomer, in order to produce said polymer.

4. The method for producing a water-absorbent resin composite as claimed in claim 2, wherein the polymerization is effected in the presence of a polymerization activator.

5. The method for producing a water-absorbent resin composite as claimed in claim 1, wherein the polymerization activator is added to the product after the polymerization.

6. A method for producing a water-absorbent resin composite that contains highly water-absorbent resin particles hybridized with fibers, which comprises contacting liquid droplets that contain a monomer and/or the monomer being polymerized with fibers in a vapor phase and promoting the polymerization of the monomer;
wherein the polymerization of the monomer is promoted through radical polymerization in the presence of a polymerization activator, and the method includes
redox polymerizing in an aqueous solution a monomer by the use of a non-metal reducing agent and a non-metal oxidizing agent, wherein at least one transition metal compound selected from the group consisting of transition metal salts of an inorganic or organic acid, transition metal oxides and alloys comprising a transition metal is used in addition to the reducing agent and the oxidizing agent, in an amount of from 0.01 to 100 ppm by weight in terms of the metal thereof relative to the monomer, in order to produce said polymer.

7. The method as claimed in claim 6, wherein the product after the redox polymerization is kept in an atmosphere having a relative humidity of at least 80% or is given water in the presence of a transition metal compound in an amount of from 0.01 to 100 ppm by weight in terms of the metal thereof relative to the monomer.

8. The method as claimed in claim 6, wherein the transition metal compound is a compound capable of being reduced by the reducing agent.

9. The method as claimed in claim 6, wherein the transition metal compound is a primary transition metal compound.

10. The method as claimed in claim 6, wherein the transition metal compound is an iron compound.

11. The method as claimed in claim 6, wherein the redox potential of the non-metal reducing agent is from −2 to 0.3 V, the redox potential of the non-metal oxidizing agent is from 0.6 to 2.5 V, and the redox potential of the transition metal of the transition metal compound is larger than the redox potential of the non-metal reducing agent and is smaller than the redox potential of the non-metal oxidizing agent.

12. The method as claimed in claim 6, wherein the non-metal reducing agent is used in an amount of from 0.001 to 10% by weight relative to the monomer, and the transition metal compound is used in an amount of from 0.0001 to 100% by weight in terms of the metal thereof relative to the non-metal reducing agent.

13. The method as claimed in claim 6, wherein (meth) acrylic acid is used as the monomer.

14. The method as claimed in claim 13, wherein crude (meth)acrylic acid containing one or more polymerization inhibitors in an amount of from 1 to 1000 ppm by weight and/or hydroquinone monomethyl ether in an amount of from 230 to 5000 ppm by weight is used, and the polymerization inhibitor is selected from the group consisting of aldehydes having from 1 to 6 carbon atoms, saturated or unsaturated carboxylic acids having from 1 to 6 carbon atoms (excepting acetic acid, propionic acid and dimer acid), esters having from 1 to 6 carbon atoms, cyclic unsaturated hydrocarbons having from 8 to 10 carbon atoms, alkoxyhydroxy-(polycyclic) unsaturated hydrocarbons having from 7 to 16 carbon atoms except hydroquinone monomethyl ether, and phenothiazine.

15. The method as claimed in claim 6, wherein one or more of the non-metal reducing agent is selected from the group consisting of ascorbic acid, erythorbic acid and their salts.

16. The method as claimed in claim 6, wherein hydrogen peroxide is used as the non-metal oxidizing agent.

17. The method as claimed in claim 6, wherein the monomer polymerization rate is at least 50% in 0.7 seconds after the initiation of redox polymerization, or the monomer polymerization rate is at least 70% in 1.5 seconds after it.

18. The method for producing a water-absorbent resin composite as claimed in claim 1, wherein a water-absorbent resin composite having a remaining monomer concentration of at most 2000 ppm is produced.

19. A water-absorbent resin composite produced according to the method for producing a water-absorbent resin composite of claim 1.
